(19) United States
(12) Patent Application Publication
(10) Pub. No.: US 2015/0089399 A1
(43) Pub. Date: Mar. 26, 2015

(54) SYSTEM AND METHODS FOR REAL-TIME FORMATION OF GROUPS AND DECENTRALIZED DECISION MAKING

(71) Applicant: POLIS TECHNOLOGY INC., Seattle, WA (US)

(72) Inventors: COLIN SEAN MEGILL, Seattle, WA (US); Michael Carl Erik Bjorkegren, Redmond, WA (US); Christopher Tarbell Small, Seattle, WA (US)

(21) Appl. No.: 14/496,551

(22) Filed: Sep. 25, 2014

Related U.S. Application Data
(60) Provisional application No. 61/883,045, filed on Sep. 26, 2013.

(51) Int. Cl. H04L 12/18; G06Q 30/02; G06F 3/0484; G07C 13/00

(52) U.S. Cl. CPC H04L 12/1813; G07C 13/00; G06Q 30/0203; G06F 3/04842
USPC 715/753

(57) ABSTRACT

Systems and methods for enabling the formation and analysis of social structures, such as groups, in real-time among a number of participants. Embodiments of the invention are also directed to systems and methods for enabling an understanding of the responses, opinions, or decisions of individual members of a group and how those may change and coalesce into one or more consensus views of a majority of the group. Embodiments of the invention may be applied to better understand the opinions and dynamically changing membership and characteristics of social structures in a variety of settings, including but not limited to educational, business, political, marketing and related environments.

### CROSS REFERENCE TO RELATED APPLICATION

This application claims the benefit of U.S. Provisional Application No. 61/883,045, entitled “System and Methods for Real-Time Formation of Groups and Decentralized Decision Making,” filed Sep. 26, 2013, which is incorporated herein by reference in its entirety for all purposes.

### BACKGROUND

Embodiments of the invention are directed to systems and methods for enabling the formation of social structures, such as groups, in real-time among a number of participants. Such structures may then be used to assist in making decisions, determining opinions, implementing planning functions, or evaluating the effect of the response(s) of a member of a group on the characteristics of the group. Embodiments of the invention may be applied to better understand the opinions and dynamically changing membership and characteristics of social structures in a variety of settings, including but not limited to educational, business, political, marketing, and related environments. In this way embodiments of the invention may be used to enable a collective action among loosely associated individuals, identify outlier beliefs or opinions within a group, identify commonly held beliefs or opinions with a group, model the impact of a change or changes in the beliefs or opinions of members of a group on the collective beliefs or opinions of the group, and otherwise characterize or investigate the values, opinions, or beliefs of a group.

There are many situations in which a group of people purposely assemble or otherwise become associated because of an interest in a common purpose, goal, or activity. These assemblies form a type of social structure, either formally or informally. In some such situations, communication between group members and between group members and group leaders is an important part of achieving the purpose or goal, and may assist group members to coalesce into supporters of one or more opinions, values, beliefs or commonly held ideas. Being able to communicate and identify and develop such opinions, values, beliefs or commonly held ideas may enable the group to be more effective in achieving their goals and may increase their understanding of the different approaches people have to solving a common problem. In addition, from the perspective of someone concerned with group dynamics and the process of how opinions are formed or decisions are made (such as politicians, advertisers, business management, etc.), understanding what is happening when groups communicate and reach a consensus can be a valuable source of information.

However, there is presently no practical scalable solution for enabling and tracking group communication that provides the degree of fidelity (i.e., precision or resolution) desired for an effective understanding of group dynamics and the formation of opinions or the making of a decision. A fundamental problem involves the synthesis of the data, which requires exponentially more time as the scale increases (i.e., the number of participants and/or the amount of data associated with each participant increases). As an example, someone with 10,000 people on an email list would not be able to review and create order from (i.e., synthesize) all of the responses received if they asked those on the list to respond to an open ended question (i.e., they would not be able to achieve a relatively high level of fidelity in terms of understanding the responses), but they would be able to read a bar graph if all participants were asked a yes/no (i.e., binary) question (i.e., they would be able to understand a relatively low fidelity representation of the responses).

Conventional approaches to enabling communication between members of a group and providing an understanding of group opinions or decisions have proven to have serious limitations in terms of one or more of scalability, degree of fidelity achievable, or similar characteristics that relate to the ability to understand the thoughts of members of the group. Embodiments of the invention are directed to solving these and other problems individually and collectively.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the invention and introduces some of the concepts that are further described in the Detailed Description section below. This summary is not intended to identify key, required, or essential features of the claimed subject matter, nor is it intended to be used in isolation to determine the scope of the claimed subject matter. The subject matter should be understood by reference to appropriate portions of the entire specification of this patent, to any or all drawings, and to each claim.

Embodiments of the invention are directed to systems and methods for enabling the formation of social structures, such as groups, in real-time among a number of participants. Embodiments of the invention are also directed to systems and methods for enabling an understanding of the responses, opinions, beliefs, values, or decisions of individual members of a group and how those may change and coalesce into one or more consensus views representing a majority of the group. Embodiments of the invention may be applied to better understand the opinions and dynamically changing membership and characteristics of social structures in a variety of settings, including but not limited to educational, business, political, marketing, and related environments. This can be of value in many situations, including but not limited to assessing the effectiveness of a presentation or advertising plan, identifying a group member whose opinion is representative of a majority of the group, examining how a group member's opinion compares to the group as a whole, determining how the responses of a group can be segmented into a set of characteristic responses, etc.

In one embodiment, the invention is directed to a data processing platform that is operative to receive and process inputs from a group of participants. The inputs may represent a response to a question, a statement, an opinion, or another form of communication presented by an initiator of a conversation or discussion. The inputs may be one or more of textual, video, image, audio, or other form of content. In one embodiment, the inputs represent comments regarding the question, statement, etc. The reaction or opinion of one or more of the participants to the comment or comments of others may be evaluated by receiving and processing those participants' “votes” regarding the comment or comments. In one embodiment, a result of the processing may be to generate a display illustrating how participants' reaction or evaluation of a comment permits them to be placed into one or more groups having members that responded similarly to the comment. In one embodiment, the display may be used to illustrate how a specific participant's response causes them to be placed within a particular group, and how their placement relative to other groups may change dynamically as they or others provide new inputs to the inventive platform or system.

In some embodiments, the invention is directed to a communications system that provides a scalable platform for indicating group consensus or disagreement, segmenting participants into groups reflecting commonly held opinions or values (or gradations/differences in an opinion or value), and showing more easily comprehensible patterns among participants' inputs/votes. In some embodiments, the communications system/platform includes capabilities for online statistical processing and real-time data-visualization to enable better comprehension of group dynamics, opinion formation, and how a consensus or representative opinion is developed. As noted, such information can be beneficial to educators, advertisers, politicians, community organizers, management personnel, and others seeking to understand and utilize the opinions and decisions of a group.

In one embodiment, the invention is directed to a method of communicating, where the method includes:

initiating a conversation involving a plurality of participants, wherein initiating the conversation includes presenting information to the plurality of participants;

receiving a response to the presented information from one of the plurality of participants;

providing the response to the plurality of participants;

receiving an evaluation of the response from others of the plurality of participants than the one that submitted the response;

processing the received evaluations to segment the participants from which an evaluation is received into a set of groups or sub-groups, wherein each group or sub-group represents one or more participants having a similar evaluation of the response; and

generating a display illustrating the set of groups or sub-groups for presentation to the plurality of participants.

In another embodiment, the invention is directed to an apparatus for use in facilitating communications between a plurality of participants, where the apparatus includes:

a processor programmed to execute a set of instructions; and

a data storage element in which the set of instructions are stored, wherein when executed by the processor the set of instructions cause the apparatus to
receive a response to information presented to the plurality of participants from one of the plurality of participants;
provide the response to the plurality of participants;
receive an evaluation of the response from others of the plurality of participants than the one that submitted the response;
process the received evaluations to segment the participants from which an evaluation is received into a set of groups or sub-groups, wherein each group or sub-group represents one or more participants having a similar evaluation of the response; and
generate a display illustrating the set of groups or sub-groups for presentation to the plurality of participants.

In yet another embodiment, the invention is directed to a communications system to facilitate communications between a plurality of participants, where the system includes:

a client application for installation on a device associated with each of the plurality of participants; and

a data processing platform configured to
receive a response to information presented to the plurality of participants from one of the plurality of participants;
provide the response to the plurality of participants;
receive an evaluation of the response from others of the plurality of participants than the one that submitted the response;
process the received evaluations to segment the participants from which an evaluation is received into a set of groups or sub-groups, wherein each group or sub-group represents one or more participants having a similar evaluation of the response; and
generate a display illustrating the set of groups or sub-groups for presentation to the plurality of participants

Other objects and advantages of the present invention will be apparent to one of ordinary skill in the art upon review of the detailed description of the present invention and the included figures.

### BRIEF DESCRIPTION OF THE DRAWINGS

Embodiments of the invention in accordance with the present disclosure will be described with reference to the drawings, in which:

FIG. 1 is a diagram illustrating the primary functional elements or components of an embodiment of the inventive system and the context in which it may be used;

FIG. 2 is a diagram illustrating the primary functional elements or components of a system architecture that may be used to implement an embodiment of the inventive system and methods, and in particular showing how participants' votes are used to generate the visualization that each participant may access;

FIG. 3 is a diagram illustrating an example user interface for a first participant that may be used as part of implementing an embodiment of the inventive system;

FIG. 4 is diagram illustrating an example user interface for a second participant that may be used as part of implementing an embodiment of the inventive system;

FIG. 5 is a diagram illustrating a user interface to permit a user to submit a comment or initiate a new conversation that may be used in implementing an embodiment of the inventive system and methods;

FIG. 6 is a flow chart or flow diagram illustrating a typical process or data flow for a conversation owner to initiate a conversation and for a user to participate in the conversation, in accordance with an embodiment of the inventive system and methods;

FIGS. 7-10 are diagrams illustrating examples of the primary elements, components, and methods that may be used in one or more embodiments of the inventive system to update the visualization after new “votes” are submitted;

FIG. 11 is a diagram illustrating a user interface or display that may be used to assist a user to rank or otherwise assign importance or significance to a set of comments;

FIG. 12 is a flow chart or flow diagram illustrating a typical process or data flow for a user to participate in a conversation, in accordance with an embodiment of the inventive system and methods;

FIG. 13 is a diagram illustrating the primary elements or components and methods, operations, functions, or processes that may be used to implement an embodiment of the inventive system in which comments are shown in an optimized order;

FIG. 14 is a diagram illustrating elements or components that may be present in a computer device and/or system configured to implement a method and/or process in accordance with an embodiment of the invention;

FIG. 15 is a diagram illustrating how an embodiment of the invention that uses polling can use vote timestamps or vote IDs to decide when to trigger a re-compute of the projections, and to decide when the client should fetch the latest projection;

FIG. 16 is a flow chart or flow diagram illustrating a process for receiving and processing a user's vote and in response updating a display of the user's dot or other visual indicator;

FIG. 17 is a diagram illustrating an example user interface or display for a participant or other user who is analyzing a conversation and that may be used as part of implementing an embodiment of the inventive system;

FIG. 18 is a diagram illustrating an example user interface or display for a participant or other user who is analyzing a conversation and that may be used as part of implementing an embodiment of the inventive system;

FIG. 19 is a diagram illustrating an example user interface or display for a participant or other user who is analyzing a conversation and that may be used as part of implementing an embodiment of the inventive system;

FIG. 20 is a diagram illustrating an example user interface or display for a participant or other user who is analyzing a conversation and that may be used as part of implementing an embodiment of the inventive system;

FIG. 21 is a diagram illustrating an example user interface or display for a participant or other user who is analyzing a conversation and that may be used as part of implementing an embodiment of the inventive system;

FIG. 22 is a diagram illustrating an example user interface or display for a participant or other user who is analyzing a conversation and that may be used as part of implementing an embodiment of the inventive system;

FIG. 23 is a diagram depicting the elements of a basic auto-encoder neural network with a single hidden layer;

FIGS. 24-26 are diagrams illustrating other examples of a user interface or display for a participant or other user who is analyzing a conversation and that may be used as part of implementing an embodiment of the inventive system;

FIG. 27 is a diagram illustrating elements and processes that may be used in an embodiment of the inventive system to update a user's visualization in response to their votes and those of other participants;

FIG. 28 is a diagram illustrating elements and processes that may be used in an embodiment of the inventive system to update a user's visualization in response to their votes and those of other participants;

FIG. 29 is a diagram illustrating elements and processes that may be used in an embodiment of the inventive system to update a user's visualization in response to their votes and those of other participants;

FIG. 30 is a diagram illustrating elements and processes that may be used in an embodiment of the inventive system to update a user's visualization in response to their votes and those of other participants;

FIG. 31 is a diagram illustrating an example of a user interface where the voting patterns for a selected comment are shown with metadata about participants, allowing the user to see correlations between the comment and the metadata;

FIG. 32 is a diagram illustrating a user interface where a participant is able to change their votes on votable entities/comments;

FIG. 33 is a diagram illustrating a user interface where a participant is creating a votable entity;

FIG. 34 is a diagram illustrating a user interface where a participant is in the process of voting on a votable entity;

FIG. 35 is a diagram illustrating a user interface in which the inventive system has been integrated with a collaborative document editing system;

FIG. 36 is a diagram illustrating a user interface in which the inventive system has been integrated with a collaborative document editing system;

FIG. 37 is a diagram illustrating a user interface where comments have been sorted and shown in a list, with the order of the sorting taking into account the representativeness of comments within each group;

FIG. 38 is a diagram illustrating a user interface where principal components have been used to prioritize the display of certain comments;

FIG. 39 is a diagram illustrating a user interface where comments have been sorted and shown in a list, with the order of the sorting taking into account the weighting of comments along each principal component;

FIG. 40 is a diagram illustrating an example user interface which is a text-only version of the interface illustrated in FIG. 38;

FIG. 41 is a time-series diagram illustrating a sequence of projections as a participant votes, where one sequence of projections using missing-vote compensation is compared with another sequence of projections not using the compensation;

FIG. 42 is a diagram illustrating a visualization where both comments and participants are shown;

FIG. 43 is a diagram of a user interface illustrating that (similarly to FIG. 42) a visualization can show projections of both participants and comments, where in FIG. 43, there are no groupings;

FIG. 44 is a diagram of a user interface illustrating that one or more participants can be selected, and a list of comments shown for which those participants voted in a unique way;

FIG. 45 is a diagram of a user interface illustrating that a visualization can consist primarily of projected comments, with the addition of the current user's dot; and

FIG. 46 is a diagram of a user interface illustrating that a visualization can show comments and participants simultaneously, with a comment selection mode that allows for direct selection of comments, without necessarily selecting participants.

### DETAILED DESCRIPTION

The subject matter of embodiments of the present invention is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

Among other things, the present invention may be embodied in whole or in part as a system, as one or more methods, or as one or more devices. Embodiments of the invention may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, etc. that is part of a client device, server, network element, or other form of computing device) that are programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

One or more embodiments of the invention may be implemented as a business model, such as a web service, software-as-a-service (SaaS), back end server, etc. in order to provide the inventive processes and services to multiple users. In one embodiment, a tenant of a multi-tenant data processing platform may use the inventive processes to permit employees or customers to evaluate products, provide input regarding internal policies or operations, comment on their response to advertising materials, etc. as part of the business processes being supported for the tenant on the platform. In one embodiment, a company may use the inventive processes internally as part of evaluating its own operations to assist management in setting or developing policies. In such an embodiment the inventive system may be incorporated with the company's own data processing infrastructure and made available to employees using the company's internal network.

Embodiments of the invention are directed to systems and methods for enabling the recognition and formation of formal or informal social structures, such as groups, in real-time (or pseudo real-time) among a number of participants. Embodiments of the invention are also directed to systems and methods for enabling a greater understanding of the responses, opinions, beliefs, values, or decisions of individual members of a group and how those may change and coalesce into one or more consensus views of a majority of the group.

In one embodiment, the invention is directed to a data processing platform that is operable to receive and process inputs from a group of participants. The inputs may represent a response to a question, a statement or opinion, or another form of communication. The inputs may be textual, video, image, audio, or other form of content. Other inputs may represent “votes” or opinions regarding a response or comment to a question or statement. Thus, in one embodiment, the inventive system may be used to initiate a discussion or conversation, receive responses or comments to a question or statement used to initiate the conversation, and to receive the votes/response of other participants regarding the received responses or comments. In some embodiments, the inventive system may be used to generate a display or illustration of the groupings formed by participants based on their votes, and to show how those groupings may change as new participants join the conversation, and as new comments and votes are received from current participants. This provides a real-time or pseudo real-time mechanism for illustrating the dynamic nature of groupings, opinions, and commonly held values during a discussion.

In some embodiments, the invention is directed to a communications system that provides a scalable platform for indicating group consensus or disagreement, segmenting participants into groups reflecting common opinions or values (or gradations/differences in an opinion or value), and showing more easily comprehensible patterns among participants' inputs. In some embodiments, the communications system/platform includes capabilities for online statistical processing and real-time data-visualization to enable better comprehension of group dynamics, opinion formation, and how a consensus or representative opinion is developed. As noted, such information can be beneficial to educators, advertisers, politicians, community organizers, management personnel, and others seeking to understand, utilize, and possibly alter the opinions and decisions of a group.

Embodiments of the invention may be applied to better understand the opinions and dynamically changing membership and characteristics of social structures in a variety of settings, including but not limited to public-opinion polling, fund raising, educational, business, political discourse, product and service marketing, segmented advertising, and related environments. This can be of value in many situations, including but not limited to assessing the effectiveness of a presentation or advertising plan, identifying a group member whose opinion is representative of a majority of the group, examining how a group member's opinion compares to the group as a whole, determining how the responses of a group can be segmented into a set of characteristic responses, studying what information influences the opinion(s) and structure of a group or sub-group, generating questions or tasks designed to alter the opinion of one or members of a group or sub-group, etc.

As noted, in a typical use case the content that is submitted by a member or participant may be in any suitable form, including but not limited to textual, image, audio, video, etc. This provides an opportunity for achieving a more precise understanding of a participant's input(s) (i.e., a relatively high degree of fidelity) and also an enhanced level of communication, as different formats may be capable of or more effective at expressing or communicating different concepts, opinions, emotions, thoughts, values, etc.

Some conventional communications systems facilitate a scalable synthesis of inputs from multiple participants by sacrificing fidelity. This is accomplished by using question structures such as multiple choice questions, which facilitates a relatively easy processing and assessment of the responses from a large group of participants. Other conventional systems do not facilitate synthesis but do facilitate high fidelity communication by permitting submission of relatively detailed comments or responses, typically expressed in a textual format. There are thus two aspects to such communications systems, and conventional systems typically focus on one of the two aspects, thereby only addressing one of the primary goals of an optimal system (which would be to provide a relatively high fidelity and a scalable synthesis process).

An example of a communications system is electronic mail or “email”, which permits extremely high fidelity responses, but does not provide synthesis capabilities beyond the grouping of emails. One of the reasons for this limitation on email and similar types of systems is that effective synthesis of communications requires that similar ideas or expressions of thoughts be capable of being identified and then grouped together. Grouping ideas is relatively simple if the answers are in a common and easily processed format; however, if they are not in the same format or are in one that requires more complicated processing in order to evaluate the ideas (e.g., parsing with a natural language processing method), then it becomes a difficult problem for a computing device to implement (and one which can be time consuming and mentally intensive for a person to perform, if they could perform the required processing efficiently).

In one embodiment, the invention is a communication system for relatively “large” groups that is scalable and includes online statistical processing and real-time data-visualization capabilities. Among the system's features and capabilities are to identify and show participant consensus and disagreement, segment participants into sub-groups having similar views (or values, responses, or opinions), and effectively show comprehensible patterns or trends among the views, opinions, or values of members of the group. In one respect, the invention represents a solution to the problem of the coordination of collective human behavior at large scale, in a use case where individuals, who may or may not be centralized, must come to a consensus and act. This has implications for organizing collective action and decision making, political or social activity (such as nominations or decisions regarding a political platform), survival scenarios, monitoring and/or predicting the collective effect of multiple individual decisions, values, opinions, etc. (such as might be applicable to modeling of economic activity and decisions, stock market simulations, “group think” investigations, investigating or influencing the spread of opinions or beliefs among previously unaffiliated persons, etc.).

In one embodiment, the invention provides a mechanism for an individual to start a “conversation” or interaction, and by asking open ended questions and waiting for responses, to facilitate the formation of one or more ad hoc “social networks”. These ad hoc networks represent groups or sub-groups having a similar “opinion” or sense of values and such networks may be formed in (pseudo) real-time relative to the response(s) received from the other members of the group. When using an embodiment of the invention, received comments or responses to an initial statement or question are related to each other by the actions of the participants, in a form of crowd-sourcing of a process to evaluate participants' comments by the submission of “votes” regarding the comments (such as “agree”, “disagree”, “trash”). Further, by using the statistical analysis and data processing techniques described herein, a view or understanding of the consensus and differences in opinion or values among participants may be obtained. In this sense, embodiments of the invention can be thought of as a system and associated processes whereby a number of participants may engage with each other and groups/sub-groups may be formed based on consensus and differences of opinion, values, decisions, or another characterization that may be derived from the submitted comments.

As recognized by the inventors, in a conversational environment or system, participants may be related to one another based on their opinions with respect to statements or comments made by others, i.e., by their evaluation of the comments made by others in response to an initial statement or question. Embodiments of the invention permit these relationships to be visualized in real-time or pseudo real-time as a projection of participants on a 2-dimensional plane, with clustering techniques (for example) being used to identify and define the outlines of group boundaries that represent participants having a common or similar belief, response, or value. Thus, each user may be shown with regards to where they reside with respect to the identified groups on the plane. This is a unique and informative aspect of the invention, and one that is missing from conventional systems of human communication. As will be described further, this visualization/display is part of a feedback loop that may lead to a dynamic change in participants' opinions, a change in the evolution of the groups and sub-groups, or the identification of participants or opinions that represent outliers or thought leaders. Note that in some situations, a specific user or participant in a conversation may be depicted as being outside of one or more (or all) groups, thereby perhaps indicating that the user or participant holds a belief or value that is not shared by some (or all) of the others of the participants.

As recognized by the inventors, the inventive system and methods solve one or more core problems present across several industries. For example, in education, politics, and conferences, speakers cannot ask an open ended question of a large group and get responses back in real time (particularly not in a manageable or synthesizable way). Similarly, marketers cannot quickly and easily segment a large email list into focused groups for purposes of generating targeted communications. Likewise, business teams cannot get an answer to an open ended, complex question that involves many stakeholders without holding meetings which are costly in terms of time and energy. In another area, researchers in the social sciences must rely on their own interpretations or approximations of what respondents might “feel” or “think”, rather than allowing those respondents to “speak” for themselves. Similarly, social activists and civic leaders have difficulty synthesizing the passion of their followers into a coherent group with common values that can more effectively take action.

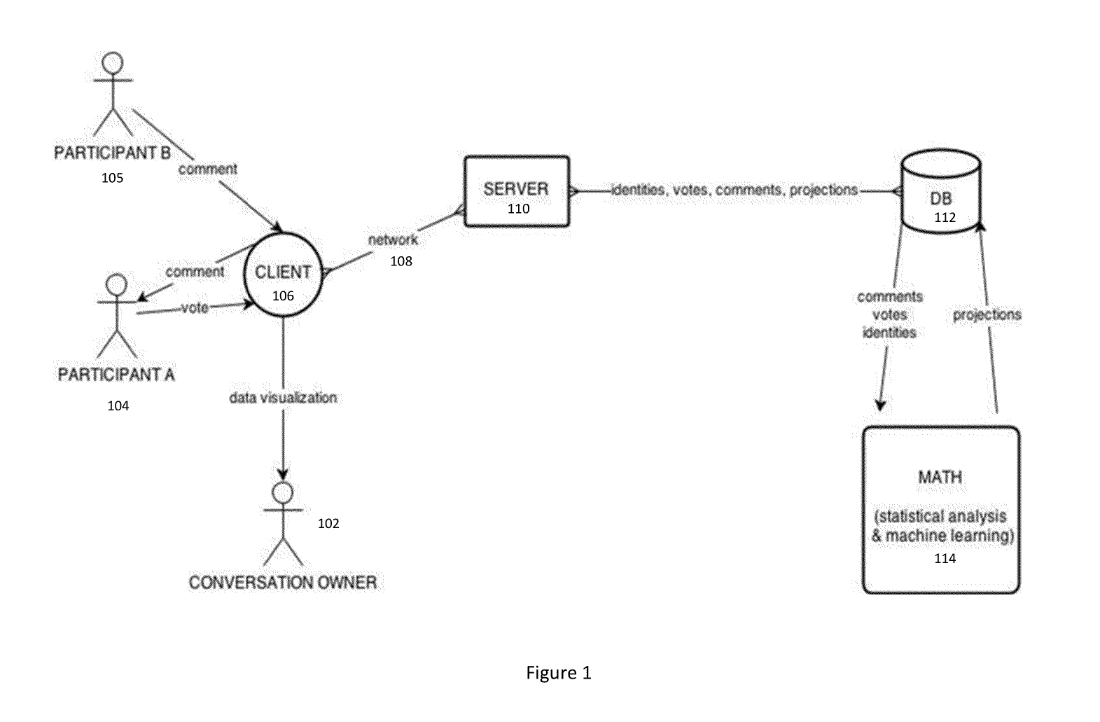

As will be described in greater detail with reference to FIG. 1, in one embodiment or implementation of the inventive system and methods, a process or method for initiating a “conversation” and enabling its development, understanding, and evolution is as follows:

1. A conversation owner or initiator (such as a conference speaker, team leader, or professor) instantiates a new conversation using the inventive system, for example by asking a question, making a statement, or specifying a topic for comment or discussion;

2. The conversation owner shares a (URL) link with the group participants (such as audience members, team members, or students);

3. Participants navigate to the URL link to download the inventive web application onto a device that has a browser (in another embodiment, the application may be provided to participants by another suitable manner, such as on a thumb drive, as a download from an application store, as a download from a specified network location, etc.);

4. Participants submit statements or comments in response to the posted statement or question;

5. Participants vote on, or register their opinion or evaluation of comments submitted by others (note that in some cases a participant may submit a vote on their own comment, which may have been a “straw man” type of argument intended to stimulate responses) using one of five (for example) exemplary actions or “votes” (note that the number and specific type of possible responses/votes may vary depending on the setting, group structure, types of participants, expected types of responses, expected response style for the particular statement, question, or comment, factors of interest in segmenting a set of participants, the nature of the initial statement or question, etc.):

In one example, these “votes” or voting actions may be expressed as (a) agree (with a specific comment or statement submitted in response to the initial statement or question), (b) disagree, (c) pass, as comment or statement is confusing, (d) star as important or significant, or (e) trash as abusive or off topic;

6. The inventive system performs statistical analysis and/or other forms of data processing on the data produced by the participants and produces a data visualization or display; and

7. Participants, including the conversation owner, may then analyze the conversation by observing and interfacing with the interactive visualization that shows groups/sub-groups and consensus opinions or values being formed, modified, trending, dynamically altering in response to new comments or participants, etc.

Note that the output(s) of the inventive system (for example, a visualization of one or more groups and identification of a consensus opinion or response) provides value in that it offers almost immediate feedback about what a relatively large group thinks or believes about a statement, question, etc. This may be of assistance to focus a discussion, identify a thought leader or outlier opinion, demonstrate to a group how their thoughts about an issue evolve over time, etc.

Embodiments of the invention provide a scalable solution for understanding high fidelity group communications by providing a system and methods for synthesizing and investigating responses received from users in a relatively unstructured fashion. As a practical example, an embodiment of the invention would allow someone with an email list of 10,000 people to ask an open ended question, have everyone respond, and receive something that was comprehensible in return. For example, the users/respondents may receive an interactive data visualization in real-time (or pseudo real-time) which synthesizes the inherent complexity in their individual responses as those are received and processed. The synthesizing process is in effect “crowd sourced,” meaning that rather than the person who instantiates the conversation being responsible for comprehending and evaluating the data to create order or develop understanding (i.e., synthesize the content received), each user is involved in this process by doing a relatively small action (agreeing, disagreeing, starring other people's comments, depending on the options available) which the system interprets, aggregates, analyzes, and presents for viewing and further discussion.

Achieving both high fidelity communication and scalable synthesis of data together provides synergistic benefits compared to having or focusing on only one or the other of these capabilities. One of the differences between the inventive system and other systems for human communication is the potential and capability for decentralized decision making among large groups. Email, for instance, is effective at decision making among small groups but quickly becomes unwieldy because it lacks synthesis or at least a scalable synthesis capability (though it does provide high fidelity feedback). Surveys fall short in that they do not show groups, but instead present each question as if in a silo and independent from other questions (at least until sufficient statistical analysis is applied to discover correlations). In addition, surveys do not allow for participants to state their own thoughts (thus lacking high fidelity feedback), and thus the person who creates the poll must imagine what types of feedback those he is asking will provide, and what issues are important to them. In contrast, the inventive system and methods facilitate decentralized decision making because they provide for the synthesis of high fidelity responses: an individual can observe what a large group of people think about a wide variety of related issues, and relatively quickly recognize patterns of consensus or disagreement.

### Conventional Communications Systems

The following is a description of certain conventional communications systems and in particular, their disadvantages or sub-optimal aspects when compared to embodiments of the inventive system and methods:

### Email

A group of between 2 and 5 people can comfortably talk amongst themselves over email. Between around 6 people and 12 people, the conversation takes on greater complexity, and each person's response may in turn generate 6 to 12 more responses—an amount that can quickly fill up an inbox and take hours to process and understand. If each member of a conversation involving 10 people responds to a comment by the other and copies the group, each person's inbox has 110 emails in it, for a total of 1100 emails across the team. More realistically, participants often respond to things as they come into the inbox, for example by responding to the last two comments at once, and addressing multiple concerns. In some cases participants may begin responding inline, in different colors of fonts, yielding a complex and difficult to decipher thread which quickly becomes impractical and inefficient. A complex and time consuming synthesis process by group leaders may ensue—this is a common problem on non-profit, corporate, and advisory boards attempting to discuss open ended ideas. The inventive system specifically overcomes the problem of complex email threads by not allowing users to respond directly to one another.

### Scrolling Comments

Comments that continue to scroll down vertically with the most recent comment at the top, while typically encompassing hundreds of comments and thousands of readers, are an ineffective tool for groups to talk amongst themselves for three primary reasons. First, because users typically do not read many comments before writing, there are many duplicate comments which are not aggregated in any meaningful way. Second, the users who may not comment but have an opinion are often invisible. In some cases, comments can be ‘liked’, which is advantageous and does add a layer of aggregation. But this leads to the third problem; users are not able to group themselves relative to the comments, so it is opaque with respect to who believes what, even if there is a voting system in place. In particular, it is difficult to determine who is in the majority and who is outside, and in some cases may hold an extreme point of view. Minority groups are usually unable to bring their comments to the top, since the majority groups have enough voting power for their 2nd, 3rd, and 4th most popular comments to crowd out the #1 most important issue of a minority group. Some suggested systems have added real-time functionality to this underlying structure, but have left its assumptions unchallenged. In contrast, the inventive system overcomes these specific disadvantages by producing discrete and identifiable groups. Relatively “extreme” groups are visible, majority groups are visible, and minority groups are visible. Thus, using the inventive system permits insight into whether someone's words are representative of a large set of the people or of a relatively small number.

### Threaded Forums

While the structure of threaded forums helps to meaningfully order user responses (thus improving on the email “reply all” function) and are a tool for intragroup dialogue at small scales, such systems increase the cost of entry with each comment, as new users must go back to the beginning of the thread to discover the context. This improves upon most-recent-at-the-top comments in that each submission to a forum then bears a relationship to each other comment (either it is a new thread and thus a “top level” comment or a response to an existing one). When such forums try to scale, however, there is no effective mechanism for synthesis. As more comments come through and more bad actors inevitably participate, geometrically more human administration and moderation effort is needed. Some forums do aggregate together comments which are similar, but they fail to provide any layer of synthesis and thus do not effectively scale.

### Twitter

An example of a communication structure which does scale in some respects is Twitter. However, it has solved the problem of scalability at the expense of interpretability. The concepts which have taken hold in the “Twitter-verse” enable more amorphous, many-to-many person dissemination of information. However, there is nothing in Twitter which facilitates aggregation or synthesis of information. Consequently, the vast network of tweets, hash-tags, and users surrounding a particular topic poses a significant obstacle to gaining a full picture of the state of a conversation. Analysts have extracted significant amounts of useful information from these data sets, but these analyses are typically “one-off”, not available in real time, and are not integrated into the structure of Twitter itself. Furthermore, there is no functionality for restricting the scope of conversation to a particular set of users, which is of value when attempting to understand the values and goals of a specific group.

### Stack Exchange, Etc.

This group of systems is not optimal but in some use cases are able to support intragroup discussion in a scalable way. Examples of such systems are Stack Exchange, Quora, Google Moderator, and IdeaScale, all of which follow a similar process. First, a user asks a question. Next, users submit answers to that question, and other users vote on (up/down) the answers. Most of these systems neglect aggregation—if different users submit different parts of the answer, they will not be combined into a whole or be grouped together. The systems do, however, accomplish the synthesis of a scalable amount of user input into a singular output in the form of a “right answer,” so long as the question is of a class of discussions that can be concluded by producing a single correct answer as output. However, a shortcoming of each of the systems is that they fail to produce identifiable groups, whereas the inventive system overcomes this deficiency by producing groups from actions taken by participants in a conversation.

### Aspects of the Inventive Communication System

Whereas email, forums, and other forms of mass communication do not facilitate sophisticated (i.e., high fidelity) two way dialogue for large numbers of participants, the inventive system and methods do enable this goal. The inventive system and methods provide a tool for intra-group discussions where there may be more than hundreds, thousands, or even millions of participants. Some of the benefits of scalability are discussed further herein. Briefly, in one embodiment, the inventive system achieves scalability within a timeframe of relevance to the participants by leveraging modern web technologies such as JSON APIs, which send a small amount of data over a network rather than triggering an entire page refresh (commonly referred to as AJAX), combined with the use of neural networks and other machine learning techniques that provide scalable algorithms for dimensionality reduction and online clustering algorithms.

Embodiments of the inventive system may provide significant advantages in situations where there is not one clear answer to a question, and particularly, where a variety of responses are expected (and may be desired) in order to understand the range of opinions and values belonging to a group. The inventive system permits both the input and output to contain value judgments (e.g., the structure of the use case put forward by the person writing the question or topic for discussion, and the voting on the received comments and the resulting groups that occur from the responders' opinions). As noted, in one embodiment, the inventive system leverages a form of “crowd sourcing” by allowing users to vote on each other's comments, thereby introducing a second set of data that may be analyzed to generate insight into the group responding to the original question or statement. In one embodiment, a discussion may also contain partial evidence and/or subjective comments or information that can be analyzed and evaluated. By leveraging browser technologies (e.g., the D3 library), the inventive system is able to generate a visualization of a group or sub-group as it changes and evolves; thus, an outlier position will be recognized but will not derail the flow of the rest of the “conversation”. Users are able to see in real-time (or pseudo real-time) whether someone's opinions are representative of the majority or of the minority of the group. Because multiple sub-groups may form, multiple courses of action may be recognized as desired and actionable, rather than a single course of action. This is an improvement over communication structures which cannot gracefully handle multiple groups, such as forums (which are prone to infighting).

Note that the issue of dealing with groups (or more precisely, the ineffectiveness or lack of ability to address the grouping of participants' responses) is a significant limitation of conventional communication systems. In one embodiment, the inventive system addresses this problem by utilizing dimensionality reduction on the acquired data. To demonstrate the value of this approach, consider a poll of 1000 people with twenty questions, thereby generating 20,000 responses. It is quite a challenge (and may be nearly impossible for an untrained individual) to produce recognizable groups from this data (with or without the aid of a computer) in the absence of applying advanced statistical methods.

In some embodiments, comments that are “similar” are aggregated together by users and by use of machine learning techniques. This produces sets of similar comments, thus reducing matrix sparsity and allowing for larger numbers of comments to be submitted as inputs. Also, unlike with vertically scrolling comments or tweets, the invention enables users to be aggregated together in clusters/groups and displayed in an effective data visualization process. One result of this is that with new behavior, new groups may emerge, with users who are now thinking similarly being clustered together. In one embodiment, the inventive system provides a comprehensible, interactive data visualization that synthesizes inputs and metadata into a single, interactive output that can be navigated by a user to extract the information he or she is interested in understanding. Thus at one level, the inventive system and methods provide a solution to the problem of identifying and coordinating the collective human behavior of a group in a situation where individuals who may not be in a centralized location must come to a consensus and take action (such as in a business setting, a meeting whose participants are distributed over multiple locations, etc.).

Prior to describing the inventive system and methods in greater detail, the following definitions are presented. These definitions are relevant to understanding the implementation and operation of one or more embodiments of the invention:
Conversation—A collection of users and associated comments and votes. A conversation may have a central topic. Mathematical and/or statistical processing (e.g., clustering and dimensionality reduction, Natural Language Processing, etc.) may be performed on each conversation separately;
Participant—A user in the context of a given conversation;
Instantiator/Initiator—The person (or process or program) that starts a conversation;
Un-votable Entity—In some cases, there may be new data-points or measurements related to a system that require monitoring; for example, a set of doctors who are diagnosing a patient. In such a case, results from a test or scan may be added to the system. These data-points may be added automatically, or they may be entered by a participant. However, participants are not able to “vote” on these items of data. The items may appear in the comment-voting box UI, or they may appear outside of the comment UI, possibly along with the Topic and Summary. Although the participants are not able to vote on these entities, they may be required to acknowledge that they have read/seen them. They may also indicate whether this new information changes their opinions. If other participants have indicated in such a way, then the new entity may be displayed in a more urgent way, such as with bold text, and the participant may be shown a list of his previous votes, making it easier to change his votes in light of the new information;
Worker—A process, function, operation, or method which processes data to produce one or more mathematical, machine-learning, or statistical outputs and implements techniques in whole or in part to determine those outputs. These processes may operate on their own timescales, and publish the output(s) to data stores or to queues. The data typically will then be provided to one or more clients via a front-end server. Typically, these “workers” are executed on separate computers than the front-end servers;
Worker (for a peer-to-peer embodiment)—Alternatively, workers may be processes running on clients, in a peer-to-peer embodiment. In this scenario, the clients may alternate in performing the worker tasks, possibly in a round-robin or other scheduling scheme. A peer-to-peer embodiment may also benefit from replacing the centralized databases with a distributed database which also runs on the clients. The “votes” could be transmitted to the other clients in an efficient protocol, such as by using bit torrent. Note that for a worker process on a client to do tasks such as updating the projection model, the worker needs to have the latest votes. Once the projection model and/or projection are computed, they can be distributed to the other clients through the same efficient protocol;
Votable Entity—A piece of information/data/opinion which can be voted on. Depending on the topic of the conversation, votable entities may rely on the topic for context to a varying degree. Votable entities may be more general than comments; for example, as a follow-up to a round of job interviews, the interviewers may use the system with candidates as votable entities. Additionally, comments may be mixed in as additional votable entities, for example “Joe” might be a votable entity which was supplied outside the commenting tools (populated by an HR system, etc), while “Joe seems nicer than Bob” would also be a votable entity, which may be a comment supplied by a participant. In some embodiments, votable entities might not be entered by the participants directly—they may be fed into the system automatically. These votable entities may originate in other systems, such as bug trackers, allowing for use-cases like triage, or HR systems as in the example above;
Comment—Note that the description of the invention uses the word “comment” in a sense that is more expansive than its typical meaning, i.e., the more general concept of a “votable entity” is what is meant by use of the word “comment”.
Vote—A value produced when a user reacts to a given comment or statement. It may be represented as a signed number; for example, using (−1, 0, 1) for Agree, Pass, Disagree, since sociologists have observed that different people will tend to use different magnitudes when given a choice (e.g., some people always give four or five stars, some rarely give four stars, etc.). In this regard, use of “Agree” or “Disagree” in the context of the invention can be interchanged to support a participant making a comment with which a user doesn't agree (such as a straw man argument, etc.);
Voter—A participant who is currently voting, or did vote on a comment;
Commenter—A participant who is currently commenting, or submitted a comment;
Synthesis—A data analysis process; such as (a) Finding points of agreement/disagreement and/or grouping users; (b) Grouping comments that are similar (de-duplication or reducing duplication); and (c) Presenting the de-duplicated views of a group, where ideally, these present a coherent set of opinions;
Visualization/Vis/Display—A 2D and/or 3D interactive animated image presented on a client device which shows where each user is in an opinion-space, and which clusters or sub-groups that they are a part of;
Dot—A mark which represents a participant or group of participants in the visualization projection; note that it does not necessarily have to look like a standard, round dot;
Red Dot—A dot that represents the current user; to aid in identification, it should be readily discernible from the other dots, but does not have to be any particular color or shape;
Tag—An optional extension to the inventive system that allows for comments to be connected by a common concept. A tag may be embedded within the comment itself, such as “We need more machines in the #3dprinting and #metalshop” or the tags may be entered in a separate tag-adding interface and stored in a separate metadata field. A conversation-wide list of tags may be visible, and participants may alter the order of comments they vote on by selecting certain tags they would like to subscribe to. Tags may also become attributed to certain clusters, if those clusters take a disproportionate interest in creating or voting on certain tags;
Projection/Dimensionality Reduction—The computed position of a participant within the lower-dimension space shown in the visualization, as derived from information about how they have voted, and/or other data about that user, relative to other users;
PCA—Principal Component Analysis—a method of projection or dimensionality reduction that may be utilized in an embodiment of the invention;
Auto-Encoder/AE—A form of artificial neural network which may be used as a method of projection or dimensionality reduction in an embodiment of the invention;
Projection Model—The data model used to map a user's voting vector to a position in the visualization. The data may be formatted as vectors of weights, each corresponding to a dimension of the visualization. The vector for each dimension may be multiplied by a user's voting vector to get that user's projection onto that dimension of the visualization. This may be done for each visible dimension to obtain a complete projection. The projection model may be used on a server to project each user, and may also be sent to the client to be used to quickly update the user's own projection;
Encoder—The input half of an auto-encoder, which can be used to project (“encode”) a participant's vote vector. In one embodiment, this may be used as a projection model;
Decoder—The output half of an auto-encoder—may be used to facilitate the auto-encoder training process;
Principal Component/PC—In one embodiment, the PCs with the highest eigenvalues are used as a projection model (i.e., using the first two for a 2D projection, and the first 3 for a 3D projection, etc);
Scalable, Scale—Most discussions about scalability are centered on the ability of computers to process a large amount of data. In the context of the inventive system and methods, scalability refers to that concept and may also refer to a human's ability to process that amount of data. For example, it is not scalable for a single human to read 1000 comments. However, it is scalable if each person reads a few well-chosen comments. The inventive system is designed to scale (in computer time) to a very large number of users; in terms of human scalability and comprehension, efforts may be made to reduce the total number of comments and/or to reduce the amount of comments needed to be viewed by each user;
Cluster—Used in the sense of k-means clustering;
Group-cluster—A grouping of participants who are “closer” to each-other than they are to members of other clusters. Group clusters are produced using a clustering algorithm, such as k-means. Group clusters provide a granularity for analyzing discussions;
Base-cluster—A grouping of participants who are “nearby” in the projected space. Applying base-clustering before group-clustering may be useful for reducing visual clutter, as well as reducing the amount of participant dots that need to be sent to clients. If base-clustering is done, then group-clustering can be done on the base-clusters, instead of directly on the participant projections; and
Hull—A polygon shape in a visualization that includes the participant dots/base-clusters of a cluster, and provides a way of visualizing a cluster. Hulls may be selectable, which may trigger showing of information about the associated group-cluster.

FIG. 1 is a diagram illustrating the primary functional elements or components of an embodiment of the inventive system and the context in which it may be used. As shown in the figure, a conversation owner 102 may initiate a “conversation” in which other people participate (e.g., Participant A 104 and Participant B 105). The conversation owner 102 and each participant utilize a client 106, with each typically utilizing their own client (note that FIG. 1 illustrates a single client for purposes of simplicity). The client 106 may be of any suitable form, but typically will be a browser application installed on a suitable device, such as a desktop computer, laptop computer, tablet computer, PDA, smartphone, etc. The client or clients 106 communicate over a network 108 to one or more servers or other data processing systems or platforms 110. The network 108 will typically be the Internet and may be used in conjunction with another network such as a wireless network or wired network (where a wireless network may be coupled to a wired network by means of a suitable element such as a Gateway server, thereby enabling communications and data to be exchanged between a wireless network and a wired network, such as the Internet).

The server or servers 110 may be operated as part of a web service or cloud-computing architecture, or as a dedicated server that receives and processes communications and data received from the client or clients. The server or servers 110 are coupled to a suitable database 112 which is used to store the communications and data received from the client or clients. The element 114 labelled “Math” in FIG. 1 represents one or more data processing or computing elements or components operative to perform the mathematical and statistical functions, operations, processes, or methods described herein, and that are used by the inventive system to process the received communications and data, and to generate the visualizations of the comments, votes, groups, etc. that are an output of the inventive system.

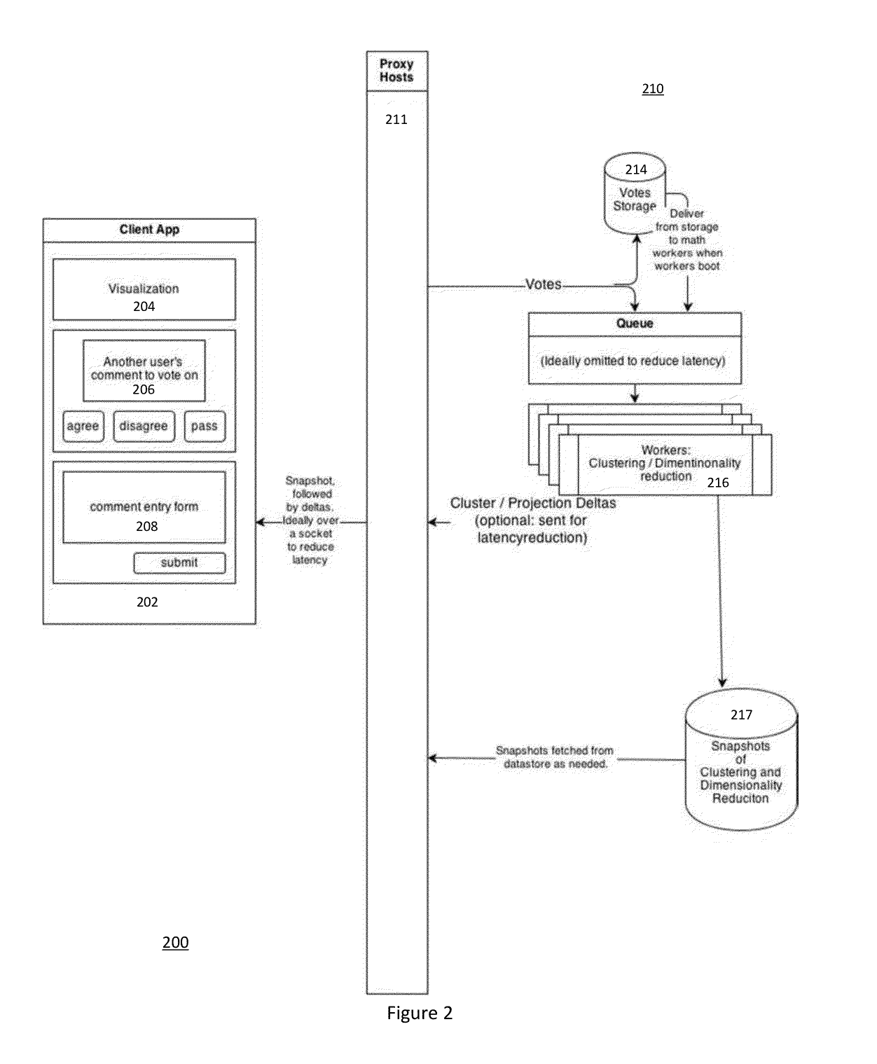

FIG. 2 is a diagram illustrating the primary functional elements or components of a system architecture 200 that may be used to implement an embodiment of the inventive system and methods, and in particular showing how participants' votes are used to generate the visualization that each participant may access. Note that one or more of the methods, functions, operations, or processes occurring within the functional elements or components may be implemented using any suitable technology, including but not limited to socket push, interval polling, http long-polling, etc.

As shown in the figure, a client application 202 (e.g., a browser used alone or in conjunction with a software program that functions to generate a user interface and permit data entry) is installed and executed on a suitable client device (e.g., a smartphone, laptop computer, tablet computer, etc.). Client application 202 is typically implemented as a set of instructions that are executed by a processing element, such as a controller, microprocessor, CPU, in the client device, etc. In one embodiment, the client application may be downloaded from a public or private server after the browser application is used to navigate to a specified web-site or location on the Internet or another network. In another embodiment, the client application may be provided to a user via any other suitable delivery mechanism, such as email, postal mail, download from a network or local data storage element (thumb drive, etc.) Once installed on a client device, client application 202 permits a user of the device to function as a “Participant/Commenter” and/or “Instantiator/Conversation Owner” in the inventive system.

As shown in the figure, and for purposes of a non-limiting example, client application 202 may generate a user interface that operates to display a Visualization 204 to the user, presents another person's comment or statement for purposes of allowing the user to “vote” on the comment or statement 206, permits the user to provide their own comment or statement 208, etc. One or more servers 210 operate to receive inputs from the client device and provide outputs to the device. These “back-end”servers may be connected directly or indirectly to the client devices (such as via one or more intermediary servers, labelled “Proxy Hosts” 211 in the figure). On the “back-end” (i.e., the one or more servers 210 that function as a data processing platform), the comments and votes are stored in a suitable database 214 or other suitable data storage element. The element labelled “Workers” 216 represents data processing and/or computational elements or components that operate to perform the mathematical and statistical operations described herein as part of processing the received data and generating the visualization(s) used to represent the votes, groups, sub-groups, clusters, etc. as described herein. Datastore element 217 represents a data storage component in which “snapshots” of the clustering and dimensionality reduction results from processing certain of the input data may be stored and accessed for presentation to users. This may assist in reducing the client side processing needed to enable a user to comprehend the inputs.

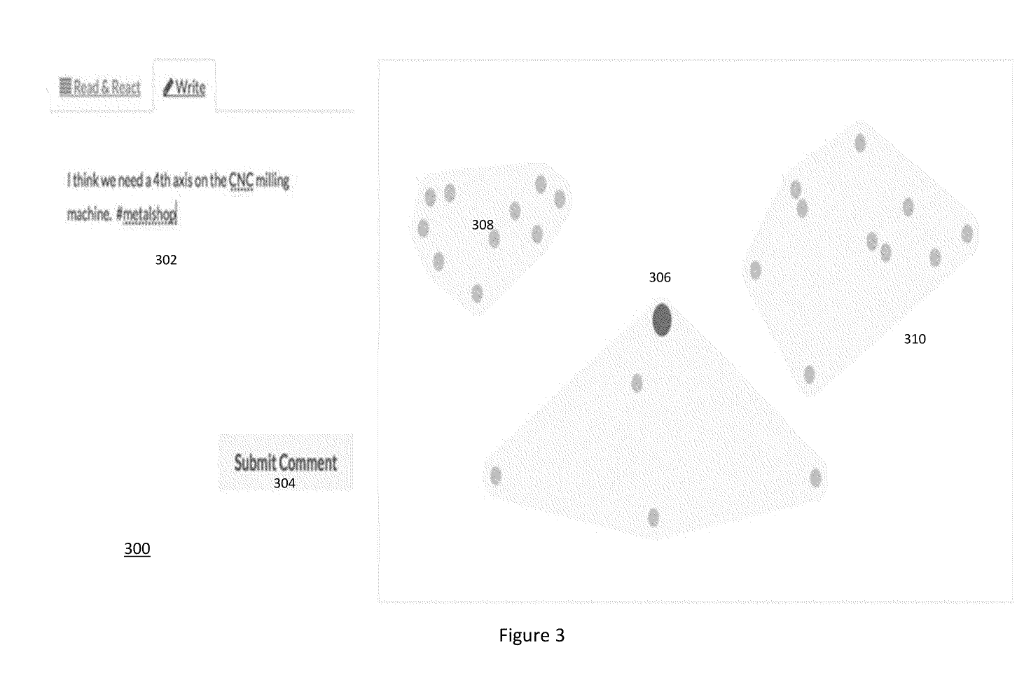

FIG. 3 is a diagram illustrating an example user interface 300 for a first participant that may be used as part of implementing an embodiment of the inventive system. As shown in the figure, a user (Participant A) is submitting a comment or statement 302 for consideration by other participants. The client application is in “write mode” (which may be accessed via a “tab” or other UI element) which makes available an editable text area, as well as a button 304 for submitting that text as a comment. This UI display 300 does not necessarily need to be accessed via a separate “write” tab/mode, and could be shown simultaneously with other comments. However, one reason to keep the comment form visually separate from the other comments is to encourage writing comments that don't depend on other comments for context. In the figure, Participant A is observing his current position within the projection as a red dot 306. The other participants are shown as dots 308 which are less emphasized than the red dot. Groups, sub-groups or clusters of projected participants may be indicated by wrapping their respective dots in a visual bounding shape 310, which can be drawn using a shape that contains every dot (or those falling within some criteria, such as within a distance from a center of mass, etc.) in the cluster. Shown in the picture is an example where the bounding shape is a convex hull, where the shape can be calculated using a graphics library (e.g., D3).

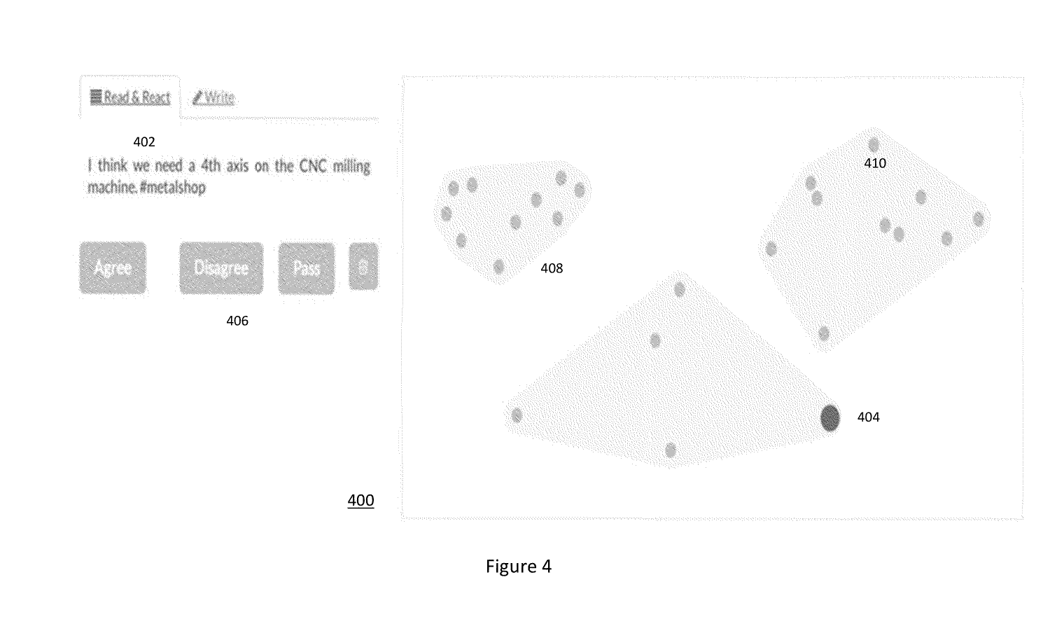

FIG. 4 is diagram illustrating an example user interface 400 for a second participant that may be used as part of implementing an embodiment of the inventive system. As shown in the figure, a user (Participant B) is preparing to vote on or otherwise react to the comment 402 submitted by Participant A. Participant B is also observing his current position within the projection as a red dot 404. As Participant B reacts to comment 402 by clicking agree, disagree, pass, or trash (as indicated by “buttons” 406), he will observe his own position change (typically in real-time or pseudo real time), as well as the position of others. This is because the inventive system operates to re-compute the position of all participants relative to all other participants based on their respective voting behaviors within the conversation. At a point in this process, Participant B can click on a group 408 or an individual 410 to see more information and metadata related to that group or individual, including but not limited to: the comments they have found most important; the comments that were divisive within a group, and; their name if the conversation is not anonymous. In addition to the comment 402 which the participant is being prompted to vote on, other comments may be shown simultaneously, such as a list of comments which the participant has already voted on. This list may offer the option of changing votes or selecting comments to learn more about them, possible causing the visualization to show how each participant voted on the selected comment.

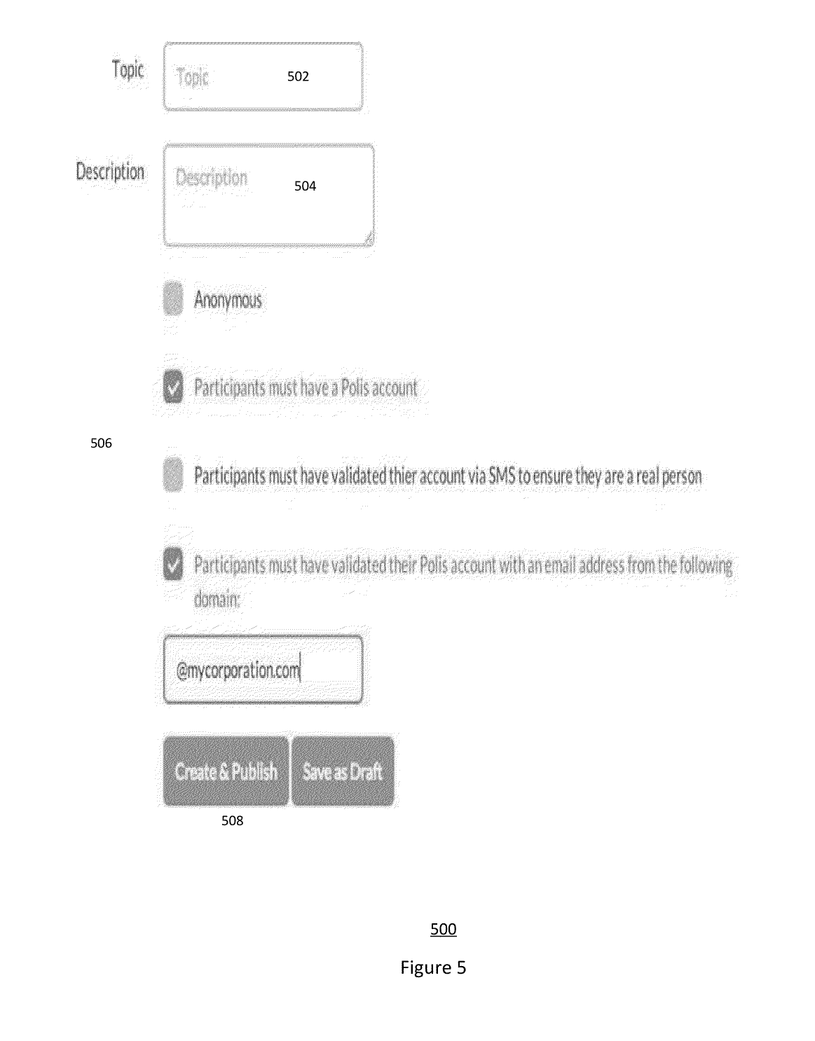

FIG. 5 is a diagram illustrating a user interface 500 to permit a user to submit a comment or initiate a new conversation that may be used in implementing an embodiment of the inventive system and methods. The user may optionally specify a topic 502 and/or a description 504. Various other options 506 may be selected, such as whether the participants should be shown as anonymous, whether participants must have created accounts with the service provider, whether participants must be authenticated, or other limitations such as membership in certain organizations, etc. In some embodiments, limits may be placed on the total number of participants that may join the conversation. A minimum number of participants may also be set, which may prevent the conversation from starting until a certain number of participants have joined (interested participants may be notified when enough participants have joined by email, SMS, or another notification system). When a user is satisfied with the structure and terms of the conversation they wish to initiate, they may “publish” the conversation by activating a suitable “button” 508.

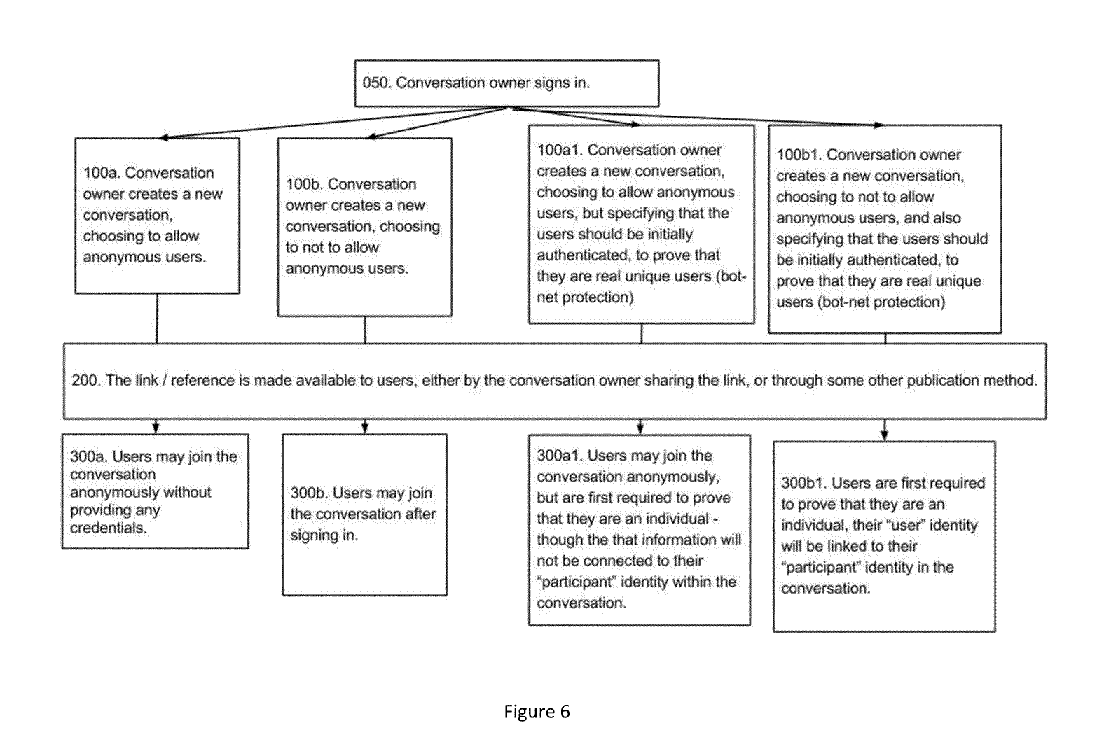

FIG. 6 is a flow chart or flow diagram illustrating a typical process or data flow for a conversation owner to initiate a conversation and for a user to participate in the conversation, in accordance with an embodiment of the inventive system and methods. With reference to the figure, the following is a brief description of the steps or stages involved in using an embodiment of the inventive system, after a user has installed the client application:

050—Conversation owner activates the client application and signs in—this may be accompanied by an authentication process (such as username/password, PIN, etc.). In one embodiment, the options presented to the user are then:
100a—Conversation owner creates a new conversation, in this example choosing to allow anonymous users;
100b—Conversation owner creates a new conversation, choosing to not allow anonymous users;
100a1—Conversation owner creates a new conversation, choosing to allow anonymous users, but specifying that the users should be initially authenticated, to prove that they are real unique users (i.e, a form of protection from bot-net participation);
100b1—Conversation owner creates a new conversation, choosing to not allow anonymous users, and also specifying that the users should be initially authenticated, to prove that they are real unique users (i.e., a form of protection from bot-net participation);
200—A link/reference URL or other form of identifying a location where the conversation is hosted is made available to users, either by the conversation owner sharing the link, or through some other publication or transmission method (e.g., generation and transmission of a notification message, invitation, etc.). A user wishing to participate in the conversation may then join the conversation in accordance with one of several options;
300a—Users may join the conversation anonymously without providing any credentials;
300b—Users may join the conversation after signing in (and if desired by the conversation owner or system administrator, after being authenticated);
300a1—Users may join the conversation anonymously, but are first required to prove that they are an individual—though that information will not be connected to their “participant” identity within the conversation; and
300b1—Users may join the conversation but are first required to prove that they are an individual—that information will be connected to their “participant” identity within the conversation.

As recognized by the inventors, in order to encourage adoption of the inventive system by prospective users, it is desirable that the system have operating characteristics that enable users to obtain the most benefit from it. These operating characteristics include, but are not limited to fostering a high degree of user engagement, providing a high degree of fidelity with respect to comments or statements and other users' responses to those, a high degree of scalability to enable use of a relatively large number of people as participants in a conversation, and providing a relatively clear and easily understood mechanism for communicating similarities and differences between a user's view/opinions and those of others who are part of a conversation. In order to enable these and other desirable operating characteristics, the inventors developed technical solutions to problems related to latency, a possible lack of sufficient viewer engagement, the lower scalability of certain facets of a conventional communications system, and the illustration of a viewer's opinions or statements relative to others who are participating in a conversation.

Prior to discussing these technical solutions that function to improve the operating characteristics of the inventive system and methods, several typical use cases or scenarios for the invention will be described. These use cases are examples of ways in which an embodiment of the invention may be used to enable an effective understanding of the views, opinions, values, etc. of participants in a conversation and also how those views change over time as participants contribute to the conversation. In some embodiments, the inventive system and methods enable individuals to coalesce into one or more “groups” based on common values or opinions, and to then more effectively engage in activities or pursue common goals.

### Example Use Cases for an Embodiment of the Invention

The following are brief descriptions of several use cases in which an embodiment of the inventive system and methods may provide benefits and advantages not available from conventional communications systems. One characteristic of these example use cases is that using conventional systems an individual is able to broadcast content to a scalable number of people and would benefit from being able to receive an understandable and high fidelity response to that broadcast, but is unable to do so because of the limitations of current technology and methods.

### Professors/Teachers

As class sizes have grown in response to an increase in on-campus enrollments and budget cuts, educators have struggled to engage students in classes that can range in size up to (and above) 500 students. Class sizes have also grown because of online learning models, where professors administer classes with an online homework component or in situations where all of the activity is online, regardless of the class size. Students currently participate in polls and surveys given in class on proprietary hardware, or with new real-time polling software offered by companies such as Poll Anywhere, Google docs or Survey Monkey. Students also participate in discussions on forums. However, consistently across all present classroom or audience engagement tools, there is a high degree of overhead for professors and TA's, and a low degree of potential insights that can be garnered from the students' responses.

In contrast, the inventive system offers a relatively low overhead approach to instantiating a conversation and also a high degree of synthesis and rapid comprehensibility. Students can navigate to a provided link (URL) and immediately begin submitting comments in response to the professor asking an open ended question, such as “What did everyone think of the reading last night?” Rather than getting one or two students raising their hands, the professor would be able to receive hundreds of comments and a significant amount of voting related data. The data visualization could be presented to the class on a screen and the professor could actively navigate the visualization as it was generated and as it changed in response to new comments, etc. During an analysis phase, a professor could point something out like, “It seems roughly 70% of the class, the majority, thought that Mr. Black did the right thing by leaking the documents, while 30%, the minority, felt he was in the wrong—could each group continue to elaborate on why?” At this point in the conversation, students might stop responding to the article and begin to answer the professor's questions, all in real time.

In one embodiment, this could be arranged to happen semi-automatically—the professor might select the primary groups, and create new conversations with specific questions for each of those groups. The client-side application used by the students would automatically switch to these new conversations, so the students would be simultaneously contributing to their respective new conversations. By comparison to multiple choice questions, which don't stimulate conversation or discussions in class, the inventive system's open ended approach could lead to social arrangements where groups that appeared in the visualization are identified and the students in those groups move to different areas of the room to discuss things further. Note that there are currently no communication platforms available that could accomplish this process. Because of this, no other communication structure could provide a professor or instructor with a way to address groups of students in a targeted way with specific follow up questions, without regard for both the number of people and the number of issues.

### Conference Organizers and Speakers

Conference speakers face many of the same issues as professors; they frequently have hundreds of people in front of them and no obvious way to interact with them all simultaneously outside of broadcasting their voice and images to the group. This goes against the very idea of a “conference”, which is based on conferring with one another. As a result, the structure of modern day conferences is generally more like a broadcast of a lecture, with little feedback from the audience that can affect the discussion or illuminate the opinions and variety of opinions of the audience.

In contrast, the inventive system can provide value because it allows large groups to provide real time feedback with regards to a divisive or substantial issue. For example, in a room full of doctors with a doctor leading the session, the speaker might ask about strategies for treating a disorder or dealing with new legislation. In a room full of teachers, the speaker might ask about the limits to differentiating instruction within one. As with educators, there are currently no conventional communication systems that can provide a speaker with a real time understanding of the complexities of the groups based on the members' opinions and the social structure in the room in a comprehensible and actionable way. The inventive system could be used to facilitate pre-conference discussions online before attendees arrive, mid-conference topics that unify the entire conference, specific sessions could use the invention so that speakers could have an interchange with the crowd in a deeper and more complex way than just by a show of hands or single questions, and interactive post-conference follow-ups would also be possible to evaluate the level of interest in certain topics.

### Marketers

For many organizations, email lists are vital to communications and fund raising. However, a core problem with email lists is that while someone may express an interest in “learning more” about an organization in which they are or may become involved, they do so for very different reasons. This makes it difficult to avoid sending out communications which are untargeted and exhausting the limited attention span of many in the intended audience.

As an example, consider a gym in a small city. If the owners possess an email list of a couple thousand past, present and potential members, then they will send a message to that entire list with class offerings, a description of equipment upgrades, events, etc. Someone who is completely disinterested in running, however, should not be sent an email update about a local 10 k event for which the gym is sponsoring training. Currently, there are few (if any) options outside of polls for assisting in segmenting a group into sub-groups based on interests. Polls are un-engaging, but do offer a scalable solution to figure out who wants what information or services. However, while polls may be useful in a limited sense for differentiating customers, they do not naturally produce groups that are affiliated by a common interest.

In this example, market researchers could use the inventive system to transform an undifferentiated email list into a series of targeted email lists based on self-indicated interest(s). Market researchers would be able to see how participants reacted to each other's ideas, rather than polling them individually. Using the inventive system, market researchers could simultaneously ask thousands of engaged customers open ended questions to solicit feedback about products, prototypes or services. In that situation, the system could be used to produce a subset of an email list. The hierarchical clustering produced by a conversation can be used to produce groups which represent subsets of the email list.

In one embodiment, these groups (subsets) can be displayed in different ways. One way would be to use a tree view, where the nodes are clusters. Expanding a level displays the sub-clusters. In an adjacent view, lists of emails (or other information) could be shown in separate containers, where each container includes the participants that are within that sub-cluster. An alternative to the tree view would be to put the visualization adjacent to a list of containers, and use the visualization to expand/collapse nodes. This could be integrated with an email sending tool, where the groups produced and tags associated with each group could differentiate the batches of emails sent to those on the email list.

One variation of this idea would be to use the same email (newsletter, etc.) for all people on a contact list but to arrange the sections in a different order for each group of people having a common interest, or have certain less relevant sections left out or replaced with an alternate version. For instance, suppose a makerspace has a metal shop, electronics benches, and 3D printing machines. An email is sent to the mailing list for the makerspace, asking to hear what people want more of. Respondents comment and vote, and are formed into groups. These groups are used to generate emails regarding metal shop issues to those who care about the metal shop, and different emails or content are sent to those that care about the 3D printers, etc. Tags may be suggested by natural language processing, or may also be created by participants, or the instantiator. Tags may be entered using a special syntax, like #metalshop, #3dprinting, or @metalshop, @3dprinting, etc. A special syntax or application/widget may make it relatively easy for users to generate tags. An email generating application can make use of the system derived clusters and a list of tags and their corresponding weights for each cluster to determine which sections of the email should be prioritized for each cluster.

### Academic Social Science Researchers

In this use case, the inventive system could be used to minimize the opportunity for bias introduced by researchers in social science surveys. There is a difference in this regard when using PCA on comment votes as described compared to using other potential methodologies: instead of relying solely on strong assumptions about the data in order to construct the indexes of similarity (i.e., distances) that the other methods rely upon, the inventive system leverages individuals' real world knowledge to get a sense of what statements and viewpoints are close to one another. The inventive system provides an affordable means of both studying and experimenting with group deliberation processes, because insights about consensus and disagreement can be derived from the data collected. The inventive system provides a novel and potentially powerful way of understanding the role of “framing” and ideology in peoples' way of thinking about the world (in contrast, most social science research has had to focus more on powerful or at least very vocal actors). While detailed and computationally intensive analysis of public comments in existing forums might provide some of this information, the invention gives a much richer set of information both in terms of content and dynamics. Data that is generated by the inventive system is in a form that is amenable to application of machine learning methods that focus on “text as data” (e.g., Sentiment Analysis, Topic Modeling, dictionary approaches, etc.), where such methods are being used more frequently in both the social sciences and in “Big Data” research. Using an embodiment of the invention, a researcher is able to couple textual inputs with the history of a discussion and the reactions of participants to others' comments; this represents a potential to advance these types of investigations.

### Activists

A common problem that reduces the effectiveness of activist movements is the dilution of the movement as it grows and takes on more members. During many recent democratic movements (such as those of the Arab Spring in Iran, Egypt and Bahrain and movements in the US such as Occupy Wall St.), effective communication has proved to be a limiting factor in the efficacy of the movement. This is particularly noticeable as a movement evolves from a gathering of passionate people into a united front and then develops into a stable political force. During the Occupy movement, a technique called the “human megaphone” emerged, whereby someone who wanted to speak to the crowd would say something, and everyone else would repeat it in unison afterwards so that the words could be amplified. However, what was initially an exciting and chaotic outburst of energy lost momentum because of its inability to cohere around a set of shared beliefs and an inability to identify and differentiate groups, subgroups and differing agendas.

Regardless of whether a movement is a grassroots one or is led by an opposition figure, political movements could utilize an embodiment of the inventive system to identify clear sub-groups, each with an ideological focus, and points of overlap and/or distinction. Members of a group, or the leaders of a group (note that anyone can instantiate a conversation), can use the system to instantiate a conversation and ask an open ended question of a large crowd. Further, using a suitable service (e.g., Twilio), those who instantiate a public conversation could set geographic limits on participants, thereby allowing only those with a cellphone validated with an area code from a specified region or city to participate in the conversation.

In any political movement, there are supporters of core, central ideals and also fringe extremists. The inventive system could be used to help groups discover and publish evidence of their core ideals, with the conversation serving as a “living document” and snapshot of a population's views. This could have multiple benefits. First, it could allow groups to define and then refine their identity. Second, it could help groups to transparently set their agenda and priorities for members. Third, it could allow groups to demonstrate in a transparent way that the more extreme elements are not representative of the majority, thus controlling and if needed, altering public perception of the movement.

In this use case, an embodiment of the inventive system provides benefits and value that other systems do not provide. For example, with surveys, which are a typical means of gauging the thoughts of participants in a political movement, there is no ability for the group to communicate amongst itself; only communication back to the originator of the poll is enabled. While email could work among just a few leaders of an activist movement, the possibility of hundreds or thousands of people communicating effectively on an email chain is impractical. Similarly, while thousands do communicate on forums and on platforms such as Twitter, these methods do not facilitate reaching consensus or forming groups in a way that an activist can use to refine their goals and solidify their movements. An embodiment of the invention can overcome these disadvantages of conventional systems while providing new benefits and enabling more effective communications in many settings.

### Politicians

Politicians are often insulated from their constituents by the high costs associated with communicating with them simultaneously en masse and in a coherent fashion. Bureaucrats are similarly insulated from those whose interests they are charged with administering because of the cost and complexity of the communication mechanisms available. In this respect, politicians and bureaucrats suffer from a lack of a process to effectively synthesize a large number of high fidelity inputs from constituents. Currently, they typically receive letters from the public and solicit meetings with interest groups and lobbyists—which are high fidelity—and run polls of their constituents—which have a high degree of synthesis—to make their day-to-day decisions. However, combining these attributes into one system (as is done by embodiments of the inventive system) would allow a politician or bureaucrat to do something he/she has hitherto been unable to do: engage in a comprehensible, real-time dialogue with an entire body of constituents, even if the number of participants greatly exceeds a number that would render other communications systems ineffective or impractical (such as tens or hundreds of thousands of people). When running the inventive system with a targeted set of people, the participants themselves will identify wedge issues critical to winning their votes. Politicians, whether in the government or opposition, will then be able to observe patterns emerge and identify areas of consensus.

One observation by political observers is that the political landscape becomes polarized in part because centralized figures can cause groups or factions to come into existence by speaking about them, without providing actual evidence of their existence. For example, when media figures speak of broad classes of people, such as “democrats” or “republicans”, they ascribe an arbitrary boundary around hundreds of millions of people based on an assumed set of commonly held beliefs (which typically relate to a small set of “hot button” issues and fail to reflect the diversity of values and opinions among members of either group). Politicians, as well as constituents, fight over these simplistic and potentially damaging stereotypes. The true set of beliefs of an individual or group are more complex and exhibit many gradations, and the consensus between groups may be much deeper than recognized or assumed.

Embodiments of the inventive system can be used across all levels of government, and by administrative officials and bureaucrats. For example, a town council could engage an entire town in dialogue about a controversial issue. Conversely, a citizen who lives in a town could engage the entire town in a discussion and forward the resulting conversation to the town council during a comment period to demonstrate widespread support for an idea or proposal. Similarly, a bureaucrat who is administering forestry services could get input from people in the field. Such examples of feedback from constituents can be very valuable, as politicians frequently walk into town halls blind to the issues that really matter to the attendees (typically because they don't know the composition of the crowd). In one use case, the inventive system would allow a staffer to “warm up” the crowd with an anonymous interactive survey that would build crowd awareness of the issues that were of importance to discuss. Those who had submitted comments (if they desired) would be able to be representatives of many people in the audience. This could lead to a more substantive debate or discussion.

Because the inventive system and methods permit a crowd to identify and choose a representative or leader/thought leader (e.g., by “starring” their comment—if enough people do that a comment will stand out as one that is highly agreed with), embodiments of the invention provide a method for a group to define its vision of itself and choose the best representatives of its views. This offers a more robust and participatory method for encouraging and gathering feedback and stimulating discussion than petitions, because it allows representatives to see what was agreed upon and disagreed upon, and what ideas carried broader support. In one use case, an embodiment of the invention could be used on a very large scale (e.g., on the order of millions of people), so that United States Senators could have a substantive, real-time discussion with the people of their state without bad actors sabotaging the conversation.

Note that in one respect, the invention allows for crowd sourced “garbage collection” in that “bad” comments are filtered out through “flagging” rather than having greater and greater effect. In addition, minority opinion groups are visible and able to see and then interact with each other. This can assist in the development of stronger voices for minority points of view, and a more effective presentation of alternative values, policies, etc. The inventive system allows each group that emerges to examine, in detail, the values and beliefs of the other groups. In some cases, the invention may add value if it demonstrates areas of commonality or consensus between groups that were not apparent before. This may lead to compromise solutions and more effective implementation of policies and regulations.

### News Outlets and Blogs

As is apparent, news and media outlets are moving online. One of the services they provide is to bring experts together to talk about issues. Examples of this are Economist Debates, NY Times Room for Debate, TED Conversations, etc. The idea of “hosting a conversation” appears across multiple media outlets, but is frequently frustrated by a lack of participation and the limitations of conventional communications systems. For example, comments that scroll down endlessly do not engage most readers, who are not likely to read 300 to 600 comments, many of which are saying the same thing. This represents time on the page, and likely advertising dollars, which could be recovered by the news outlets if there were a more effective and engaging discussion platform.

In one example use case, the inventive system could provide a way for many users to respond to an article by an Op-Ed writer. The writer would write a column and users could agree and disagree with one or more of the key ideas. Users could submit responses and other users would be able to vote on those responses. The conversation might lead to a follow up question or dialogue, and new instantiation of a conversation by the Op-Ed writer. This might cause readers to go back to the site to continue engaging in the conversation. In this context, an embodiment of the invention has the possibility of replacing “most recent at the top” vertically scrolling comments in favor of something that would give readers a “position” on an argument. Sites attempting to facilitate dialogue between experts might use only expert comments as the seed comments to vote on, while users are then clustered based on what expert they are agreeing with.

Note that comments submitted by users do not need to be in the context of an instantiated conversation as described herein; in fact, something like an Op-Ed or the State of the Union speech could be broken down into chunks of text by idea, and readers could use the Agree, Disagree, Pass, Star or Trash buttons (for example) to vote on sentences or paragraphs. This represents another use of the invention; note that comments being submitted by users are only one possible aspect that users could vote on.

### Working Teams

Teams within a business have many decisions to make, and each team member brings different information (typically both fact and opinion) from the array of experiences they have on a day to day basis. Getting all of the stakeholders for an issue into one room is costly in terms of travel time and scheduling. However, because the inventive system can serve as a decentralized, distributed decision making platform, it can eliminate the need for some meetings. Note that the pervasiveness and enormous time-off-task cost of meetings within organizations speaks to the lack of communication structures capable of efficiently facilitating decision making. For example, email does not facilitate effective team decision making because it continues to branch out (as there is no synthesis inherent in the structure), as forums do. This means that each individual in the conversation must read from the beginning and produce a synthesis in his own head at a cost of time and concentration, which increases dramatically as the number of participants and emails increases.

While it is often too time consuming to conduct an effective decision process over email, managers can use an embodiment of the invention to tap into the expertise of employees across divisions or dispersed geographic locations. An example use case involves a manager who has a number of people in the field and needs to make a high-level decision that is guided by bottom-up knowledge. Besides occurring in business, this is a prevalent problem in the military as well as in nonprofit institutions such as universities and hospitals, where high bandwidth input is critical but time is short and key stakeholders are decentralized. A law firm may face a similar problem, where a flat power structure among partners requires consensus building in order to move forward with implementing a policy.

Since the invention provides a decentralized communication system where anyone can start a conversation and invite others (like email), the converse use is also possible. An embodiment of the invention can be used by a group of employees wishing to start conversations with management and present their opinions without calling a meeting, which would need to pull in many stakeholders. Additional value could be provided by generating consensus, which typically involves a pattern of communication that would lead to complex email threads, but could be accomplished very efficiently using the invention.

### Designers/Creative Persons Seeking Peer/Client Review

Note that the use cases described to this point have been based primarily (if not solely) on textual content. However, the inventive system is agnostic with regards to the medium of the inputs that are voted upon; as examples, the inputs may be text, audio, video, images, etc. A use case involving images might be that of a creative firm with both internal and external stakeholders. In this use, images could be posted instead of comments, and participants could “agree” or “disagree” with the prospect that they were good designs. This would have value to advertising executives, creative teams, graphic designers, businesses deciding upon a trademark or logo, brand consultants, photographers, etc.

### Monitoring of a Group and Coordination of Group Behavior Over Time

An embodiment of the inventive system can also be used with one or more comments being “seeded” at the beginning of a conversation. In one such example, the comments would not change and participants would not be able to input new ones. In this use case, votes may change over time in response to changes in the environment or thoughts of the users. Assuming, for example, 20 comments and hundreds of participants, the invention could serve as a monitor for a central organization (such as someone leading a rescue effort) to observe field personnel who could change their “state” or “status”. Selecting a group and examining its metadata (location, problem encountered, resources needed, etc.) may reveal a pattern in location and then resources could be diverted to that location. Similarly, geo-locating groups, or assessing correspondence between people's state and a geographic location (i.e., using location data to interpret state or comment information), are also possible applications for the inventive system.

### Technical Aspects of Certain Operations of the Inventive System

For users, an important aspect of a communications system in which messages or information is exchanged is that it has an acceptable level of latency, meaning that the time delay between sending and receiving messages (or updates to a display) is not such that users lose interest in a conversation or forget important details. With regards to the inventive system and methods, the inventors recognized that an important operating characteristic and an enabler of a scalable system was that the processes used for updating a user's “red dot” relative to other participants be relatively fast and optimized for presenting the user's position quickly after submission of a comment or response. This is expected to maintain the user's interest in the conversation and improve the scalability of the system to larger numbers of participants.

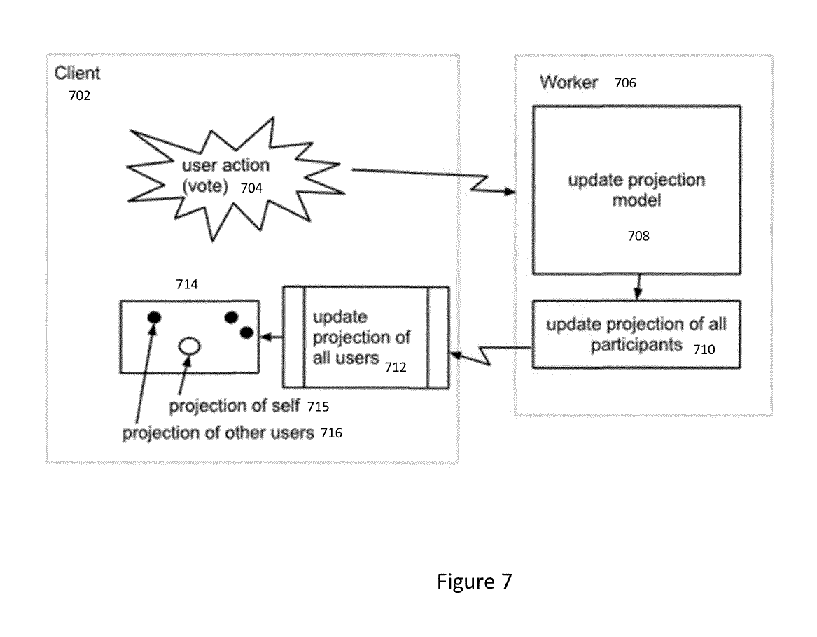

As discussed, one area in which the inventors have provided technical solutions to latency concerns is that of the update and presentation of a user's “red dot” indicator. In this regard, FIGS. 7-10 are diagrams illustrating examples of the primary elements, components, and methods that may be used for updating and displaying an indicator corresponding to a user (e.g., the “red dot”) and the relative position of one or more other participants to a conversation in an efficient and effective manner, and that may be implemented in one or more embodiments of the inventive system. Note that based on the user's comments, votes, or other indicia, the user's position in the visualization/display may indicate that they are part of a group or groups, part of a sub-group or sub-groups, or that they have provided responses which place them outside of the groups or sub-groups to which other participants to the conversation belong.

FIG. 7 is a diagram illustrating the high-level concept of a vote causing the projection to update. As shown in the figure, a user votes on a comment using an interface on their client device that is generated by the client application 702. The vote represents a user action 704 that is processed by the client application and transferred to a “worker” data processing process 706 (typically over a suitable network, such as a wireless network coupled to the Internet), which is typically executed on a remote server or other form of computing or data processing element. The data processing performed by worker 706 may include performing an update to the projection model 708 for the user and generating an update for the projections of all participants in the conversation 710. The update for all participants 710 is then provided to a process 712 in the client application 702 (typically over a suitable network, such as the Internet and a coupled wireless network) which operates to update the visualized projection of the participants to the conversation. In the visualization viewed by a specific user 714, the user's projection 715 is depicted in a manner that permits it to be differentiated from that of other participants to the conversation 716.

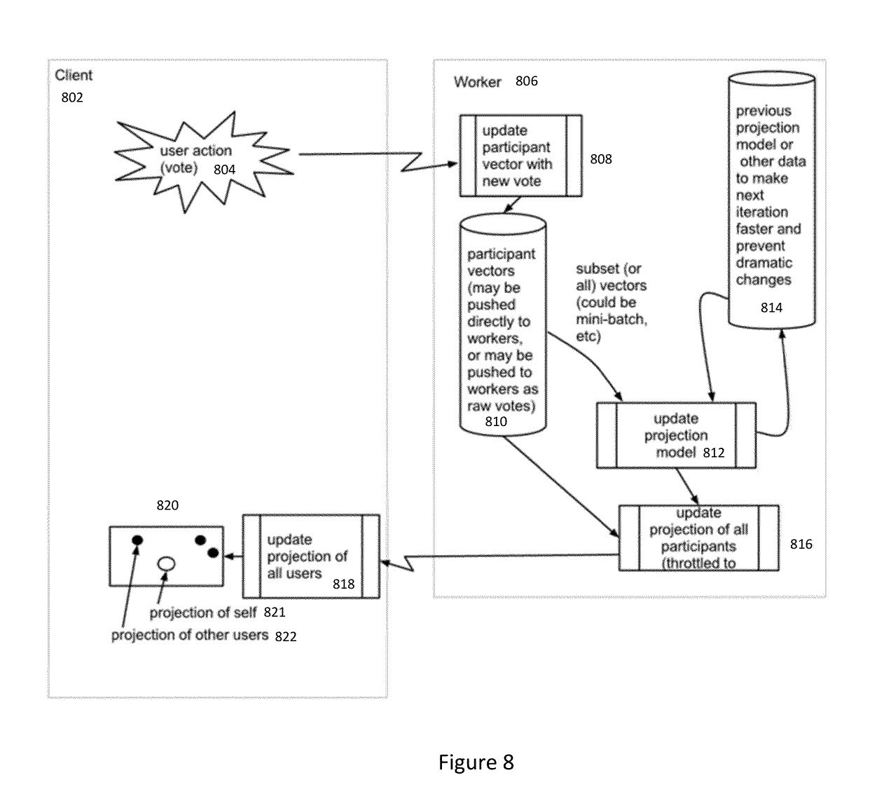

FIG. 8 is a diagram illustrating in greater detail how votes may be used to construct participant vectors, which are then used to update the projection model. Note that the previous version of the projection model may be used instead of generating new participant vectors, for example, by starting from the previous auto-encoder weights (the previous vectors may also be used to prevent axis flipping relative to the previous projection). FIG. 8 also illustrates the separation between updating the projection model, and using that model to update the projection. Note that the “update projection” step is repeated on the client and on a worker element. This step could occur in either location, but projecting all users on the client device would require sending the participant vectors for all users to the client, and thus may encounter problems with available bandwidth, latency, or processing capability. As shown in the figure, a user votes on a comment using an interface on their client device that is generated by the client application 802. The vote represents a user action 804 that is processed by the client application and transferred to a “worker” data processing process 806 (typically over a suitable network, such as a wireless network coupled to the Internet), which is typically executed on a remote server or other form of computing or data processing element. The data processing performed by worker 806 may include performing an update to the participant vector for that user 808. The updated participant vector (or other form of representation) may then be “pushed” to a worker or workers for further processing 810. In one embodiment, the updated participant vector is provided as an input to an update projection model process 812. Update projection model process 812 may access data related to or representing a previous projection model from a database or other data storage element 814. This may be desirable in order to improve data processing cycling for iterations of the model. The updated projection model may then be used to generate an update of the projection of each participant 816. The update for all participants 816 is then provided to a process 818 in the client application 802 (typically over a suitable network, such as the Internet and a coupled wireless network) which operates to update the visualized projection of the participants to the conversation. In the visualization viewed by a specific user 820, the user's projection 812 is depicted in a manner that permits it to be differentiated from that of other participants to the conversation 822.

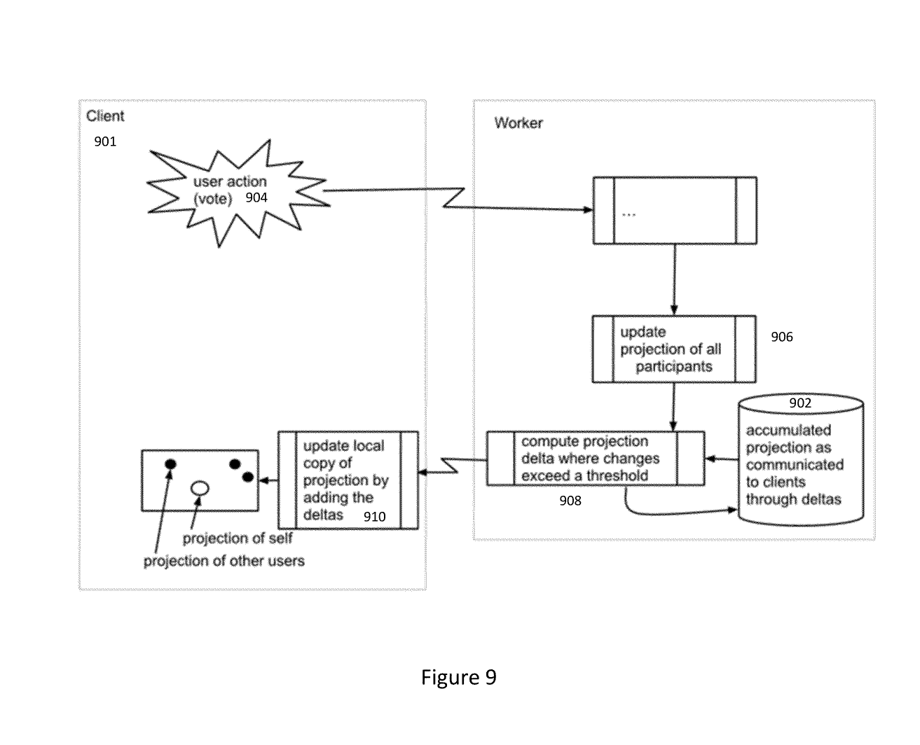

FIG. 9 is a diagram illustrating how, given the most recent projection, a delta (difference) can be produced relative to the previous projection. This process may be used as a way to update a projection in a more computationally efficient manner than recalculating each aspect of a projection to produce an updated projection. With reference to the figure, the “accumulated projection as communicated to clients through deltas” 902 is a database or data storage element that contains the sum of projection deltas which have been made available to clients. In the interest of conserving bandwidth and reducing latency, deltas for participants that have not moved very far may be omitted from the set of deltas sent to clients. This may be determined by a thresholding operation or similar process. As shown in the figure, upon receipt of a vote 904 from a participant, an update process if performed to produce an updated projection for each participant 906. A process then uses the updated projections 906 and the accumulated projections 902 to determine those projections for which the change in projection exceeds a threshold value 908. Note that this “threshold value” may be a fixed or variable number or percentage, and also may include one or more conditions, criteria, tests, or rules that are used to determine when the updated projection for a particular participant is significant enough to provide to the client 901. For those participants where a new delta value is provided to client 901, the client executes a process 910 by which a local copy of the projection for each participant is revised or updated to take into account the received delta value. As with other embodiments, in the visualization viewed by a specific user, the user's projection is depicted in a manner that permits it to be differentiated from that of other participants to the conversation.

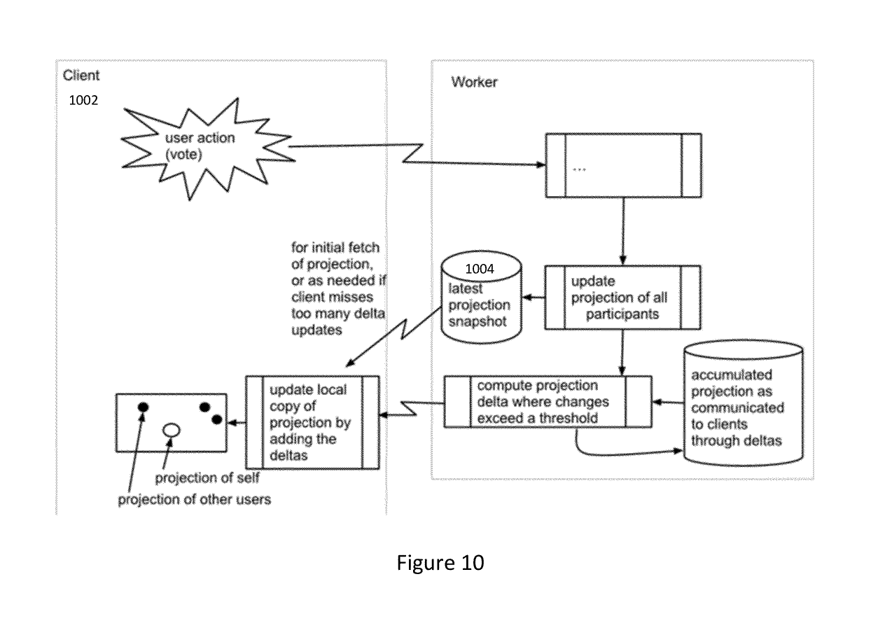

FIG. 10 is a diagram illustrating a variation of the embodiment shown in FIG. 9, where the client 1002 may fetch a “snapshot” of the accumulated projection from a suitable database or data storage element 1004 when that is more efficient than fetching the entire history of delta values. This approach is expected to prevent the need for storing the delta values, since the accumulated projection values (which might otherwise be used) are expected to be very similar to the latest projection values (as captured by the snapshot 1004), and within the threshold for any participant's projection.

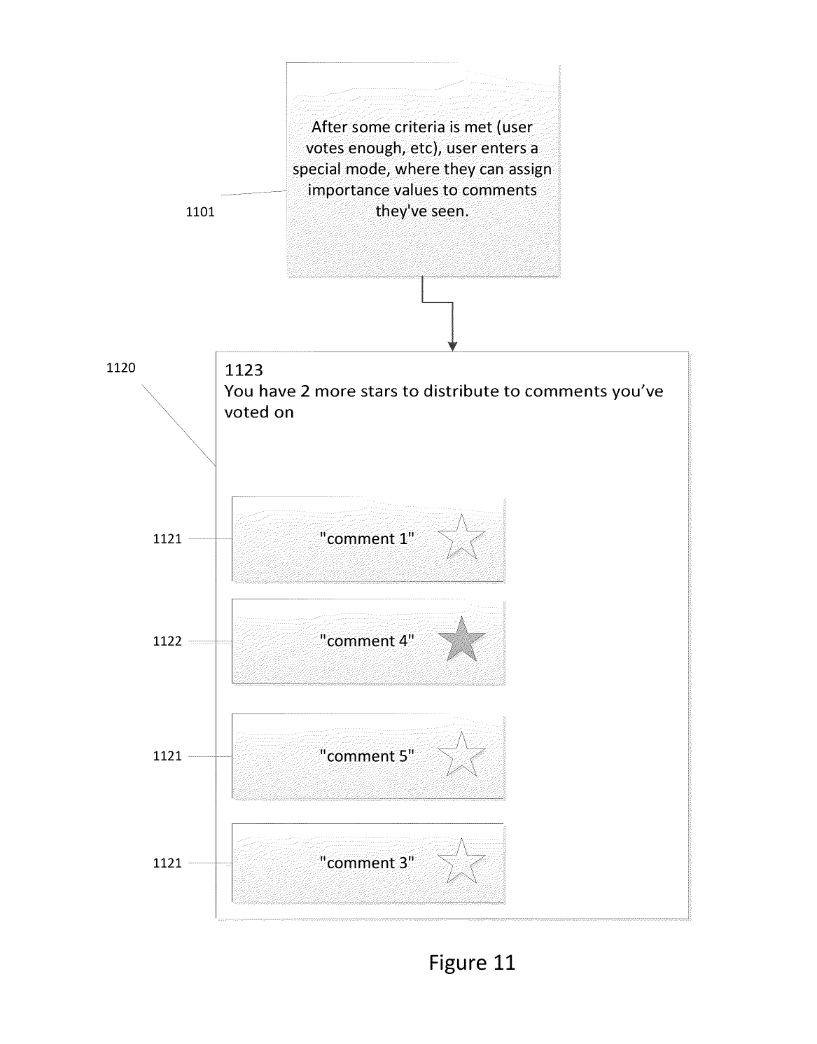

FIG. 11 is a diagram illustrating a user interface or display that may be used to assist a user to rank or otherwise assign importance or significance to a set of comments. FIG. 11 illustrates an example user interface for a participant in the inventive system, where the participant has triggered some condition 1101, (such as by voting on enough comments) and they then enter a mode where they can apply a number of stars to comments they think are important. A list of comments 1120 is shown, with some comments 1121 having no star applied yet by the participant, and a comment 1122 which the participant has applied a star to. The participant can click/tap on the comments or stars to toggle whether the star is applied to that comment or not. A label 1123 informs the user of how many stars they have remaining. A benefit with separating this out into a unique step is that by making users wait until they've voted a few times, they may have a better perspective on which comments are valuable or are indicative of a more important comment.

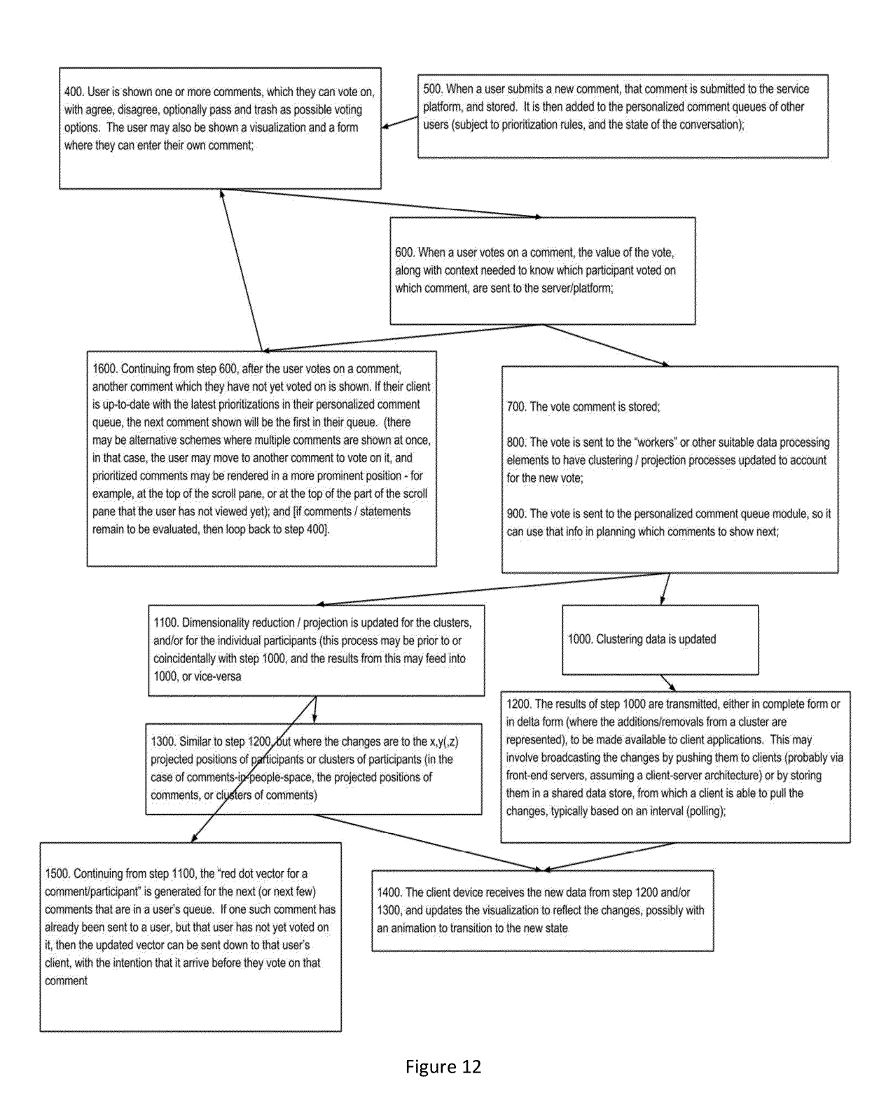

FIG. 12 is a flow chart or flow diagram illustrating a typical process or data flow for a user to participate in a conversation, in accordance with an embodiment of the inventive system and methods. With reference to the figure, the following steps or stages are illustrated:

400—User is shown one or more comments, which they can vote on, with agree, disagree, optionally pass and trash as possible voting options. The user may also be shown a visualization of the voting patterns and groupings, and a form where they can enter their own comment(s). Note that the voting options presented to a user may be defined by the conversation owner and/or the system administrator and may depend on the type of comments expected, the type of information the conversation owner wishes to capture with regards to the comment used to initiate the conversation, etc.;
500—When a user submits a new comment, that comment is submitted to the service platform, and stored. It is then added to the personalized comment queues of other users (subject to prioritization rules, applicable access control rules, and the state of the conversation);
600—When a user votes on a comment, the value of the vote, along with context data used to determine which participant voted on which comment, are sent to the server/platform;
700—The vote comment is stored;
800—The vote is sent to the “workers” or other suitable data processing elements to cause clustering/projection processes to be updated to account for the new vote;
900—The vote is sent to the personalized comment queue module, so it can use that information in planning which comments to show next to one or more users;
1000—Clustering data is updated;
1100—Dimensionality reduction/projection process/model is updated for the clusters, and/or for the individual participants (this process may be prior to or coincidentally with step 1000, and the results from this may feed into 1000, or vice-versa);
1200—The results of step 1000 are transmitted, either in complete form or in delta form (where the additions/removals from a cluster are represented as differentials), to be made available to one or more client applications. This may involve broadcasting the changes by pushing them to clients (probably via front-end servers, assuming a client-server architecture) or by storing them in a shared data store, from which a client is able to pull the changes, typically based on a regular interval (using a polling mechanism);
1300—This may be similar to step 1200, but where the changes are to the (x, y) or (x, y, z) projected positions of participants or clusters of participants (in the case of comments-in-people-space, this would be the projected positions of comments, or clusters of comments);
1400—The user's client device receives the new data from step 1200 and/or 1300, and updates the visualization to reflect the changes, possibly with an animation to transition to the new state;
1500—Continuing from step 1100, the “red dot vector for a comment/participant” is generated for the next (or next few) comments that are in a user's queue. If one such comment has already been sent to a user, but that user has not yet voted on it, then the updated vector can be sent down to that user's client, with the intention that it arrive before they vote on that comment;
1600—Continuing from step 600, after the user votes on a comment, another comment which they have not yet voted on is displayed to them (there may be alternative schemes where multiple comments are shown at once, in that case, the user may move to another comment to vote on it, and prioritized comments may be rendered in a more prominent position—for example, at the top of the scroll pane, or at the top of the part of the scroll pane that the user has not viewed yet); and
If comments/statements remain to be evaluated, then the process loops back to step 400.

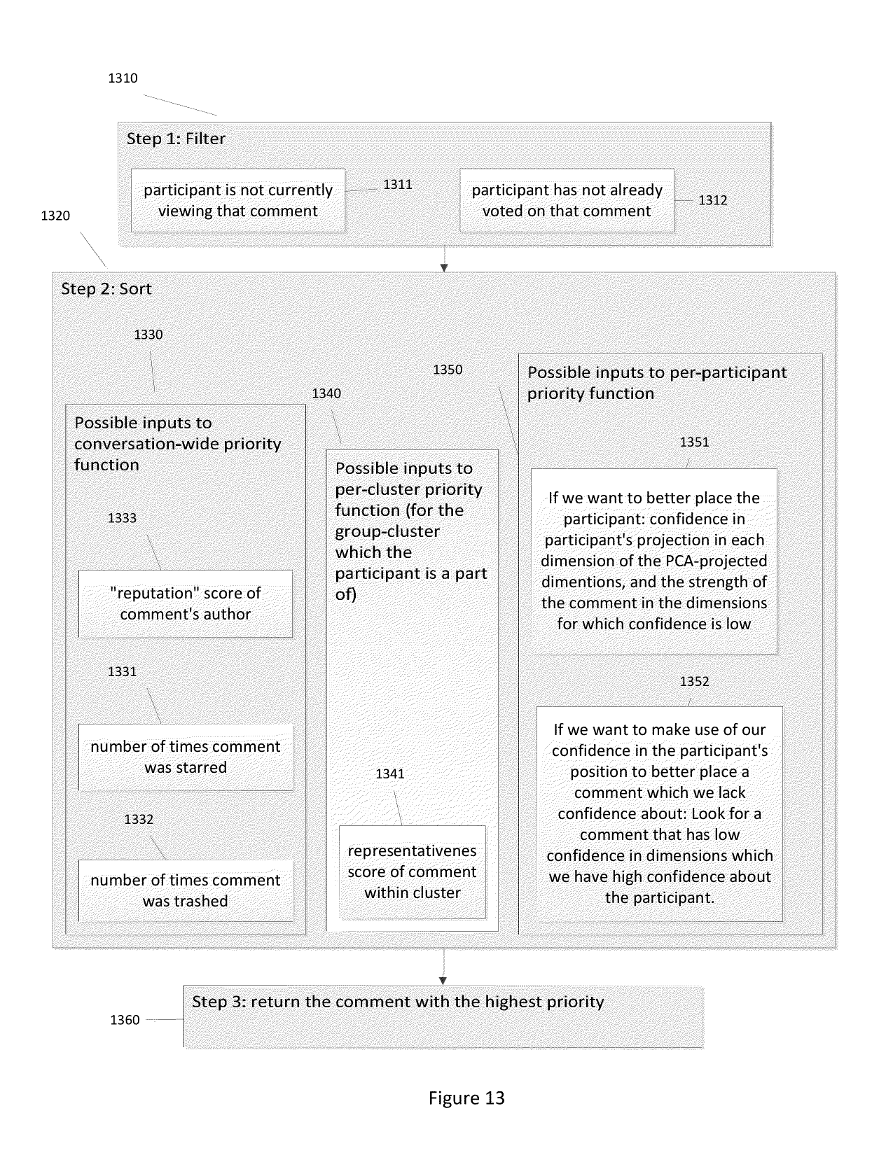

FIG. 13 is a diagram illustrating the primary elements or components and methods, operations, functions, or processes that may be used to implement an embodiment of the inventive system in which comments are shown in an optimized order. This presentation format can be beneficial since participants have limited time to “digest” the information, and may not be able to vote on every comment in the system. One goal of this format is to make the best use of a participant's time, by balancing concerns such as gaining confidence in the user's position/group, increasing positional certainty of important comments, ensuring good vote coverage for comments which are highly representative of some group, etc.

Referring to the figure, choosing the next comment to show a participant may be implemented as a filter and sort function, where comments should not already have been voted on by the participant 1312, and (in the case where comments are pre-cached on the client) the comment is not already being shown to the user 1311. It may be preferable to apply the filter 1310 before the sort operation since the filter has a linear runtime. The second step 1320 is to apply a sort operation, which may consider several objectives depending on the context. The priority can take into account a number of factors, such as the number of times a comment was starred, relative to how frequently the comment was shown. In one example, a higher ratio of this metric would yield a higher priority for the comment.

Note that some inputs to a sort function or operation may be “global” in scope 1330, and not dependent on the participant for whom the system is executing the sort operation. For example, a comment's author may have a reputation score 1333, which would factor positively into a sort for the comment. The reputation score could be imported from a social network, or could be dependent on the participant's behavior in the current and/or other conversations. If a participant has written comments that have received stars, and/or comments that have not received a relatively large number of trashes or passes, these responses to their comments may increase their reputation score relative to other commenters/authors.

Details about a specific comment itself, such as the number of times it has been starred 1331, or (negatively) the number of times it has been trashed 1332 or passed may also be considered. Considering which group-cluster the participant is in 1340, the sort can be influenced by the representativeness score 1341 of the comment in that cluster. Considering information about the participant 1350, the inventive system can calculate the absolute value of projection-model vector loadings for each comment the participant has voted on, for each projected dimension. This can be used as a “measure of confidence” in each dimension of the participant's projection. For dimensions with relatively low confidence, comments with large projection-model vector loadings in those dimensions can be prioritized for that user 1351. Conversely, if the user's projected position is determined with relatively high confidence, that can be used by the system to gain certainty about the next iteration of projection-model loadings for a comment whose loading is not well known (for example, the comment has only been voted on by participants who's projected position is uncertain) 1352.

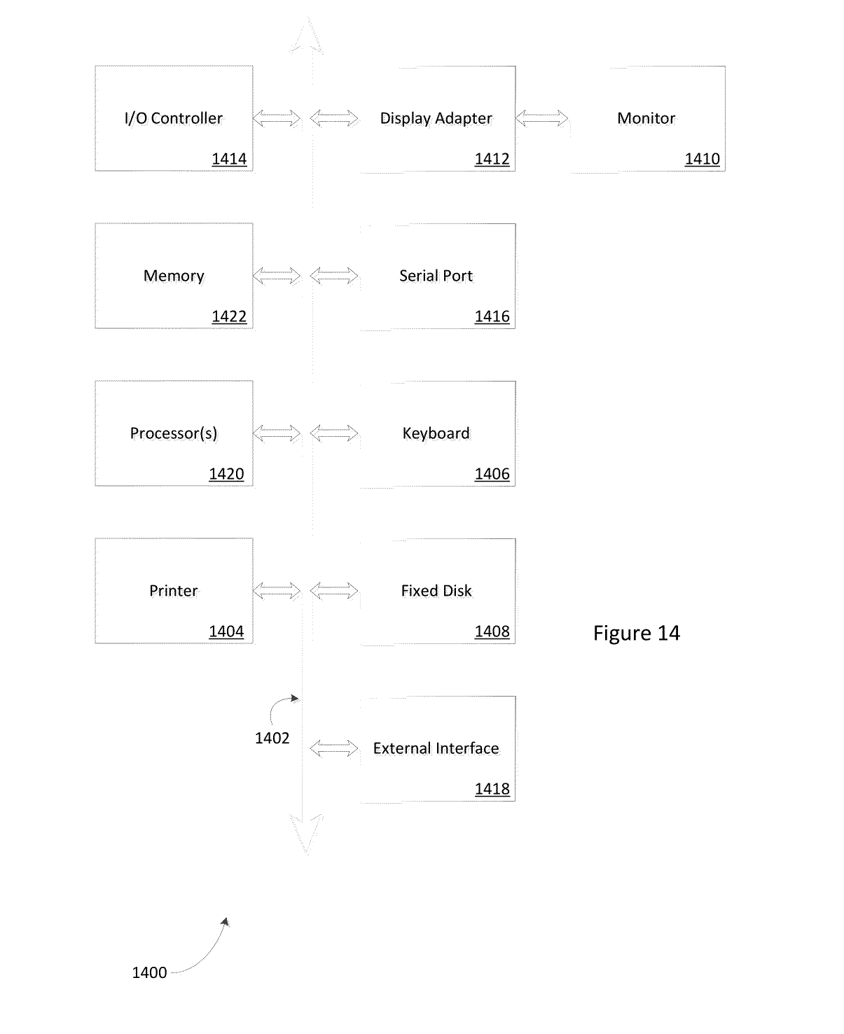

FIG. 14 is a diagram illustrating elements or components that may be present in a computer device and/or system configured to implement a method and/or process in accordance with an embodiment of the invention, and will be described in greater detail later.

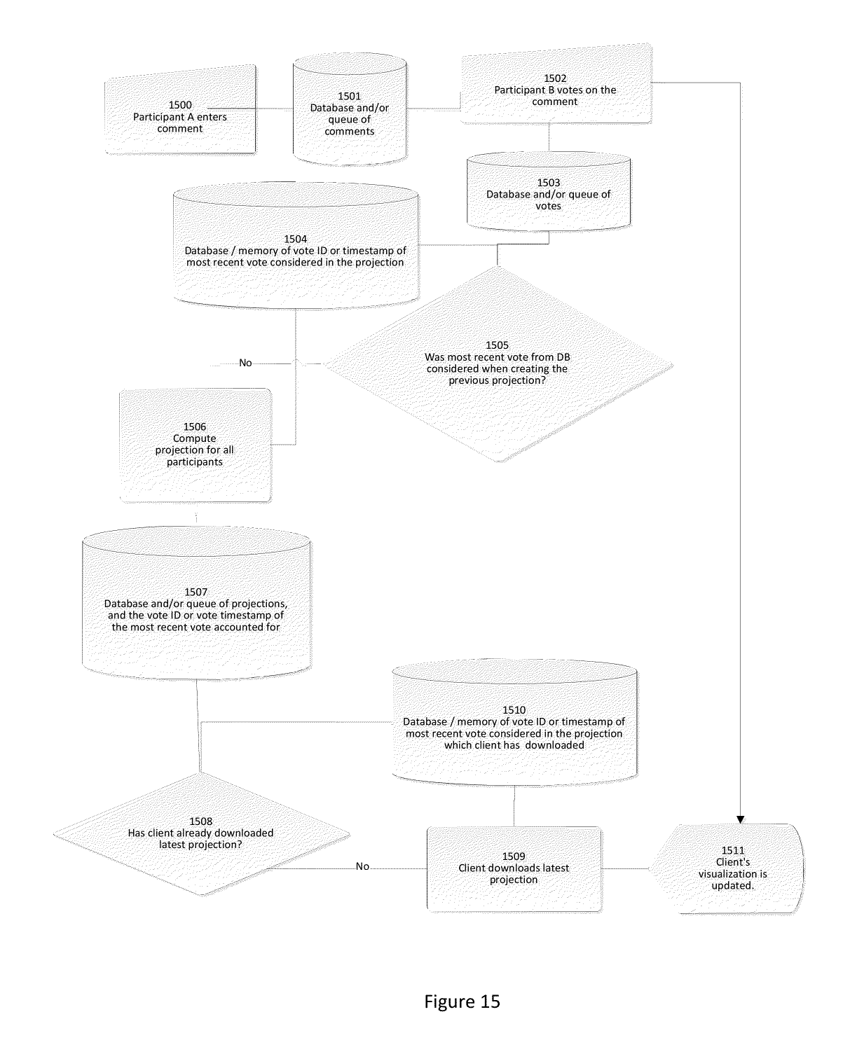

FIG. 15 is a flow chart or flow diagram a process, method, operation or function in which an embodiment of the invention uses vote timestamps or vote IDs to decide 1505 when to trigger a re-compute 1506 of the participant projections, and to decide 1508 when a client should fetch the latest projection 1509. Beginning at stage or step 1500, a comment is submitted to the system. This comment is transmitted by some means to another, or possibly the same participant 1502. An example of a way to transmit the comment is to store it in a central database or queue, where it is made available to participant B. Participant B votes on the comment 1502, and the information about the vote, such as the ID of participant B, and the ID of the comment, are submitted to a database and/or queue of votes 1503. If a projection model has previously been computed, it can be retrieved from memory/storage 1504. The retrieved projection model should have information identifying which votes were included in generating that model. This information may be the timestamp or monotonically increasing vote ID, etc, of the most recent vote among those considered when building the model. This will be referred to as LastVoteTimestamp.

Step or stage 1505 compares the LastVoteTimestamp found in the previous projection model, with the vote timestamp/ID all votes that have arrived since, and if there are any new votes, which were not accounted for in the previous model (such that newVote.timstamp >LastVoteTimestamp), or if no previous projection model exits, then the system schedules a new projection model to be constructed at step or stage 1506 (not pictured here, but discussed elsewhere is that the previous projection model may be used to inform this computation). Once the new projection model and projection (and clusters, etc.) have been computed, they can be stored, at least in memory, but also in a database 1507 where they can be made available to clients. A pub-sub queue, or other form of connection may also be used to provide the updates to clients in a low latency way. The decision 1508 to download a new projection/projection model to a client can be made by determining 1510 the LastVoteTimestamp for the model/projection which the client has already downloaded. This parameter may be stored on the client, and provided to a server when requesting the latest model/projection. The determination at step or stage 1508 is probably best made by the server, which can compare the client's latest LastVoteTimestamp 1510 with the LastVoteTimestamp of the latest available model/projection 1507. If the client is polling for this data, for example, over HTTP, then the server may return a 304 response, indicating that the model/projection has not changed. If the projection has changed, then the client may download the latest model/projection, and update its local LastVoteTimestamp 1510.

If clients can be uniquely identified, such as with a session token, then it is also possible to store each client's LastVoteTimestamp on the server, and the new data can be pushed to the client over a socket, without the client needing to perform a polling operation. Once the client retrieves the updated projection model and the projection of the other participants/groups of participants, the client can update its UI 1511, such as by updating positions of dots in the visualization. In one embodiment, step or stage 1511 may involve updating the positions of all dots directly based on the new projection. It may also involve projecting the user's own dot based on the projection model. Note that the projection of the user's own dot may differ from the user's projection in the retrieved projection, since the user may have placed votes during the time when the projection was updating on the server. If the client is projecting the dot of the current user, it is most likely overriding the projection which the worker has produced for that user. In this case, it is important to remove the current user's dot as projected by the worker, and replace it with the dot as projected on the client. If dots have been “bucketized” into groups for scaling reasons, then it may be necessary to subtract one from the count of participants in the “bucket” which the current user is in, so that the current user's dot will not increase the total participant count in the visualization. The client may update the local projection with the user's new position whenever the user votes (as suggested by the connection between steps 1502 and 1511).

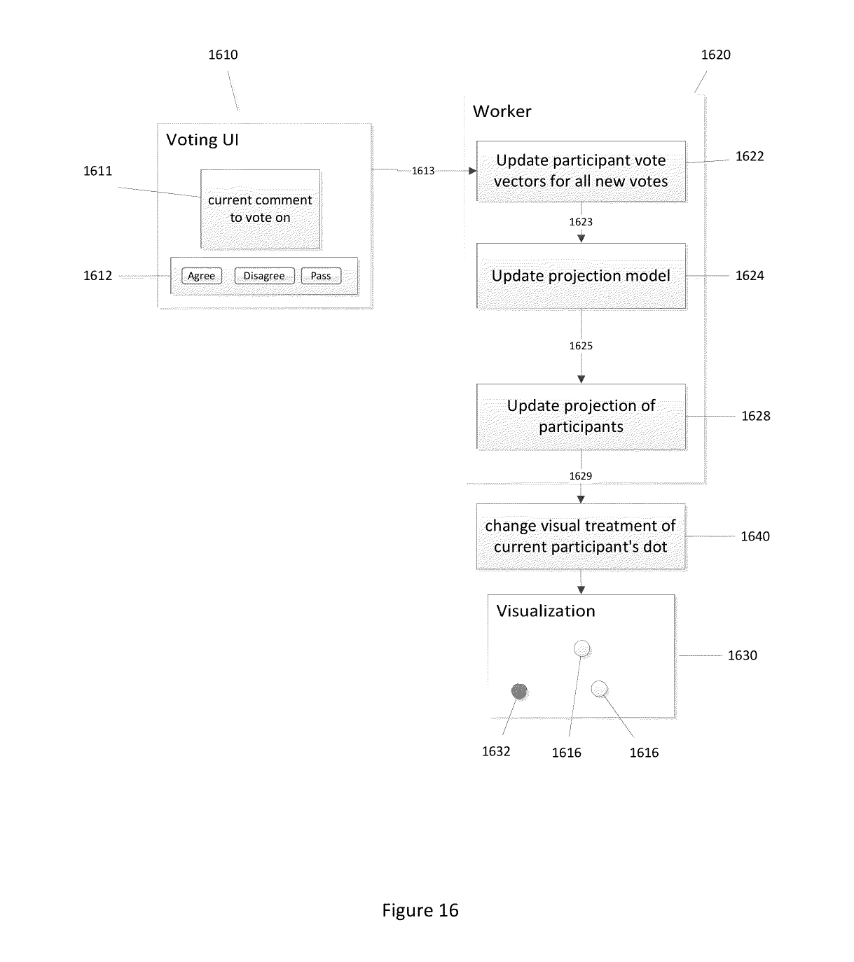

In one embodiment, the inventive system and methods may be used as part of a process of reaching consensus regarding a situation, such as making a diagnosis of a condition based on a set of symptoms. In this situation or use case, it may be important to understand how an initial position (in this case a proposed diagnosis) varies as new information is found. FIG. 16 is a flow chart or flow diagram illustrating a process for receiving and processing a user's vote and in response updating a display of the user's dot or other visual indicator. In the figure, a participant reacts to (or “votes” on) 1612 a comment 1611 which sends their vote 1613 to a worker process, probably via a database or queue. The worker (data or computing processing element) 1620 updates the participant vectors 1622, where the index into the vectors is the ID of each comment, and the value at each index is the participant's vote value for that comment. The worker iterates over all the new votes that have appeared since the previous update for this conversation, and updates any vote vectors for the participants who placed the new votes. Once the participant vectors are updated, they (along with all of the participant vectors for this conversation) can be used 1623 to update the projection model 1624 using PCA, an auto-encoder neural network or other suitable mechanism. Once the new projection model (principal components/AE weights) are ready, they are used 1625 to update the projected positions of all participants in the conversation 1628. For example, for a 2D projection, each dot is projected with an x and y coordinate, and has a participant ID attached. Once the projection is ready, it is delivered, or otherwise made available for download by the client 1629. Once the client downloads the new projection, it can find the dot corresponding to the logged in participant, and modify 1640 the display of that participant's dot 1632 in the visualization 1630, while leaving the other participants' dots 1616 unchanged.

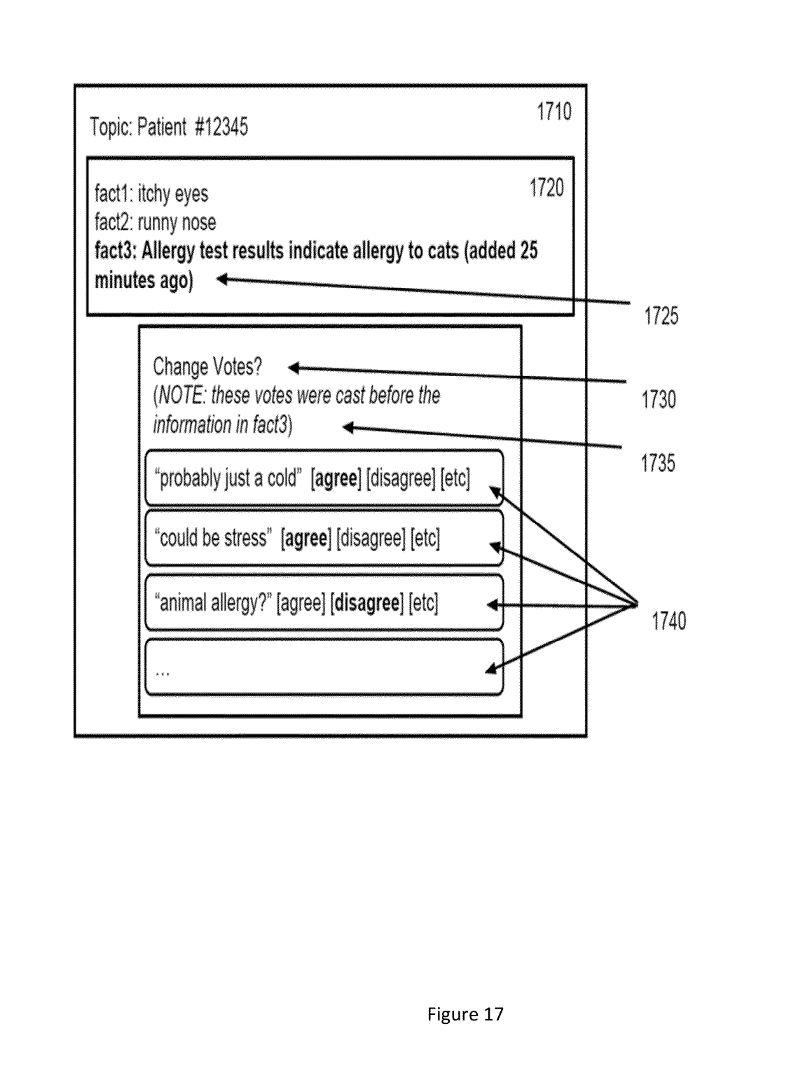

FIG. 17 is a diagram illustrating an example user interface for a participant who is being shown a UI which highlights new information 1725 within a list of unvotable entities 1720 (in this case statements that are to be accepted as “facts”), which has arrived after he has cast a vote on some comments. Since the new information may cause his opinions to change, any votes cast before that information was acknowledged can be shown in a “change votes” list 1730. In one embodiment, the items in this list 1740 may be ordered in a helpful way. For example, comments which were changed recently by other participants may be shown at the top.

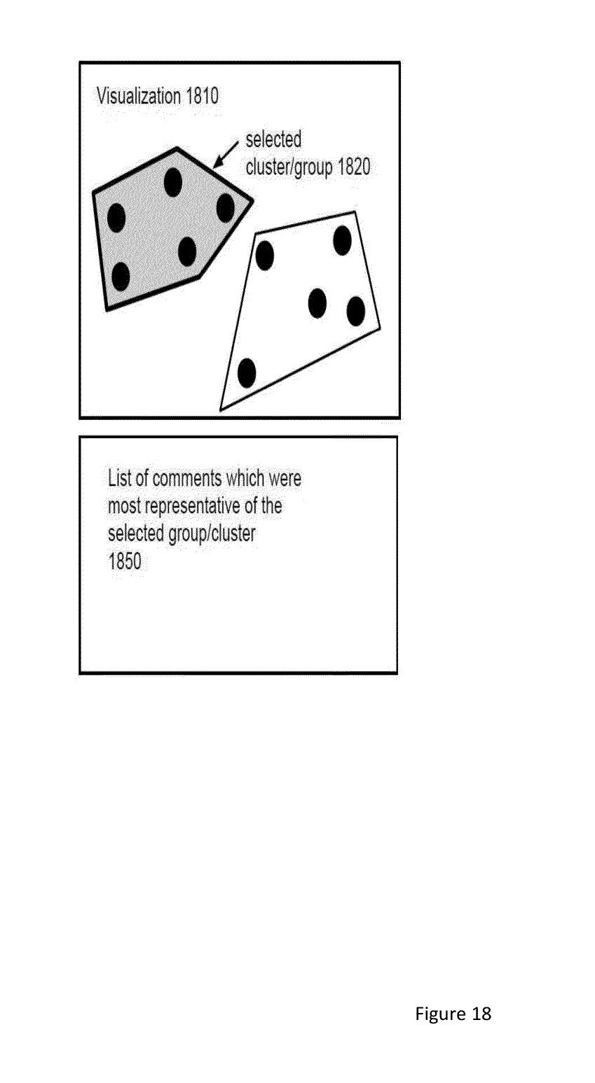

As noted, one aspect of the inventive system and methods is that they include features that improve the usability and hence value to a user. FIG. 18 is a diagram illustrating an example user interface or display for a participant or other user who is analyzing a conversation and that may be used as part of implementing an embodiment of the inventive system. The user has selected a group of users, possibly by clicking/tapping on the bounding shape for that group 1820, or by selecting a set of points with a selection tool such as a lasso or rectangle selection. In one example, the comments which are most representative of that group are shown in an accompanying list 1850 in a window or portlet.

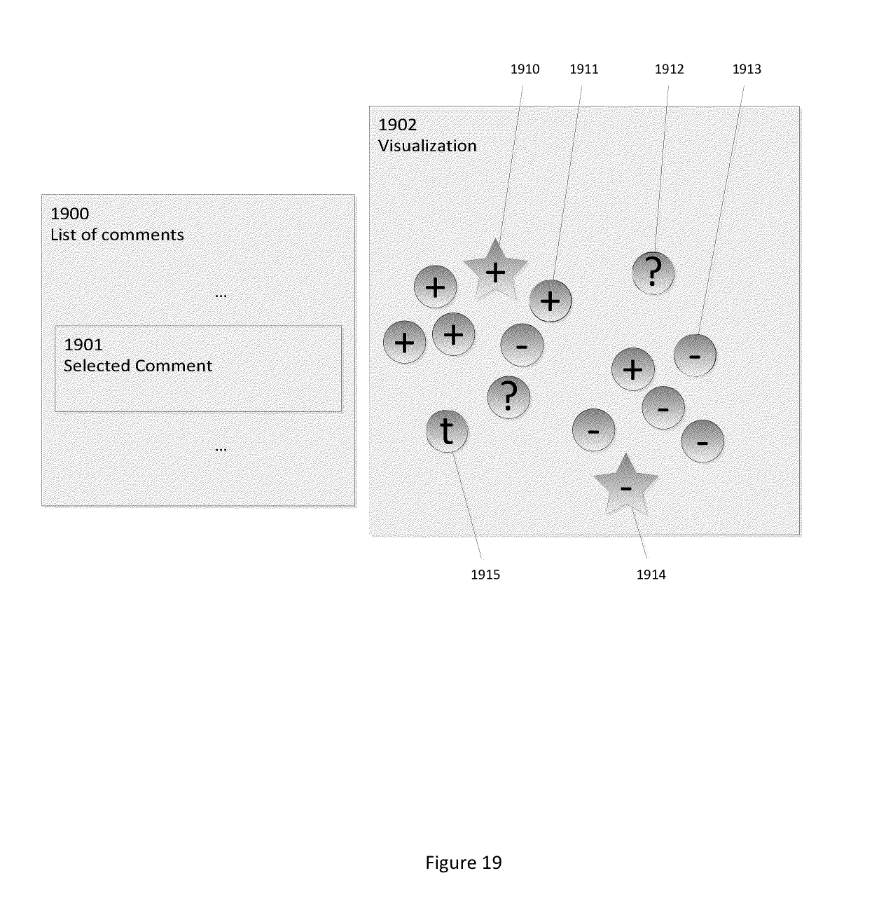

FIG. 19 is a diagram illustrating an example user interface or display for a participant or other user who is analyzing a conversation and that may be used as part of implementing an embodiment of the inventive system. A list of comments 1900 may be shown, with the comments filtered/sorted based on one or more criteria. For example, the list may be a list of comments which the user has already voted on, it may be a list of comments which the user has not yet voted on, it may be a combination of the two, or it may be a list of comments that other users have voted on, etc. One operational aspect of an embodiment of the system that is shown in the figure is that by selecting a comment 1901, the user can cause the participants' dots in the visualization to indicate how each participant voted on that comment. In this figure, “+” marks 1910 and 1911 are used to indicate participants who agreed with the selected comment and “−” marks 1913 and 1914 are used to indicate participants who disagreed with the selected comment. Dots with a “?” 1912 mark indicate participants who did not yet vote on the selected comment, dots with a “t” mark 1915 represent participants who clicked trash for the selected comment, and dots with a star shape 1910 and 1914 indicate participants who chose to star the selected comment. Note that this example represents just one embodiment of how votes may be presented.

### Text-Based Display of Groups

It may be preferable under some circumstances to show groups in a text-based or text only format. For example, in an interface optimized for the blind, it may be a better experience to simplify the content on the page so that it is more easily navigable by a screen-reader. Additionally, a text-based group representation may be preferable in cases where screen space is limited, such as on mobile phones, or when embedded within another document. The display to show, either text-based or visual, may be expressed as a preference of the conversation owner, as a local preference on a particular user's client software, be based on the version of the client software that is installed, or dynamically based on conditions such as the window size, availability of graphics rendering systems within a browser, or the presence or absence of a screen reader.

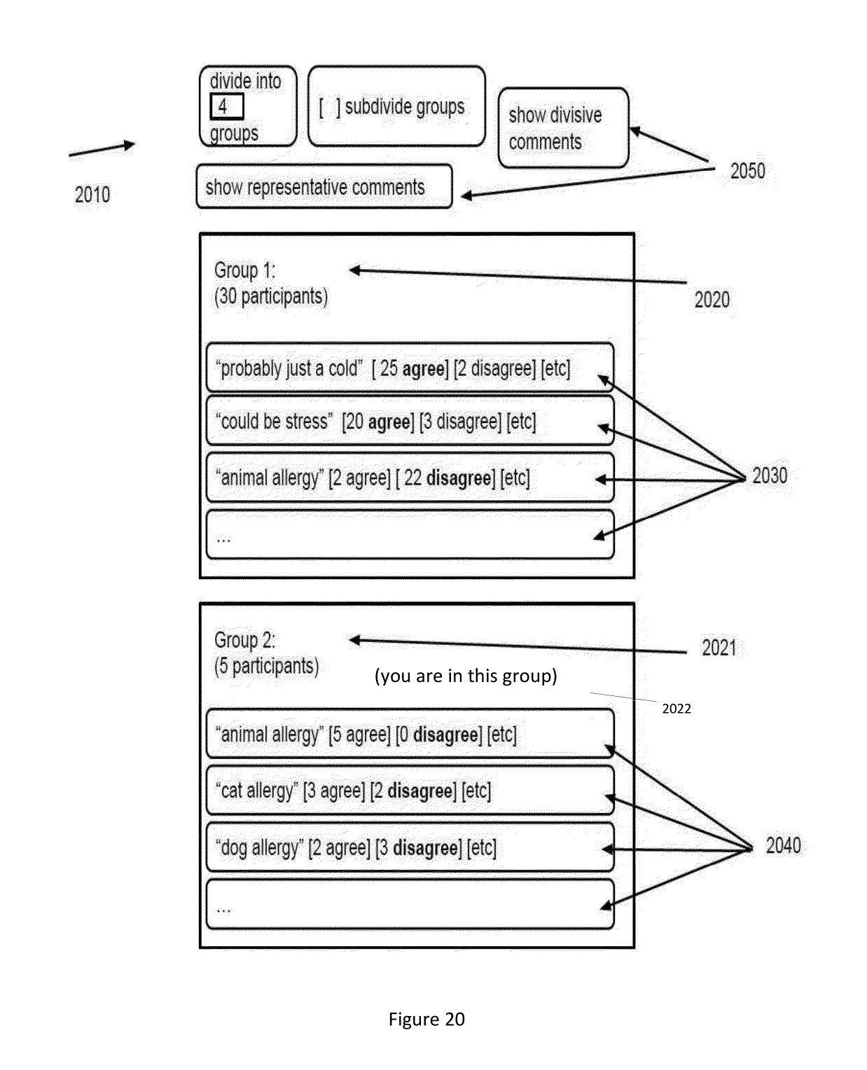

FIG. 20 is a diagram illustrating an example user interface or display for a participant or other user who is analyzing a conversation and that may be used as part of implementing an embodiment of the inventive system. As shown in the figure, the user is viewing clusters 2020, 2021 in a textual format, where comments which are representative of those clusters 2030 and 2040 are shown along with each cluster. Additional information, such as the number of participants in each cluster can be shown, as well as information about each comment, such as the voting pattern for that comment within the cluster (e.g., the number of “agrees”, “disagrees”, etc.). A label or other indicator 2022 can appear on a group to show that the current participant is a member of that group. Options 2010 may be used to control the clustering, or to change the ordering of comments displayed 2050.

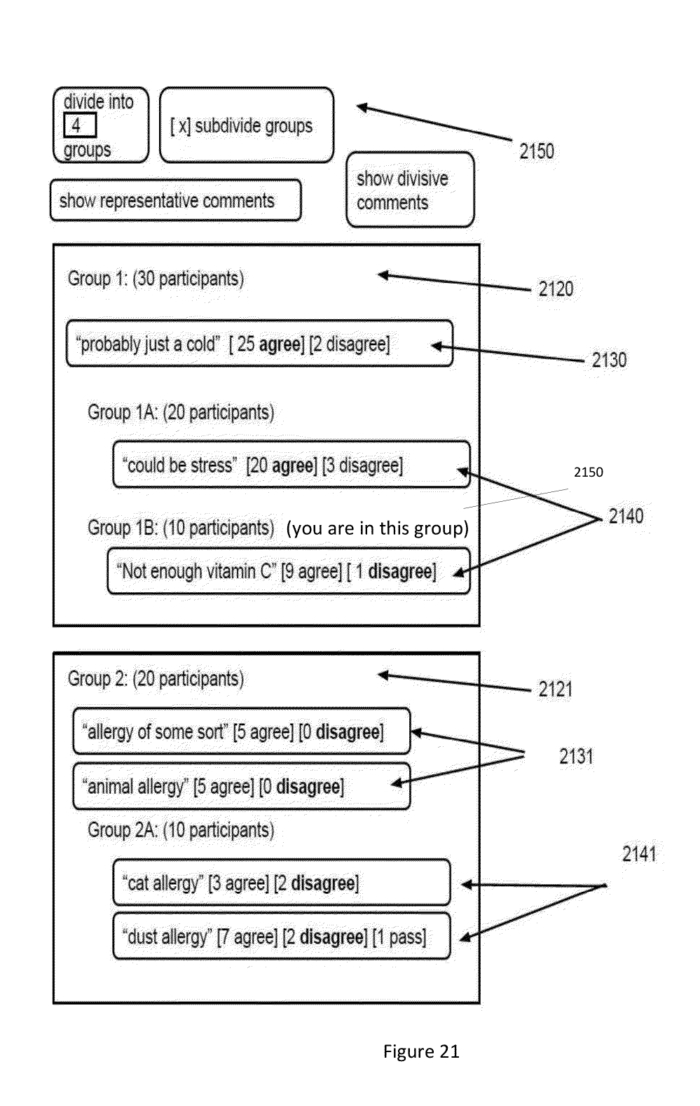

FIG. 21 is a diagram illustrating an example user interface or display for a participant or other user who is analyzing a conversation and that may be used as part of implementing an embodiment of the inventive system. As shown in the figure, the user is viewing clusters 2120, 2121 in a textual format, where comments which are representative of those clusters 2130, 2140, 2131 and 2141 are shown along with each cluster. The user has enabled the option 2150 to subdivide groups (as indicated by the “x” in that check box). This causes subdivisions (which may be generated by any suitable technique, such as hierarchical clustering) to be shown as text in a tree-view style representation. The comments 2140 and 2141 which are most representative of those sub-clusters are shown. A label or other indicator 2150 can appear on a sub-group to show that the current participant is a member of that sub-group. Additional information about each sub-cluster is shown, such as the number of participants in that sub-cluster.

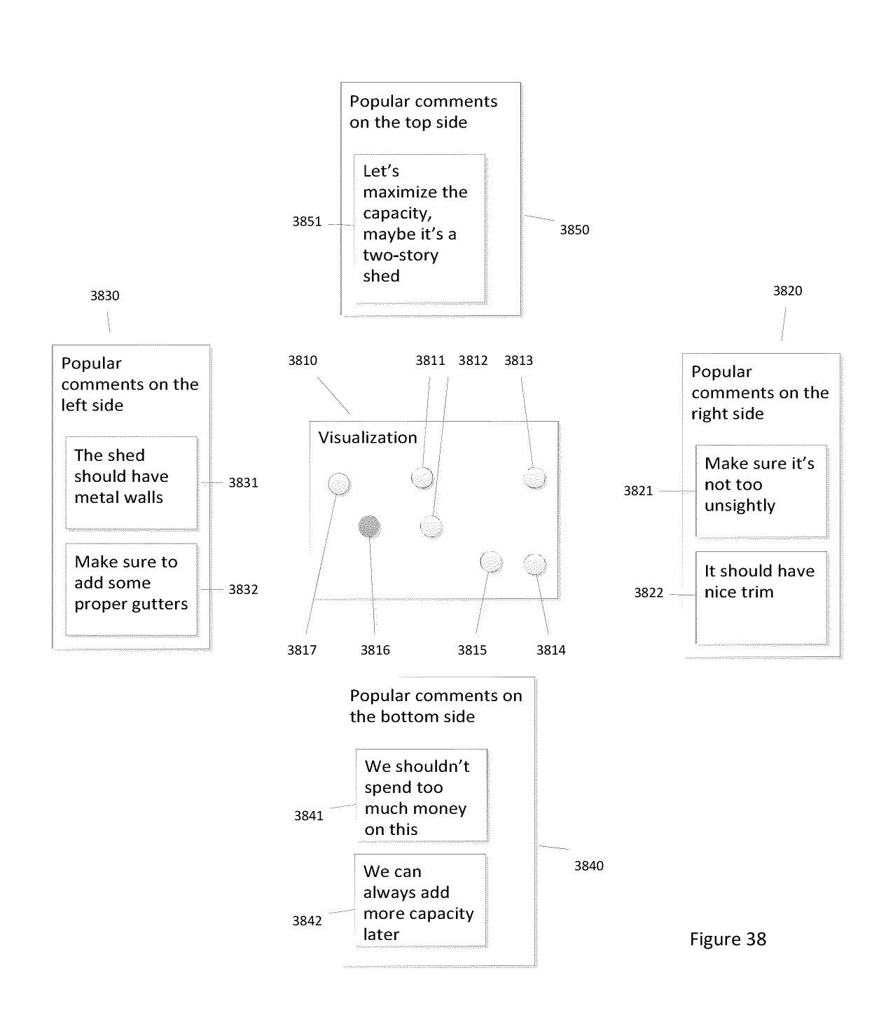

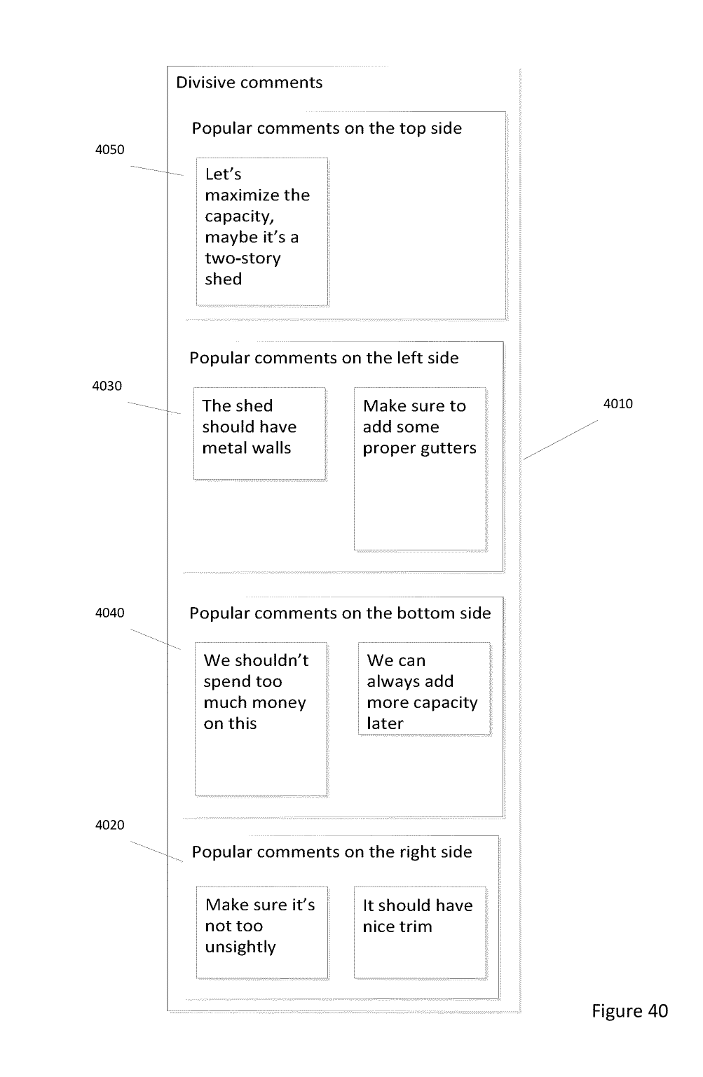

FIG. 40 is a diagram illustrating an example user interface which is a text-only version of the interface illustrated in FIG. 38. It shows a list 4010 containing lists of lists 4020, 4030, 4040, and 4050. Each of these lists contains comments that are strongly associated with the principal components (for additional information, see the description of FIG. 38).

### Projecting Comments

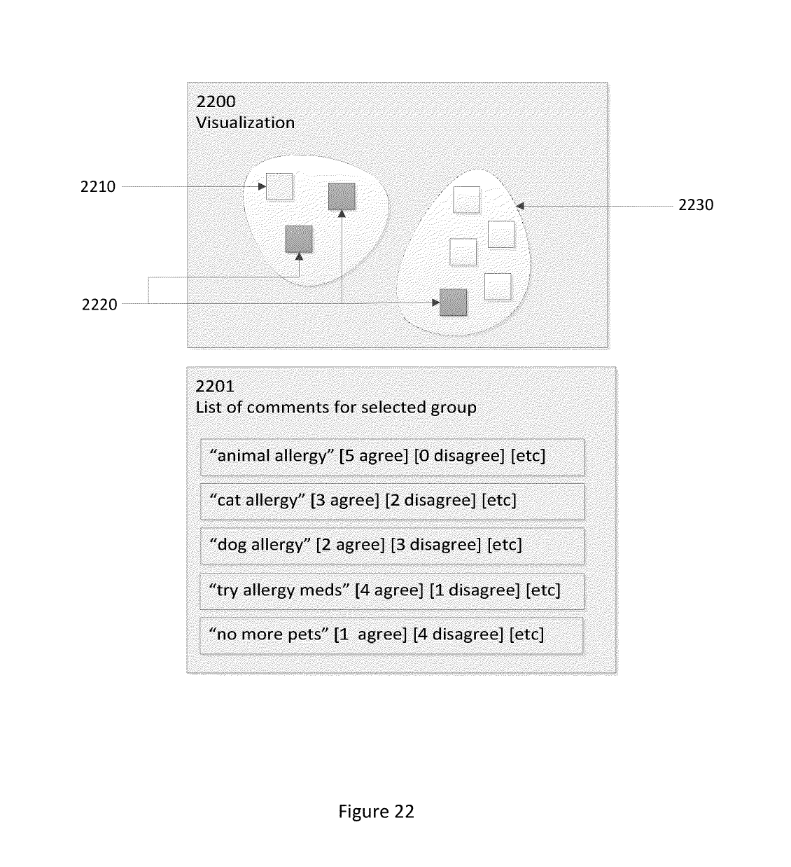

FIG. 22 is a diagram illustrating an example user interface or display for a participant or other user who is analyzing a conversation and that may be used as part of implementing an embodiment of the inventive system. As shown in the figure, the participant is viewing a visualization 2200 which shows comments 2210 and 2220 as rectangles in a projection with clusters. The comments illustrated as element 2220 are presented in a different color than those illustrated as element 2210, indicating in this case that these comments were written by the participant. The participant has selected a cluster 2230, and those comments 2201 that are in that cluster are displayed in a list.

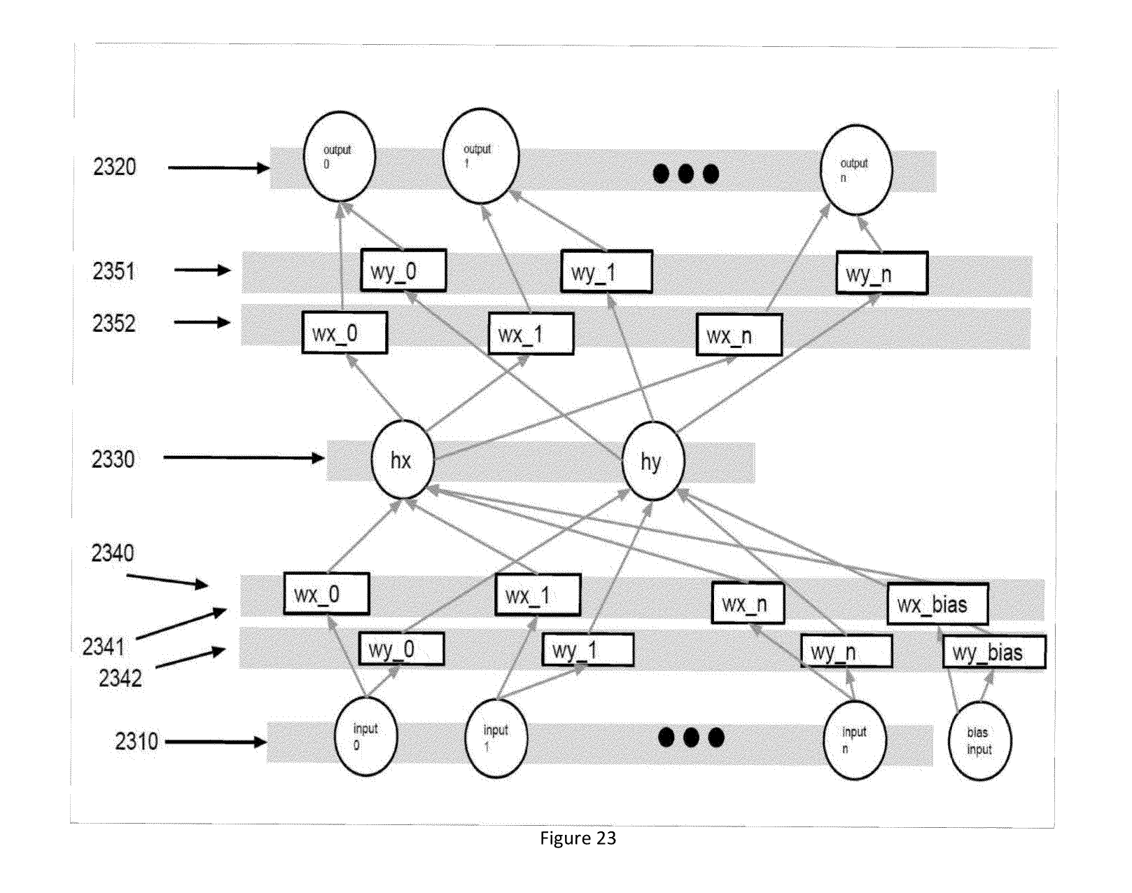

FIG. 23 is a diagram illustrating the elements of a basic auto-encoder neural network with a single hidden layer, which may be used in implementing an embodiment of the invention. This type of neural network may be used with either participant vectors as input (where the values of the vector are the votes of a participant on each comment, with each comment having an integer ID and the vote value on that comment being at the position in the vector corresponding to the comment ID, and with zeros for comments the user has not seen), or with comment vectors as input (where the values of the vector are the votes of each participant for the given comment, with each participant having an integer ID, and their vote value being at the position in the vector corresponding to their participant ID). As will be described, in one embodiment, an auto-encoder may be used to perform a reduction in the dimensionality of the input data.

The input layer 2310 can have its values set to the values of these (participant or comment) vectors, and the network can be updated using standard activation functions. The number of nodes in the hidden layer 2330 corresponds to the number of dimensions that are being reduced/projected to. In this embodiment, for a 2D projection, the node labelled “hx” corresponds to the x axis of a 2D projection, and the node labelled “hy” corresponds to the y axis of that projection. As is typical for the operation of auto-encoders, after the values are updated and propagated through to the output layer 2320, the values of the input layer are compared with the values on the corresponding nodes of the output layer, and differences are back-propagated through the network to provide a convergence to a final set of values. This process may be repeated, using the vectors of participants or of comments which have been voted on, and in some cases one or more randomly selected other vectors (which may not have changed from the set of all participant/comment vectors) to update the weights each time the projection model needs to be updated.

The output of this process is a projection model, which are represented by the weights 2340 between the input layer and the hidden layer. In this embodiment, the weights 2341 can be used to project a participant's dot in the x dimension, and the weights 2342 can be used to project the participant's dot in the y dimension. To remove the need for training on the entire set of participant/comment vectors each time the projection is updated, the weights 2351, 2352, 2341 and 2342 from one computation may be saved, and used to initialize the next computation (which will then require only a small amount of training to account for new votes). As soon as the weights have been updated, they are preferably made available as quickly as possible to the clients, for example via a queue, database, cache, a direct socket connection to the front-end hosts, etc. The clients can then use the updated values to move their red dot, red square, or other indicator. Once the projection model's vectors are ready, they may be made available to the worker responsible for projecting the participants and/or clusters.

To prevent the auto-encoder from “learning” too heavily from participants who vote frequently, or comments that are voted on frequently, it may be beneficial in some situations to “unlearn” the previous value of a participant/comment before learning the new value. This can be accomplished by updating the weights to the old values, back propagating to calculate the error, and then instead of travelling in the direction which would reduce the error, instead travelling in the opposite direction. Then, an update is determined using the new vector, and back propagation is applied as usual, possibly with an increased step size.

### Indicating Comments Associated with a Subset of Participants

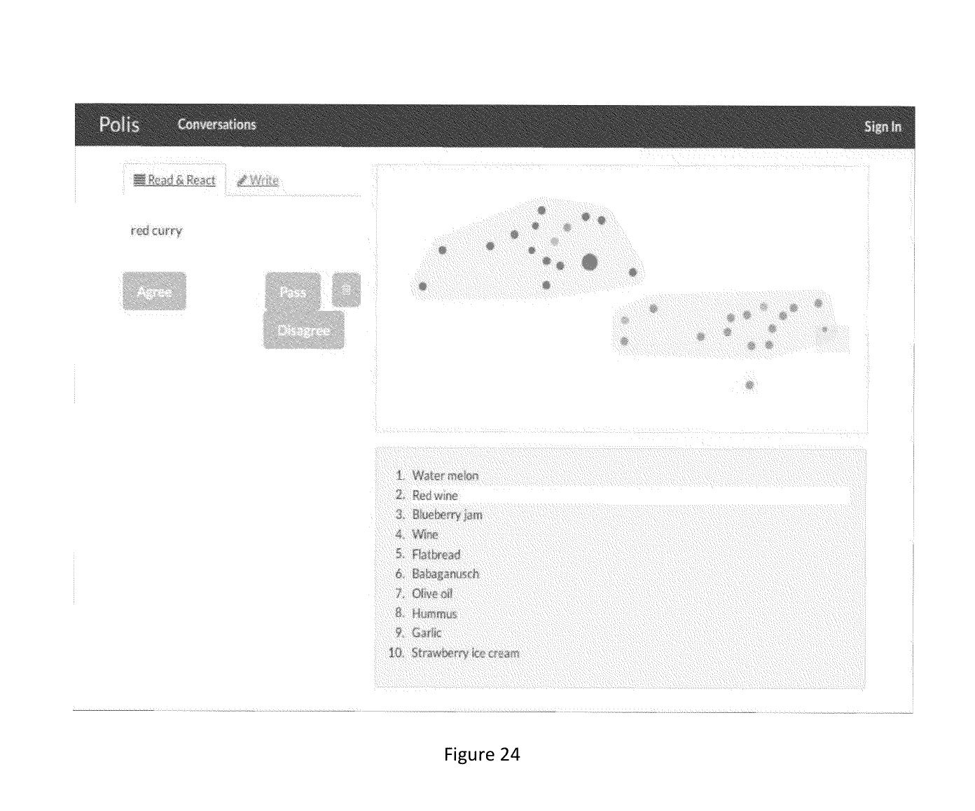

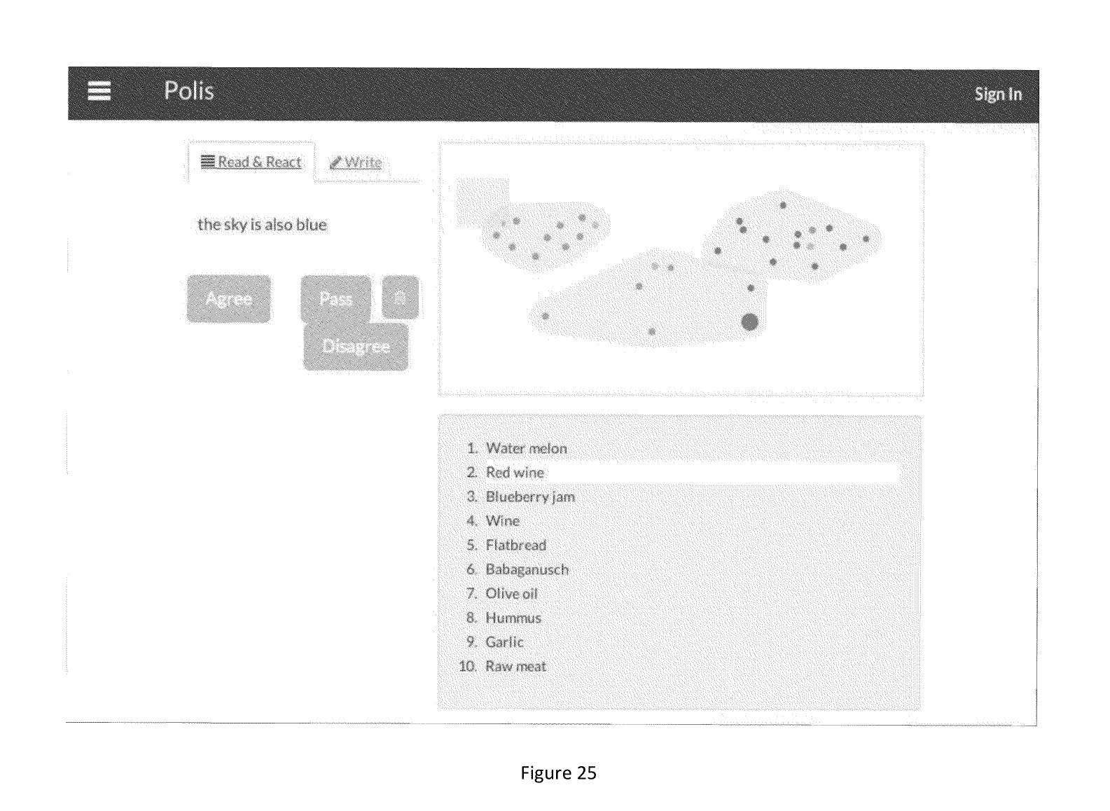

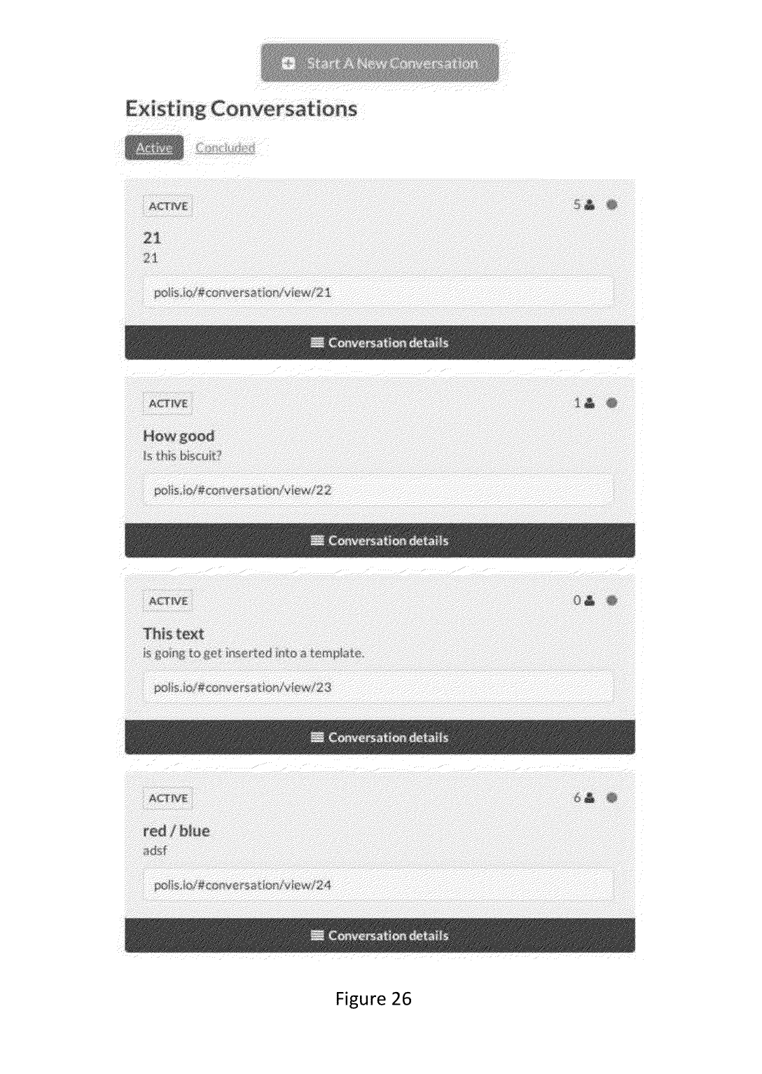

FIGS. 24-26 are diagrams illustrating other examples of a user interface or display for a participant or other user who is analyzing a conversation and that may be used as part of implementing an embodiment of the inventive system. FIGS. 24 and 25 show an interface where a rectangle selection has been made around one or more dots. The list view shows comments which were representative of the participants whose dots are selected. One of the comments within this set of comments has been selected (“Red wine”), which has caused the dots to be shown differently according to how each participant voted on that comment or statement. FIG. 26 shows a user interface or display view where a user can see conversations they have joined, conversations they have started, or start new conversations.

### Description of Certain Data Visualization Processes and Mathematical Methods

As described herein, the inventive system and methods are used to generate data, access the data, and performing data processing operations to enable synthesis and understanding of communication data that arises during a “conversation”. The system/platform accomplishes these objectives using one or more data visualizations, a foundation of which involves seeing how participants are distributed within an “opinion space”. In one embodiment, this space is presented as a 2 and/or 3 dimensional projection of points, each of which represents a participant. Participants which lie closer to each other in this projection tend to agree with each other or share more “similar” opinions, while those further away tend to disagree or have more dissimilar opinions. Note that the system can layer additional information, such as how participants break up into groups or sub-groups, upon this visual foundation.

In one embodiment, the foundational projections and/or additional layers may be produced as the result of utilizing a suitable machine learning algorithm or modeling technique, such as a neural network, a regression algorithm, a decision tree, a support vector machine, a Gaussian process, a non-parametric model (e.g., nearest neighbors or Parzen's windows), a generalized linear model, or an ensemble of one or more of the methods mentioned. Such algorithms or models can be trained using a variety of approaches, including gradient descent, gradient boosted trees, random forests, support vector regression, or other suitable method. The algorithm(s) used may be configured to optimize for different loss functions. Typically, these types of algorithms are optimized for squared loss (i.e., least squares), but some can be configured to optimize for L1 loss, Huber loss, or another suitable optimization method. For example, in some embodiments, a specific optimization or cost function may be appropriate in order to identify outliers, group participants so as to emphasize certain characteristics or values, etc.

To obtain the foundational projections, the inventive system and methods may consider participants as being represented by a position in the “space” of a conversation's comments, based on their reactions to those comments. In one embodiment, this space will have as many dimensions as there are comments. A 2 and/or 3 dimensional projection of these points can be obtained by applying a dimension reduction algorithm to the participants' positions in the full comment space. To determine the underlying groupings or structure of participants within conversations, the inventive methods apply clustering techniques to participant positions within the origin comment space (and/or potentially within the reduced dimensional space). This clustering can be hierarchical or nested (or based on another structure) so that one can visualize how each group breaks into subgroups. In the context of the invention, this process is termed “group clustering”.

Given a group, the invention can determine and identify those comments most responsible for distinguishing that group from others in the conversation. As a guiding heuristic, it is expected that a comment which is very favorably rated within a group and unfavorably rated outside of that group is more likely to be representative of that group's opinions as compared to those of other groups (i.e., it represents an opinion or value that is more distinctly associated with that group or sub-group). This observation may be formalized through the definition of a representativeness metric of a comment with respect to a particular group. These values, described in greater detail herein, can be used to display more meaningful information about which comments are really important to a group, and are likely to define their “worldview”.

As recognized by the inventors, if the number of individuals in a conversation grows too large, then the number of dots present in the visualization may become impractical, both visually and computationally (with respect to the resources needed for efficient rendering). To address this possible problem, a set of clustering techniques referred to as “base clustering” may be performed. Base clustering limits the number of dots on a page or display, so that the visualizations are not overwhelming to a viewer. Base clustering can also be used at an early stage in the data analysis process, making downstream processing more tractable by reducing the number of points considered in either group clustering or dimension reduction operations.

As a complement to the above approach, the system can also consider comments to have positions in “people space”. The techniques used to visualize and understand the relationship people have to each other in comment space can be used in a similar manner with comments in people space. In this approach, instead of seeing how people are related to each other based on what comments they tend to agree on, comments can be seen as being related to each other based on how people tend to react to them. This can provide meaningful information about how comments and opinions are related.

This may be particularly useful for a smaller conversation. While the visualization of voting patterns of participants in comment space is informative and may be more compelling with large groups of people, for groups smaller than 15 or so, these patterns are less evident. However, smaller groups are likely to on average contribute more comments per person. As such, grouping comments together in people space may yield a more informative visualization, for example by more directly establishing opinion groups via groupings of comments.

One potential issue in implementing a comments in people space model is that as the size of a conversation grows, the number of people grows faster than the number of comments (presumably because the range of people's opinions may be finite and once expressed, tend not to be re-expressed). While mini-batch update methods (as described herein) are capable of making computational time for PCA updates invariant to the number of points analyzed, it remains computationally linear to the number of dimensions in the original space. Thus, mini-batch PCA updates to a comments in people space model scales more poorly than to a people in comments space model. However, this problem can be simplified by analyzing the matrix of comments by base clusters of participants instead of the matrix of comments by participants. In this matrix, the entry for a given comment and base cluster is the average vote by members of the base cluster on the given comment. This matrix will have a dimensionality of the number of comments by number of base clusters, which can remain computationally tractable with (and potentially even without) mini-batch methods.

There are also differences in the visualization of the comments in people space model. The visual language of aesthetic mappings that makes sense for people in comment space does not necessarily make sense for comments in people space. Whereas in the case of participants in comment space, clusters are groupings of participants and clicking a cluster's hull may show representative comments, in the case of comments in people space it may be more instructive to look directly at which comments fall in a given cluster by clicking, and to sort these comments by the number of stars or agrees. When a comment is selected the system can also display voting statistics for that comment. Relevant metadata correlations may also be shown, such as “participants who voted for comments in this group tend to be female”. Another possibility with this view is to show connections between comments, such as in an implementation that allows comments to respond to each-other, lines may be shown between replies.

### Dimension Reduction—

### Principal Components Analysis (PCA)

In order to obtain a 2 and/or 3 dimensional representation of the data for visualization by users, a form of dimensionality reduction, such as the technique of Principal Components Analysis (PCA) may be used. PCA finds the directions in the original space in which there is the greatest variation (note that in some respects it performs a similar function to determining the eigenvectors that may be used as a basis for “spanning” a space). These directions are called the Principal Components (PCs) of the data set. Projecting points down into a smaller subspace then becomes a simpler matrix multiplication operation of the full dimensional representations by the PCs themselves.

As recognized by the inventors, conventional methods of implementing and using PCA are not particularly well suited to operating efficiently on “streaming” data. Traditionally, PCA works by computing the covariance matrix of the dataset, and then the eigenvectors of that matrix as the PCs. Both the computation of the covariance matrix and the eigenvectors are computationally intensive operations, and are not practical to perform for large datasets where updates need to happen relatively quickly with each new data point. One possible solution to these problems involves using Power Iteration for the computation of eigenvectors, which is a relatively fast process if only the first two or three components are needed. However, this still depends on having a covariance matrix available. Since the data is streaming in uses of the inventive system, an approach is to cache a copy of the covariance matrix from the previous round of computations, and only update rows/columns corresponding to individuals who have cast new comment ratings (i.e., votes). Given only one new rating into the system, the time required to update the matrix is linear in the number of individuals in the conversation. Note that while PCA is one possible dimension reduction technique, there are other suitable types of dimensionality reduction techniques which could be used to implement an embodiment of the invention (such as the previously mentioned auto-encoders, neural networks, etc.). Note that in some cases the output of a dimensionality reduction process may require further processing to be of best use with the other functions of the inventive system, such as where an orthogonalization process is applied to the non-orthogonal outputs of the dimension reduction process.

### Auto-Encoder Neural Networks

Auto-encoder (AE) neural networks (such as the one described with reference to FIG. 23) are one alternative to using PCA for dimension reduction. In cases of linear activation functions, AE can be taken as an approximation to PCA. However, AE techniques also allow for the use of non-linear activation functions, which may increase the variance captured within the 2-dimensional (or 3-dimensional) representations. Additionally, there are training back-propagation algorithms which are very fast, and naturally adapt to streaming new data for responsiveness. On the other hand, AEs are restricted to a certain number of dimensions in the reduced representation, whereas PCA can provide a representation of any desired dimensionality by taking the first n components for a projection. These extra dimensions (even if not used in a visualization) may be useful in downstream data analysis steps, such as clustering, because they can retain more structure than a two or three dimensional representation and yet may be more efficient for computation than using the full dimensional representation.

Additionally, there are a number of algorithms for training such neural networks, some of which lend themselves towards use with streaming data. Choosing the proper training algorithm may involve looking at simulated and test data sets, and evaluating/tuning these methods for efficiency and the amount of variance captured within the data. The neural net weights from these analyses can be sent to the client application/device for real-time position updates, just as the principal components may be provided to the client.

### Weighted PCA

Variants of PCA, which operate on weighted rows and columns, are also available. Given base clustering of comments and/or participants, as described herein, the dimensionality of the data may be reduced in large conversations by performing weighted PCA where the columns and/or rows of the data matrix correspond to base clusters of participants and/or comments (respectively), and where these columns/rows are weighted by the number of members in each base cluster. The downstream computations would then utilize the base clustering results. This allows for running PCA on larger conversations which might otherwise take too long to properly perform the computations. Weighted PCA could also be used to up-weight comments which have been heavily starred (i.e., considered significant or “best”), or have been found by clustering analysis to be particularly representative of the group engaged in the conversation (see the discussion of Group Clustering herein). Similarly, it could be used to weight participants based on reputation, either as measured through the site (as in stack overflow) or as measured by another suitable indicator (e.g., as verified professional or academic experience).

### Compensating for Missing Votes when Projecting a Participant

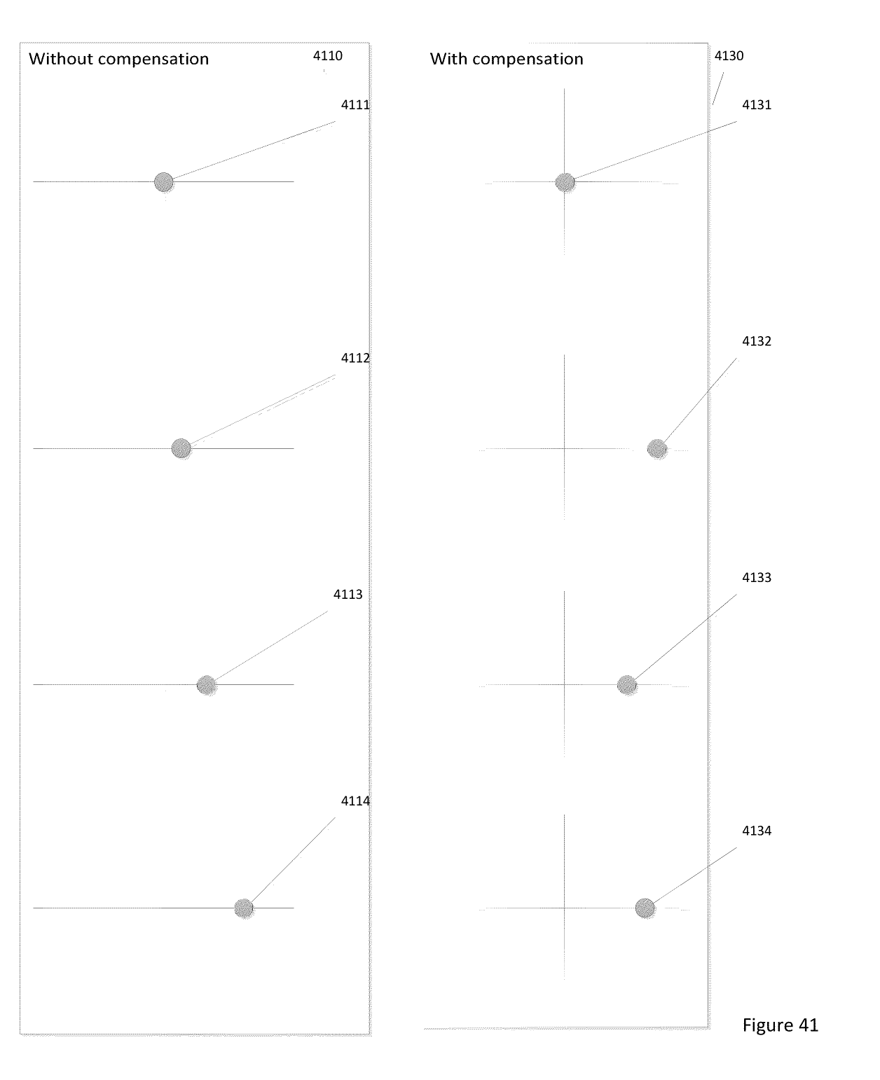

Ideally, when projecting a participant's dot, they have voted on every comment, and they can be represented with complete confidence. However, this is not always the scenario, so participants often must be projected based on only the votes they have placed. One way to accomplish this is to sum up the products of the votes and the loadings on the principal components for the corresponding comments. This is illustrated in FIG. 41 as sequence 4110, where FIG. 41 is a time-series diagram illustrating a sequence of projections as a participant votes, where one sequence of projections using missing-vote compensation is compared with another sequence of projections not using the compensation. An alternative to sequence 4110 would be to multiply this projection by a compensation (or weighting) factor, which accounts for the number of comments the participant has voted on. This is illustrated in FIG. 41 as sequence 4130. A benefit of this approach is that, based on the information available, the dot is likely to converge on its eventual location faster. Another benefit is that it makes it easy to project comments in the same space as the participants, and show them in the visualization.

As shown in the figure, there are two sequences, 4110 and 4130, where each illustrates the same sequence of votes (on the same comments), but sequence 4130 applies a form of missing-votes compensation. Beginning at 4111, the participant has not yet voted. At 4112, the participant has just voted on a comment with PC weights [1, 0], causing the participant's projection to move towards the right. This is repeated for 4112, 4113, and 4114, assuming the subsequent comments have similar right-pointing PC weights of [0.6, 0], [1, 0]. The participant's projection at 4114 is the sum of these weights, each multiplied by 1 for “Agree”. In sequence 4130, the sequence of projections is produced using missing-votes compensation. Beginning at 4131, the participant has not yet voted, and is projected to the center. At 4132, the participant has just voted on a [1, 0] comment, just as in 4112. However, here the participant's projection moves more dramatically to the right. This happens because the projection is multiplied by a factor that is larger when the participant has voted on fewer comments. At 4133, the participant's dot moves slightly to the left, in this example, as the participant has just voted on a comment with PC weight of [0.6, 0] (a slightly smaller primary PC weight than the first comment). The participant moves to the left because the compensation factor has decreased, and the 0.6 weight of the second comment is smaller than the 1 weight of the first comment. The previous projection 4132 had overcompensated, and 4133 is slightly more accurate. At 4134, the participant moves slightly to the right after voting on another comment with PC weights [1, 0]. At this point, the compensation factor is smaller, but the sum of the comment weights multiplied by 1 is greater.

### Projecting Comments in the Same Space as Participants

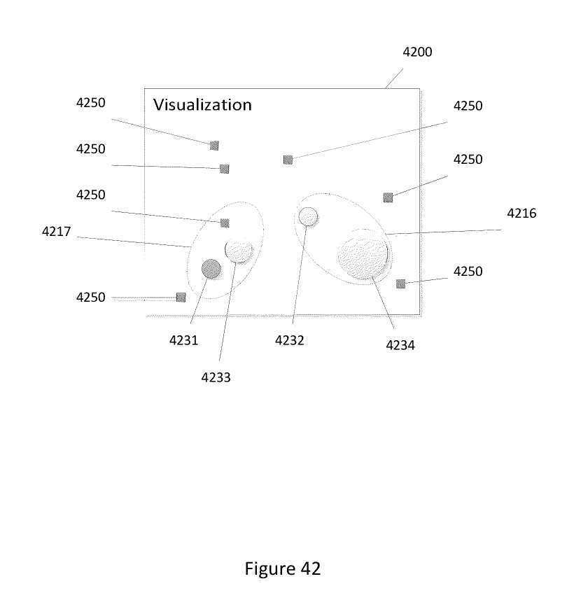

FIG. 42 is a diagram illustrating a component of a user interface, where a visualization 4200 is shown, containing participant base clusters 4233, 4232, 4234, the participant's red dot 4231, and groups 4217 and 4216. Additionally, this visualization contains projections of comments 4250. The comments have been projected using a missing votes compensation factor, as though each comment was a participant who had only placed a single vote, on the comment itself. Optionally, the projection of the participants or base-clusters may also be compensated using a missing votes compensation technique.

### Smoothly Transitioning Between Dimension Reduction Techniques

It is also possible to use more computationally intensive/expensive (and typically more accurate) techniques for conversations that have a relatively small number of comments and number of participants (for example, PCA or t-SNE). Once a conversation becomes large enough that these algorithms become too slow in a practical sense, it's possible to smoothly transition to more computationally efficient auto-encoder based projections. This can be done by training the encoder half on the existing projection for each participant, using back-propagation from the errors of the new projections relative to the known high-quality projections. Then, the new ‘encoder’ weights can be copied (except the bias term), transposed, and then used as the decoder weights (note that other initialization methods, such as where errors are back-propagated from two sources, may also be used; for example, such as from the outputs of the auto-encoder as well as from the middle projection layer). Once this initialization is done, the transition is complete, and the new auto-encoder may be used as usual.

### Dimension Reduction as a Tool for Factor Analysis

Because dimension reduction techniques attempt to capture as much information as possible in a limited number of dimensions, the subspace of the origin space to which the data is projected contains information about not just what data are correlated, but how they are correlated. Thus, if it is recognized that the 1st PC of a PCA process points largely in the direction of comments A and B, we can deduce that A and B are correlated along that direction, and that more positive placement along the 1st PC can be interpreted as a tendency to agree with A and B. This observation (i.e., this use of the results of a dimension reduction process) led the inventors to consider the use of dimension reduction techniques as the basis for performing factor analysis. While factor analysis and dimension reduction techniques aren't identical, they do share certain aspects in common. For example, PCs can be taken as explanatory factors, or as underlying or hidden variables within a conversation. The distribution of ratings over a given comment would then be considered to result from these underlying factors. Given this explanation/interpretation, in one embodiment the inventive system can display the top comments for each of the principal components as being representative of the two plot axes. And, as also recognized by the inventors, there are processes that can be used to maximize the amount of information obtained by using dimension reduction products. Some of these are described below.

### Flipping Minimization

Products of dimension reduction techniques are typically not guaranteed to produce the same orientations, even in the event of only slight changes in the data. Considering that one obtains the same subspace spanned by PC1 and PC2 as with (−PC1) and PC2, it is evident that the sign is irrelevant and contains no useful information about the data. However, a component “flipping” as new ratings come into the system may result in dots flipping wildly from one side of the screen to the other. This dramatic visual activity may be misinterpreted by users as indicating a fundamental change in the conversation, when in fact it has no meaning. This possible distortion can be mitigated by choosing the directionality yielding the most positive dot product with respect to the corresponding component from the most recent iteration. While online auto-encoders and other methods designed to work in an online fashion may not have these issues, prevention of flipping can still be ensured by finding the eigenvectors within the subspace and treating them as though they were the PCs. Doing this using power iteration (as described herein) is computationally tractable and adds minimal processing overhead to the process.

### Group Clustering

As recognized by the inventors, understanding how participants in a conversation form groups or sub-groups based on their opinions is a key to understanding the nature and development of a discussion. In one embodiment, such groups can be “discovered” by applying clustering algorithms to the data. These clusters can then be rendered as part of a visualization for users, for example as coloring of dots or as semi-transparent convex hulls overlaying group members. Information about what opinions are most representative of a group can be provided to the clients and displayed by interacting with the cluster visualizations. Note that any suitable clustering algorithm or technique may be used for this purpose. Hierarchical clustering in particular may be valuable in showing how groups are interrelated and break down into sub-groups. A user may then navigate this nested structure in the visualization using a “slider” which changes between different clustering depths. The slider could be activated using accelerometers on mobile devices, so that tilting a phone screen one way or the other would decrease/increase the granularity of the clustering that is displayed. A user may also be provided with the option of zooming into clusters to be able to see the substructure.

In one embodiment, implementation of a clustering methodology would operate either on the individual participants or on the base clusters (if the conversation has reached the point of base clustering), taking centroids or medoids (a representative object of a data set, or a cluster with a data set whose average dissimilarity to all the objects in the cluster is minimal) of the base clusters as positions. A first step in this clustering approach would be to find a fixed number of clusters which would then be used as the “leaves” in the clustering tree. For example, these clusters can be computed using the Partitioning around Medoids (PAM) algorithm. Alternatively, a modification could be employed which, at each iteration, takes the mean of each cluster as a new point in the data set for the next iteration; such points would be removed once the following iteration started or the clustering was complete. An advantage of this modification is that the medoids can take advantage of the collective information of all members within a cluster for the computation of “distances”. This avoids some of the issues associated with making distance comparisons for participants who haven't contributed a sufficient number of ratings, and will be discussed further in the “computing distances” section herein.

A hierarchy of clusters can then be built on this fixed number of clusters by progressively joining clusters that are closest together, as specified by a suitable distance metric. Such metrics include, but are not limited to distance between centroids/medoids or average distances between all members of two clusters. Use of centroids or medoids may be preferred for the sake of performance, while average distance computations could potentially provide more robust results. An advantage of this method is that the re-centering aspect of the PAM algorithm makes it relatively easy to produce diffs (differences) for updating clusters on the clients, and maximizes the maintenance of cluster identity as the conversation progresses. This results in smoother, more interpretable data visualizations. In one implementation, upon retrieving new data points, the data processing system can take the last clustering results and re-center from them given the new data. Note that this is more likely to produce clusters close to the most recent results.

Note that, while traditionally the iterative steps of a PAM algorithm are carried out until the clusters stop changing, this does not have to be the case. In particular, since it is expected that the clustering will change only minimally from the addition of a small batch of data to the system, one can assume that the clustering itself will likely not be far off. Thus, one can limit the number of re-centerings to some constant number to ensure responsiveness of the application, particularly as conversations grow in size. Such a cutoff could be obtained based on a cost/benefit analysis of the data fit, and the desired or acceptable latency. Another aspect to note is that when this clustering is first introduced, those members who have performed the largest number of ratings can be prioritized as cluster medoids during the first round or iteration. Subsequent rounds can then use the approach as described above. Beneficially, this initial priority is more likely to make distance comparisons easier.

### Possible Modifications to the Clustering Method

If it is decided that some number of clusters is optimal for summarizing the breakdown of participants' comments into groups, then that level could be optimized by starting the clustering algorithm with the modified PAM algorithm at that level. An advantage of doing this, instead of running the modified PAM step at the “tips” of a tree, is that the iterative re-centering method minimizes cluster shifting. As such, it may make sense to have that minimization utilized at the level which has been deemed most useful for the visualization. Then, higher levels can be built up as described above, while lower levels can be constructed by repeatedly breaking higher levels into smaller groups (e.g., between 2 to 4 each, choosing the number based on a clustering statistic, such as the silhouette).

### Mixture Models

Mixture models are another type of clustering technique, in which data points are modeled as having been drawn from a mixture/combination of model distributions (typically Gaussians, in practice). These methods have the advantage of being coupled to statistical underpinnings which makes it easier to evaluate how “good” a fit such a model is to the data. However, such methods tend to be more computationally intensive, which may be a disadvantage in terms of increasing data processing overhead. As a result, such models could be used early on in a conversation to “prime” a strong set of clusters, with the modified PAM algorithm then being used to maintain the clusters through the updates. Note that since the data may be discrete in nature (agree/pass/disagree), the data processing can also take advantage of a binomial model instead of a Gaussian model.

### Extracting Information from Clustering

As mentioned, from the results of the clustering processes one can obtain useful information regarding which comments are specifically responsible for separating clusters from each other or delineating “unique” positions. To assist with this evaluation, one can define a “representativeness” measure which indicates how representative a given comment is of some cluster. Specifically, this measure is designed to be largest when the comment is mostly agreed with within the group, but mostly disagreed with outside of the group. One computable function that can be used for this purpose is:

$${R}_{c , g} ( {s}_{1} , {f}_{1} , {s}_{2} , {f}_{2} ) = \frac{( {s}_{1} + 1 ) ( {f}_{2} + 1 )}{( {s}_{2} + 1 ) ( {f}_{1} + 1 )}$$

where sᵢ, fᵢ are the number of positive and negative ratings (respectively) in participant set i, i=1 corresponds to the group in question g, and i=2 corresponds to either everyone not in the group, or to some specific comparison group or groups (such as where based on other information, it is believed that the group or groups are representative of an opposing view or a view representing a comparison of interest). The (+1) terms in this equation ensure that if any of the counts are zero, then the equation will still be well defined. In principle, other functions could meet these criteria; however, this one is relatively efficient and simple. A more complex approach would be to take into account the certainty in the ratios, thereby mitigating concerns that a comment which had only been rated a couple of times would have a relatively high score. A metric meeting these criteria is the binomial proportion test's z-score function. Note that computing this function for every comment within the discussion—as well as for every cluster separation—could prove to be computationally intensive. The number of computations in these cases can be reduced by only considering comments which have been starred at some frequency threshold within the group.

### Base Clustering

As mentioned, using a base clustering process reduces visualization clutter, rendering time, and computational costs. These clusters can be obtained in a manner similar to those described with reference to implementation of the group clustering algorithm, only without building up a hierarchical clustering on top of this. In theory, K-means or K-medoids would work well for this purpose; however, using the modified PAM algorithms described in the group clustering section has the advantage of providing diffs between these base clusters. This is advantageous for maintaining dot identity in the visualization, reducing data transmission over the network, and minimizing computational cost. While it may be desirable that the base clustering happen before the other steps, an alternative implementation involves applying PCA first, followed by base clustering on a reduced dimensional representation of the participant locations, thereby reducing or simplifying downstream computations. Preferably, the method used is evaluated based on memory and time consumption profiles as conversations scale in size.

### Computing “Distances” Between Participants and Between Comments

In a typical implementation of the inventive system, there may be many instances in which it is desirable to compute “distances” between either participants in comment space or comments in people space and to use that as a metric for purposes of comparison. Where an implementation uses discrete ratings, such as agree/disagree/pass, it may make sense to use a Manhattan distance between points, as it reduces the computational complexity. In theory though, the Euclidean distance is fine, and may be preferred when using methods which assume such distance metrics (particularly PCA). A difficulty in performing distance computations may arise in cases where (for example) two participants have rated very few of the same comments. To some degree, base clustering mitigates these issues, in allowing the base cluster positions to be taken as cluster medoids or centroids, together with weighting determined by the number of individuals in the clusters. Similarly, performing PCA first also addresses this issue in that each participant will have a position in a reduced dimensional space which can be utilized in further downstream analysis (though it should be noted that care must be taken to ensure that the number of dimensions picked for the reduction is verified as capturing a reasonable amount of the variance within the data). Regardless of which technique is used first (PCA or clustering), distances need to be computed for that method even when there are few common votes between two participants. One way of accomplishing this is to place ratings of zero wherever a user has not made a comment. This has the net effect of clustering those individuals who have not participated much in the conversation towards the center of the visualization. More robust ways of dealing with this issue include the utility of variants of PCA which are able to more naturally account for missing data, such as the binary PCA methods used in roll call analysis.

### Using PCA with Missing Data

There are methods specifically designed for performing PCA on matrices in which there is missing data. These can be useful for moving participants who haven't voted much towards the groups which they most likely belong to.

### Up-Weighting Representative and Starred Comments

A way to address this type of missing data problem is to assume zeros in place of missing data as described above, but to up-weight comments which have either been heavily starred or are representative of some group structure. These comments can then be prioritized when deciding what comments should get sent out to a given user. This has the effect of ensuring that most individuals have at least some basis for comparison and that the comments on which they are comparable are considered particularly important to the conversation. However, this potentially has the problem that those comments which establish themselves as being important early on in a conversation remain important or are given an over-emphasized role as the conversation develops. This concern can be addressed by adding randomness to the comment feeding process and looking for comments which seem to be gaining quickly in representativeness to ensure that newcomers are more fairly represented.

### Use of Iterative Clustering

Given base (or group) clustering results, one can use knowledge of what group an individual seems to be in to “predict” the way they would vote in the future. This could involve averaging over their positions to obtain smart centers, which act almost as priors for what we would expect the cluster member positions to be. In one sense this is a somewhat naive form of collaborative filtering, where the missing ratings can be filled based on a best guess from the data about what someone's ratings would be (note that other methods of collaborative filtering could be used as well). Note that one disadvantage of this approach is that a participant's position may drift over time. For example, if a person voted on just a couple of comments and left the conversation, then they would likely group together in a cluster close to (0, 0). If other members of that cluster continue participating, and move on towards other areas of the visualization, then one might naively think that the participant with very few ratings is moving in that direction as well. For this reason, this method is not optimal, though it could potentially be modified in such a way that these concerns are mitigated.

### Other Possible Modifications

During relatively high-traffic times, the server computers that are executing the data processing computations may become overloaded with queued jobs, which would increase the latency in providing analysis updates. To overcome this, it may be desirable to dynamically/adaptively reduce the number of internal iterations that are performed (e.g., as used in the iterative re-centering clustering or iterative PCA (especially power iteration)/AE analyses)), although at some cost to accuracy. Once a traffic spike ends, or once data processing reinforcements (in the form of additional server computers, for example, auto-scaled vector machines) are available, then the accuracy can be regained by running additional iterations.

### Operation of the Visualization/Display

The visualization referred to herein (e.g., the “dot, “red dot”, or “vis”) is useful for providing stakeholders with an easily understood summary of the groups and opinions in a conversation. The visualization is also important for participants in the conversation, as it has been observed that it increases engagement through a form of feedback. The visualization provides immediate value to the participants; in response to voting on a comment, they are shown an updated image of where they are and which groups they are part of within the space of the conversation. Participants can obtain insight into the dynamics of the conversation in the form of answers to questions like “who are the people that are similar to me and what are the top comments for people like me”, and “voting in such a way on the previous comment moved me in that direction, what does that say about the people in that group?”. In using the visualization, the selection of a set of “dots” or other form of indicator represents the set of participants, and/or a set of clusters of interest. Those dots may be assigned x, y (and if desired z) positions using the clustering/dimensionality reduction techniques discussed herein.

### Information Aspects of the Visualization

In general, desirable characteristics of the visualization are the following:

(1) Nodes (participants or groups) that are visually distant are also distant in opinion space—they voted less similarly;

(2) It is possible that the dots will be projected very near to each other. When there are more participants in one area, it should be visually clear that there are more people there; and

(3) The axes (x and y) do not represent different types of quantity (such as time, etc.)—they are merely a projection surface for the higher dimensional comment space.

In one embodiment, the visualization may be a rectangle. The longer dimension of the rectangle corresponds to the first principal component. This is useful because the first PC represents the concept that is most responsible for separating participants. By projecting this on the longer axis, the distance between nodes along this axis is more visually spread out. The second PC is projected on the shorter axis. Since the difference between people along this axis is less dramatic, it makes intuitive sense for them to be viewed as closer together. Doing this allows for a simplifying explanation of the visualization (e.g., “people who are near each other had more similar opinions”).

To accomplish characteristic (2), participants that are projected near each other may be clustered into bigger nodes. Another way that preserves the individuality of participants is to use a physics simulation to prevent overlaps. This can be accomplished using a particle collision physics model for example.

An acceptable behavior for purposes of user comprehension may be achieved by setting each dot's target position to be the one provided by the dimensionality reduction/clustering. If multiple dots have target positions that are nearby, then they will clump around that area. If one of the dots moves away, the other will then move closer to its target. If a dot enters a crowded area, then the other dots move out of the way. This effect mimics that of a person moving through a crowd, and is useful in giving the perception that a participant's red dot is moving within groups of people.

To implement characteristic (3), it is desirable use a technique to indicate that the visualization is not a scatter plot. In one embodiment, this may be achieved by drawing “hulls” around clusters of nearby participants. This approach visually reinforces that the visualization represents clusters, and that the axes are not of different unit types.

### Visualizing Sub-Clusters and Participants within Clusters

Since it can be relatively slow (both as a result of data processing computations and the available network bandwidth) to render every participant in a conversation individually, in one embodiment it may be preferable to instead render sub-clusters (groups of individual participants) that are within the same cluster that the current user is in. Similarly, the members of a cluster might be shown only when a user (not necessarily a participant) selects a cluster. Further, a user can select a cluster in order to “zoom in” (i.e., focus) on the selected cluster and show detail that is relevant to that cluster—such as the comments that most represent that cluster.

### Updating the Visualization

As described herein, FIGS. 7-10 are diagrams illustrating the primary elements, components, and methods that may be used in an embodiment of the inventive system to update the Visualization as new votes are submitted. As noted, in FIG. 9 the update process is illustrated when used with a streaming of deltas or diffs in the data, while FIG. 10 illustrates an implementation in which the updating is accomplished using delta streaming with the most recent projection snapshot available as needed for the process.

### Reducing Latency Between Voting and Update of the Red Dot

An important latency-sensitive part of the inventive system is the update of the position of the red dot after a user takes an action (such as voting). If there is too much latency, then the user will often miss the connection between their vote and the movement of their dot (or other indicator or representation of that user). It is generally less important to have lower latency when updating the dots that correspond to other users, since a given user will not usually see when other users hit the button to vote—thus an extra amount of time (though small) is unlikely to be of concern.

Thus, in order for a user to associate their voting action with the subsequent movement of the red dot in the visualization in a way that reinforces their participation, it is important that the dot's movement not be delayed beyond an amount of time that they find acceptable. This typically means devoting resources to reducing the latency of the update process when possible. A user will typically look at the visualization briefly after they vote, but if their dot doesn't move immediately they may shift focus away from the visualization, and begin reading the next comment, etc. This may result in them thinking that the system is broken, or perhaps worse, they may think this indicates that their vote had no effect on the red dot. Therefore, it is important to reduce the latency between a user voting and moving their corresponding red dot when possible.

One way to reduce this latency is to reduce overall latency within the datacenter, and between the datacenter and the client(s). However, there are practical limits to how much those sources of latency can be reduced, especially in conversations where participants are not generally located in a similar area. While it would be possible to distribute parts of the data processing computations to datacenters that are nearby large cities, that may also not be ideal since it introduces additional cost and complexity. Reducing latency within a datacenter is also challenging, and may be expensive as throughput increases.

One practical way to reduce the latency is to transmit the projection model (e.g., the first two (or three for 3D visualizations, etc.) principal component vectors in the PCA case, or the encoder weights in the AE case) to the client whenever those change. When the user votes, the client application can use the projection model to generate the projection of the user's red dot to show its location in the visualization. This may be done using the same projection algorithm as used to project the other participants, but only for the current user. To do this, the client application can store the latest copy of the projection model, and a copy of the user's votes (e.g., in the form of a vector or +1, −1 values). In the case where the user is logged in on multiple devices, it may be necessary to transmit the user's updated votes to the client application. Additional data used to generate the projections may also need to be sent to each client, such as the support overlap minimization matrix.

### Reducing the Amount of Projection Model Data Sent to the Client

The client application needs to have updated values for the elements of the projection model that correspond to comments that the participant has voted on. Additionally, to achieve low latency on the next vote, the client preferably also has the values for the elements of the PC vectors that correspond to comments which the participant could potentially vote on (for example, the comment which is currently or about to be shown in the comment voting UI). Given these considerations, the following are possible ways to reduce the amount of data transmitted to the client application while still providing a satisfactory user experience:

1. Use an efficient representation for each number in the projection model. For example, it may be sufficiently precise to use a single byte for each number;

2. If sending values for every comment dimension (the full vectors), then they can be sent in array form—this can be further reduced if a fixed-width number representation is used, eliminating the need for commas (assuming a text encoding);

3. Sparse vectors could be transmitted, where only values within the vectors that have changed more than some threshold amount are sent (deltas);

4. Sparse vectors could be used to omit values within the projection model that correspond to comments that the participant hasn't voted on, and will not vote on in the near future. The idea is to transmit the values for those comments which a participant has already voted on. Also, when a new comment is sent to the client app to be voted on, the latest PC values corresponding to that comment may be sent as well. These values, as well as the values for comments the participant has already voted on need to be retransmitted when they change (when the PCA is recomputed), but possibly only if they change beyond a certain threshold amount. Note that a downside of this approach is that the server would need to compute these custom updates for each user, and track the state of each client to know what to omit; and

5. If the client app is detected to be in an inactive state, (e.g., app not in foreground, no user interaction for some time, etc.), then transmission of this data can be paused. When the app regains focus, the latest projection model can be requested. The client may keep track of the timestamp for when the PCA was last computed, and the client app may choose not to use the latency reducing client-side red dot projection code in the case where the PC data is too old. Or, the client may move the red dot, but use some visual effect to indicate uncertainty about the position, such as wobbling/orbiting around the projected center, blurring of the dot, or showing a loading indicator, etc).

For the situation in which an auto-encoder is used, this issue may be handled in the same way as with PCA. In this case, the weights on the connections between the inputs and the hidden layer (the encoder half, and possibly multiple layers if using a multilayer AE) can be sent to the client and used to project the red dot. The variants listed for PCA may also apply to this implementation. For the auto-encoder case, the bias weights should also be sent to the client.

### Reducing Latency by Computing the Projection of the Red Dot on the Client

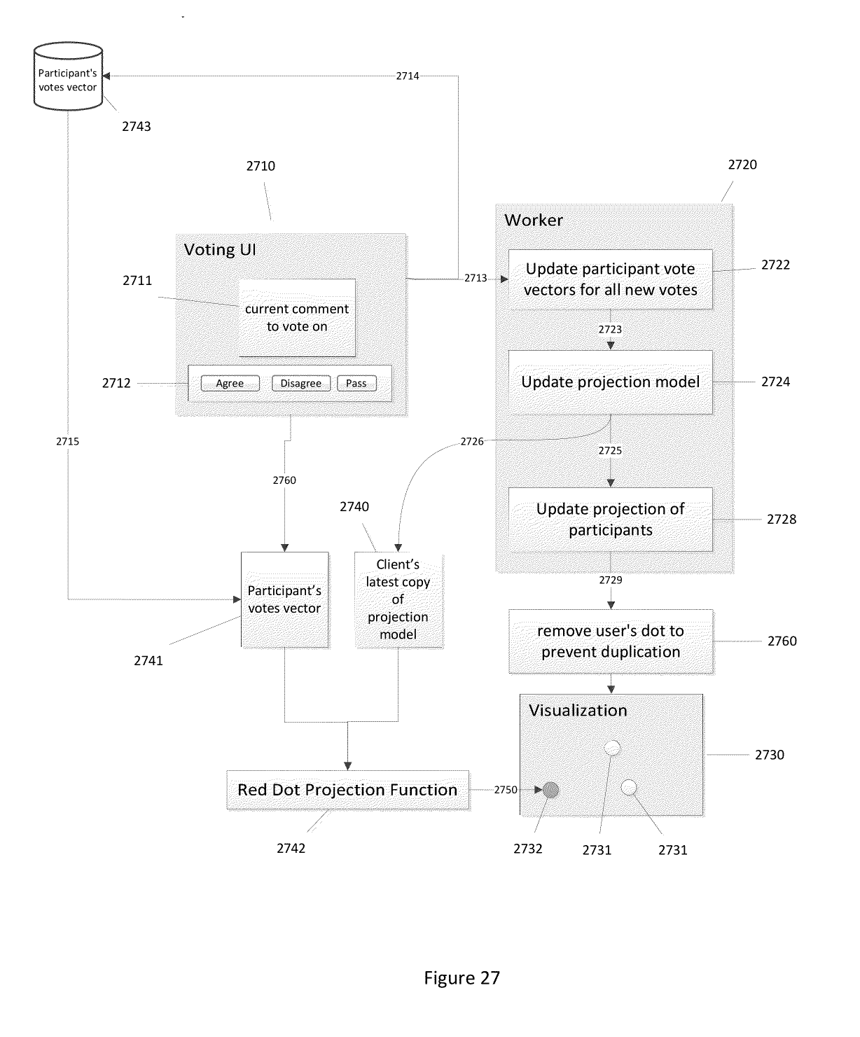

FIG. 27 is a diagram illustrating elements and processes that may be used in an embodiment of the inventive system to update a user's visualization in response to their votes and those of other participants (note that the processes shown in the figure have some similarities to the processes illustrated in FIG. 16). As will be described, the figure shows a process for updating the visualization based on transmission of the projection model vectors. One purpose of this approach is to reduce the latency perceived by a participant between their vote, and the updating of their red dot or other form of identifier. This is because waiting for a full update (based on the projection model, and an update of the projection of all participants) in response to their vote may take enough time that a user's ability to appreciate the connection between their vote and the movement of their dot may be insufficient to encourage full user engagement in the conversation.

In the process and dataflow shown in the figure, an underlying concept is to transmit the latest projection model 2726 to the clients, so that they can maintain a copy of it 2740 in order to more immediately calculate the projection of the participant's dot 2742 when that participant votes. Thus, the latency in presenting the updated projection to that user is reduced because there is no need to wait on the worker 2720 to re-project the participant's dot before updating the participant's dot or indicator. The element noted as “Participant's votes vector” 2741 is the participant vector, made up of vote values for each comment where the participant has voted (and zeros for the comments which the participant has not voted on). To update the projection of the current participant, the vector is multiplied 2742 by the projection model 2740, which yields the projection data used to draw the participant's “dot” 2732. Note that the other participants' indicators 2731 are updated with a 2720 worker-generated projection, beginning when a participant votes 2713.

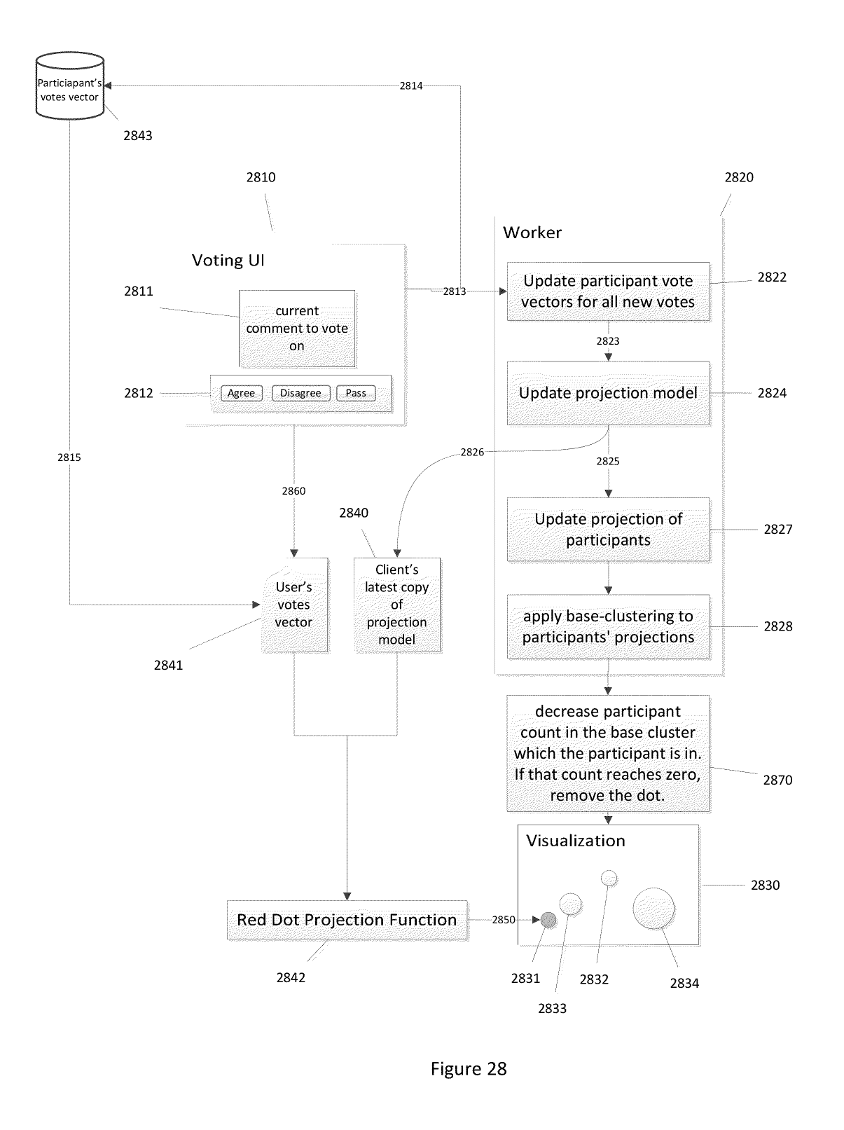

Note that in one embodiment, projection model 2726 may be delivered simultaneously with the latest projection 2729, and the client may cache the projection model 2740 for use in the local projection function 2742 until a new projection and projection model 2726 is delivered. A benefit of the simultaneous delivery is that the projection of the red dot and the other dots are in sync since they are based on the same projection model 2724. Also note that the participant's votes vector 2741 may be updated 2760 directly on the client following a vote event, and must also be updated 2715 when the same user votes from a different device. In this illustration, 2743 is a database storing each participant's votes, which is useful for keeping the participant votes vectors in sync across their devices. FIG. 16 and the accompany description may be consulted for more detail on the voting UI 2710. The process of updating the projection model and projection are similar to that in FIG. 16, except that the projection model is exported 2726 from the worker. Another consideration in FIG. 27 is that the participant's dot is projected twice: once in the worker 2728, and again on the client 2742. To remedy this, the client can remove 2760 the participant's dot from the client's copy of the projection, leaving room for the client's own projection 2750 of the participant's dot 2732. This process is described in greater detail with reference to FIG. 28.

FIG. 28 is a diagram illustrating elements and processes that may be used in an embodiment of the inventive system to update a user's visualization in response to their votes and those of other participants. In some sense, FIG. 28 is an elaboration of FIG. 27, and illustrates how base clustering may be applied (in conversations with a relatively large number of participants) to the participants' projections to reduce visual clutter and reduce the number of bytes needed to transmit the projection to clients. The base clusters may be applied 2828 after projecting each participant 2827. The base clusters are then used as a proxy for the participants' projections. Although many of the details of FIG. 28 are similar to those found in the description of FIG. 27 and FIG. 16, there are some steps (2828 and 2870) that are different, and there are changes to the visualization. Note that in this implementation (that of FIG. 28), the base clusters are shown with various sizes 2832, 2833, 2834, with a larger radius indicating that the base cluster contains more participants than a dot with a smaller radius. A complication of transmitting the base clusters to clients is that it is slightly more difficult to remove the participant's duplicate projection, as in 2760. However in this embodiment, rather than removing the current participant's projection as in 2760, the participant is represented as part of a base cluster. To ensure the participant is not represented twice, the client can 2870 find the base cluster to which the participant belongs, subtract one from its participant count, and reduce the radius of its dot accordingly. If doing this brings the base-cluster's participant count to zero, the base cluster can then be hidden. For example, in FIG. 28, imagine that the participant was included in base cluster 2833. Since the client has already 2870 removed the participant from 2833, the client can then project 2850 the participant's dot 2831.

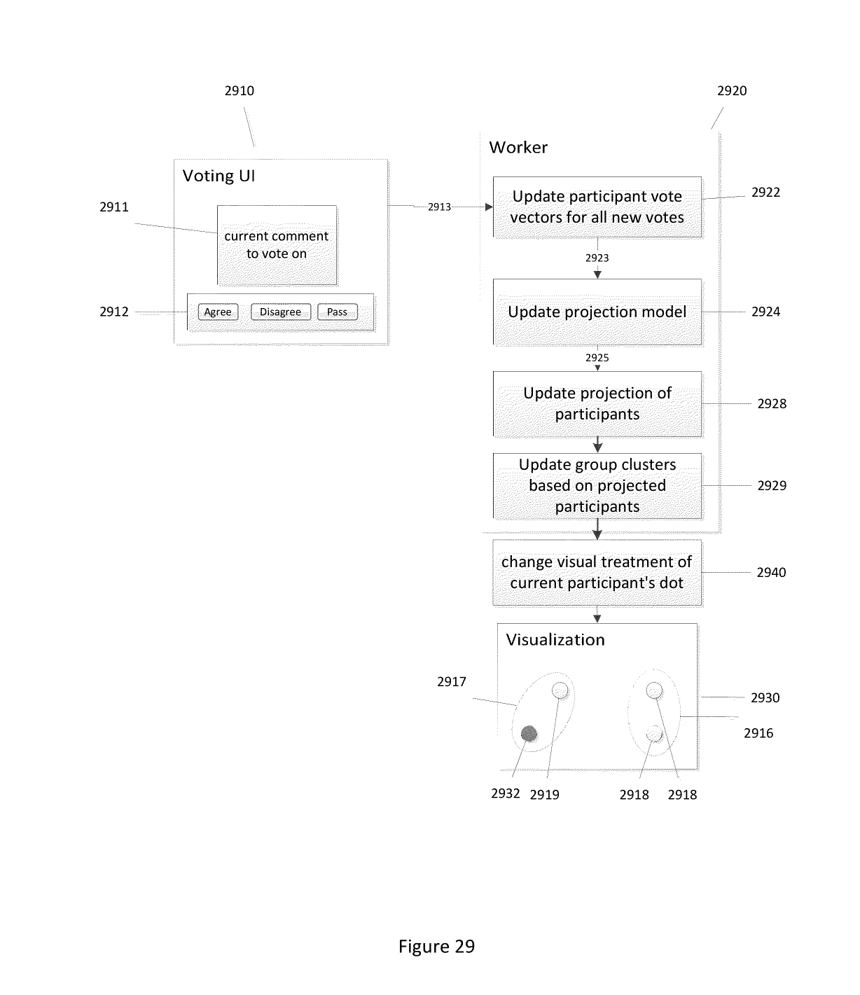

FIG. 29 is a diagram illustrating elements and processes that may be used in an embodiment of the inventive system to update a user's visualization in response to their votes and those of other participants. Note that FIG. 29 elaborates on FIG. 16, and adds consideration of group clustering. A step of interest in FIG. 29 is 2929, where group clusters are generated based on the recently updated projections of participants. Note that step 2940 is similar to step 1640 of FIG. 16. The visualization 2930 has hulls 2917, 2916 which represent the group clusters. In this example, each cluster contains two participants, 2917 contains the current participant 2932, as well as another nearby participant 2919. The other cluster 2916 contains two distant participants 2918.

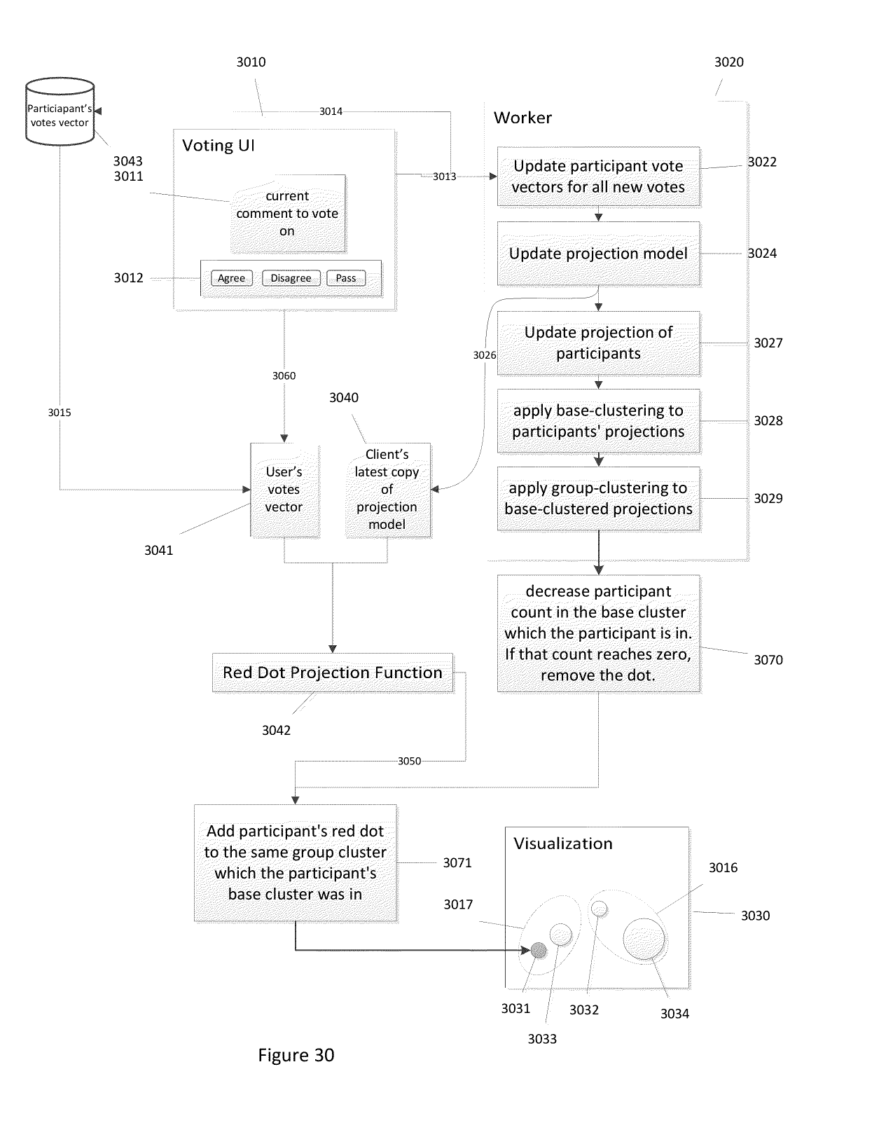

FIG. 30 is a diagram illustrating elements and processes that may be used in an embodiment of the inventive system to update a user's visualization in response to their votes and those of other participants. FIG. 30 elaborates on FIG. 29 and FIG. 28, and illustrates step 3071, which is applied after 3070 (which is similar to step 2870). One aspect of interest is that it may make sense to constrain the position of the red dot such that it does not intersect with hulls of other clusters, such as 3016, as this would cause the visualization to become cluttered. Likewise, the participant's dot, having strayed over another hull 3016, should not be added to the other cluster locally by the client, since it would complicate statistics about the clusters (which are easier for participants to communicate about if the clusters do not have different participant counts across devices). Instead, it may be preferable to wait for the worker to determine that the participant has migrated to a new base-cluster (and possibly a new group-cluster), and then every client can see the participant migrate simultaneously.

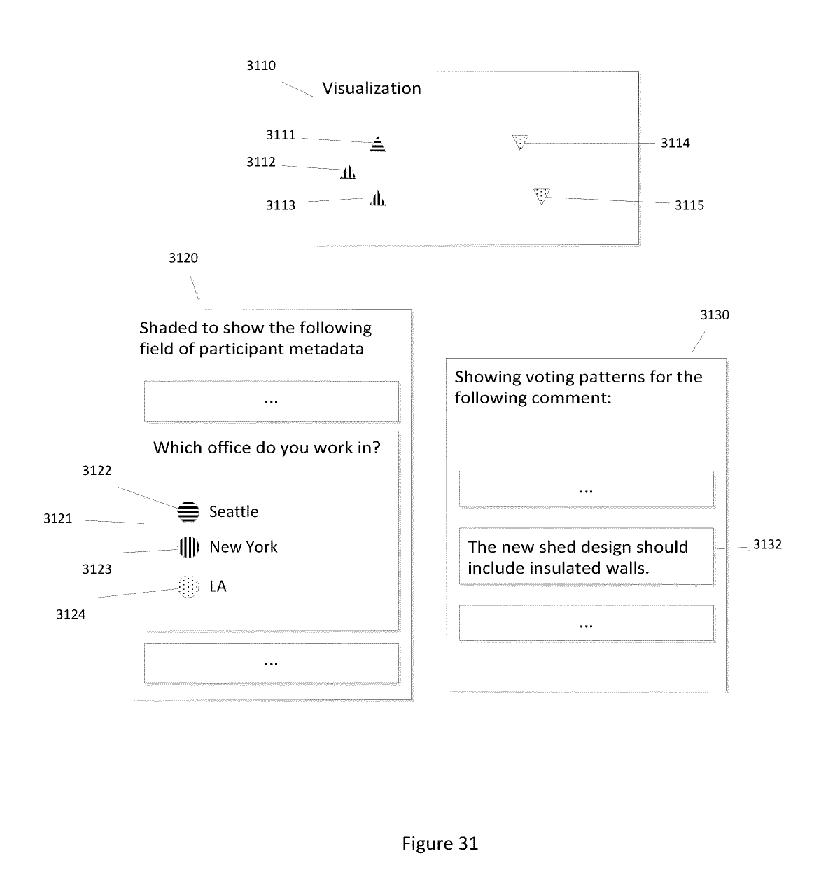

FIG. 31 illustrates an example of a user interface where the voting patterns for a selected comment are shown simultaneously with metadata about participants, allowing the user to see correlations between the comment and the metadata. A comment 3132 is selected from a list 3130 of comments from the conversation. The upward-pointing triangles in the visualization 3111, 3112, and 3113 represent participants who agreed with the selected comment. Downward-pointing triangles 3114 and 3115 represent participants who disagreed with the selected comment. The horizontal-striped triangle 3111 represents a participant who is based in Seattle, which can be seen by looking at the selected metadata breakdown 3121, where the horizontal stripes are used to indicate Seattle 3122. Note that in this conversation, the participants on the right 3114 and 3115 disagreed with the comment about insulation, but also live in LA, a relatively warm city.

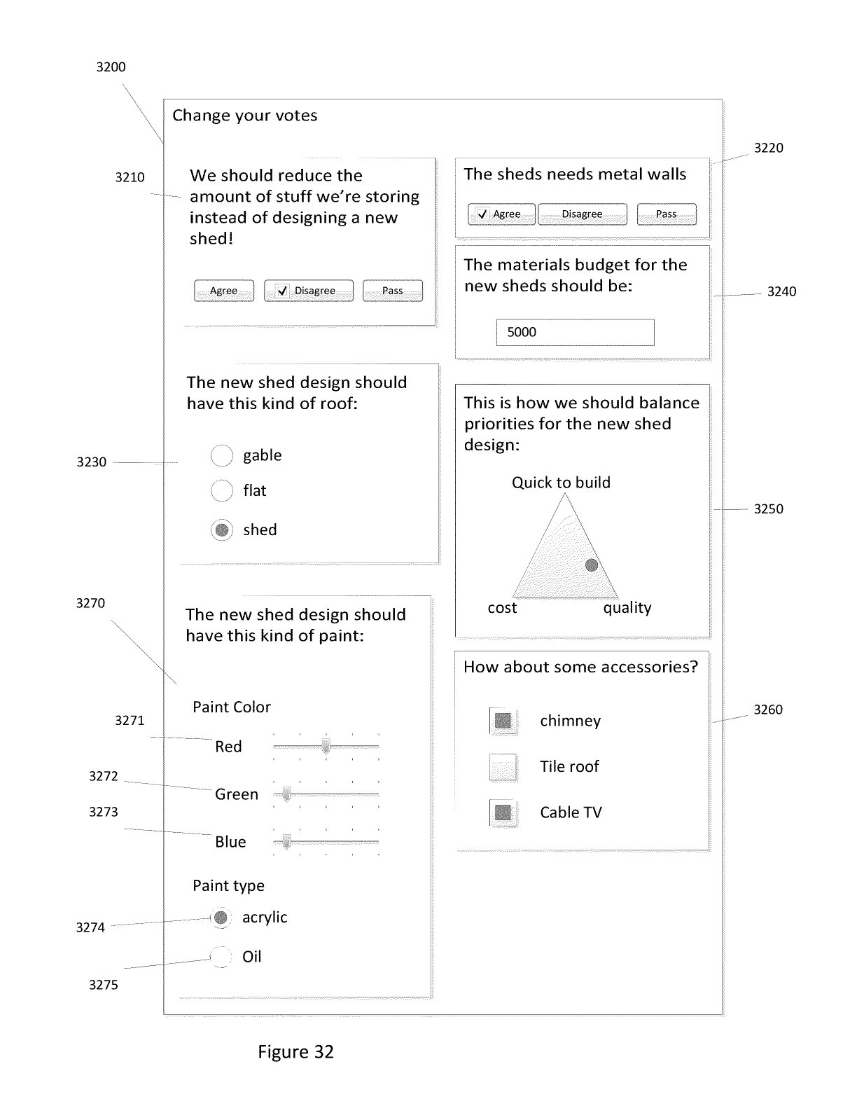

FIG. 32 illustrates a user interface 3200 where a participant is able to change their votes on voteable entities/comments. The first votable entity is a simple comment, with which the participant has previously disagreed. The second votable entity 3220 is also a comment, with which the participant has agreed. Votable entities may have other inputs than “agree” and “disagree”. Element 3230 illustrates a votable entity with radio buttons which represent exclusive choices. Element 3240 illustrates a votable entity with a one-dimensional numerical input. Element 3250 illustrates a votable entity with a constrained multi-dimensional input widget. Element 3260 illustrates a votable entity where non-exclusive choices have been made. This is similar to having three separate comments, except that it guarantees that participants who vote on it saw all of the options at once. Element 3270 illustrates a votable entity with multiple inputs of different types. Here the participant has selected a paint color using three sliders 3271, 3272, 3273, and made a Boolean choice 3274 about the type of paint using a radio widget.

### Other Methods of Updating the Visualization

An alternative to doing some or all of the projection model computations on the server side is to use the client side “red dot” projection function described herein to compute the projection of every dot on the client. This would require sending the entire list of votes (a sparse participant vector) to each client. This approach would work for smaller conversations, but may not scale well enough to be used for larger conversations.

Updating the “red dot” data—an updated projection may be produced by one or more of:

1. Sending the AE, PCA, or other model data (e.g., the vectors) needed to project the user's position based on the comments a user has voted on, and for those comments they are able to vote on in the “near” future. The data may be sent along with comments when they are delivered to the client; however, the vectors should be sent to the client whenever the system detects a significant change in the vector for a given comment;

2. Omitting the vectors for the comments which the user has already voted on, and only sending those associated with upcoming comments. In this case, the red-dot projection can be produced by adding the vectors for the new comments on top of the projection for that user as provided by the system. This approach may be more difficult to implement, since there is extra data book-keeping needed to ensure that the client doesn't double-apply or not apply a vector for a recent vote. It may be necessary to know which votes were accounted for when the worker element produced the projection (the client needs to be aware of this to avoid accidentally applying or not applying the vector). While this technique may save some amount of data from being transferred over the network, the extra administrative complexity may make it impractical;

3. Sending the entire model (the entire vector set) to the client whenever it is updated by the system. Since these vectors are only as long as the number of comments, it may be reasonable to transmit them to clients. An advantage of this technique is that it requires the least amount of data book-keeping and can take advantage of caching; also, the servers don't need to keep track of which comments are about to be shown to each user, and server CPU time is not needed to produce custom vector sets for each user;

4. Another way to achieve similar benefits, although with slightly worse latency is to project the participant's red dot on a server, by storing the latest principal component vectors on a server in a quick-to-access way, such as storing them in a cache on a front-end host. This is similar to the workflow described with reference to FIG. 27, except that steps 2740, 2741, and 2742 occur on a server instead of the client's device. In this case there would be a round-trip latency to the server, but this approach wouldn't pay the additional latency cost of fetching the vector from a central data-store. The principle components could be copied to datacenters that are physically nearby participants (e.g., near major cities, etc.), which means that the client application would experience a reduced latency (relative to server-side red dot projection without local caches) when finding the new projection of their red dot. A downside of this architecture is that the latency is higher than the PC on the client, and it is more complex to maintain; and

5. Use of a socket or long-poll HTTP connection, which could send down the vector 3026, or the new location 3050, quickly after a vote is made.

### Reducing Latency (for Aspects Other than the Red Dot) Streaming and Partitioning by Conversation

A way to reduce latency for some aspects of the system is by using persistent network connections. This can be done between the clients and servers over the Internet, as well as within a datacenter. The data processing computations can be divided across multiple processors. The typical use case is suitable for this since each conversation is independent. This means that a front-end host can have a persistent connection to multiple processing elements, each which is performing computations on a subset of the conversations. This approach minimizes the latency that would be introduced by a traditional broker-based queuing system (for example ActiveMQ). Some possible frameworks for accomplishing this are Akka, ZeroMQ, and Storm.

### Streaming Computed Results as they Become Available

If different parts of a process are computed at different rates, it may be possible to make those available to the client as they become available. For example, if a participant leaves a cluster, and/or joins another, that diff update could be transmitted immediately to the client, which could trigger an update. In this case, there is no need to wait for the updated locations of each cluster to become available, and those can be sent out as a separate updates.

### Personalized Comment Queue

In one embodiment, a process that computes a per-user prioritization of comments that optimizes certain goals may be applied. Having a participant vote on a comment provides information about the participant, about the comment, and potentially strengthens the statements the system can make about members of the group(s) the participant is in. Depending on the scenario, it may be advantageous to show one comment in favor of another. For example, if the user has already voted in a way that establishes their projected position with high confidence, then it may be optimal to have them vote on comments which have very few votes, which will provide more information to the system about those comments than votes placed by users for which there is less confidence in the projection. Similarly, some comments may be determined to be more valuable to the discussion (because they are representative of a group, have received many stars, etc), and those comments should be prioritized above comments that are determined to be less valuable (because they are not representative of any groups, demonstrate a random voting pattern, received many trashes from a variety of groups, etc.). The priorities are computed for each comment for each user. As each user votes on a comment, the next comment they see will be the one with the highest priority for them.

The inputs for such a prioritized queue implementation may include:

from PCA projection: (per-axis placement confidence). A measure of certainty for a participant's position along one of the projected axes can be found by adding the absolute values of the elements of the PC vector that correspond to the comments that the user has voted on (sum(abs(pc.x[tid]) for each comment user voted on);

(alternately) from AE projection;

probabilities from Clustering: probability of person being in a given cluster (fuzzy clustering or probabilities from EM algorithm);

from Comment Clustering: P(comment in comment_cluster_x)—this may be used to find comments that are too similar, or just to more quickly place comments;

per-person notification thresholds and notification settings; and

per-person tag interest choices.

The comment queue can be dynamically optimized for different goals by weighting the inputs differently when certain situations occur. For example, if a conversation is viewed as being too polarized along the primary PC, then the priority-function-weight associated with that axis can be tuned down, to allow inputs for other concerns to be prioritized in the queue. Likewise, if there is not much difference between the magnitude of the 2nd and 3rd PCs, it may make sense to increase the weights associated with showing comments that have high values for the 1st and 2nd components.

In one embodiment, a change in priority of a comment or comments may trigger a downstream event or process under certain conditions:
a comment's priority surpasses another's; or
a comment's priority passes some threshold value (which may be set per-user depending on the number of notifications they have pending, the number of notifications they have been sent recently, etc.). If there are comments with a priority that exceeds some threshold, then additional measures can be taken to bring the comment to the user's attention. This might include showing an icon in the toolbar of the application, incrementing a “notifications” counter on the icon of the application, sending a push notification to the user's device, sending an email, etc. This is useful in long running conversations, and in conversations which have new comments entered into the system, but where it is not desired to send notifications to every participant for every comment.

Note that the conversation “climate” can change at multiple levels (globally, cluster wise, individually), so the goals of each user's queue may change frequently. Because of this, it makes sense to preserve the intermediate results for the weighted terms that make up the priority score, with the ability to re-compute a term as needed, and then quickly add up the newly computed terms to obtain the updated priority.

Alternatively, comments can be given random priority for each user, such that any comment they have not already voted on has equal probability of being shown next. The probabilities could also take into account the factors discussed above, so there would not be a sort, but instead a weighted random selection.

### Reducing Sparsity

Ideally, each participant has voted on every comment. This allows the projection and clustering to be performed with relatively high certainty. In a pathological scenario, each participant has voted on a separate subset of comments, with no overlap. In this case, no projection or clustering can be done. A realistic scenario is that each participant has voted on some comments, and there is some overlap in the set of comments each participant has voted on. With the aim of increasing the percentage of overlap, in one embodiment, comments may be “throttled” so that commenting is stopped or slowed down until users' votes catch up with what's been entered already. Note that with fewer comments, it is more likely that participants will vote on the same comments. Comment prioritization can be used to similar effect, to prioritize important comments which can serve as “common comments”, which many participants vote on. Note that use of machine learning techniques on the comment space may enable an initial reduction in dimensionality. Another approach is to make the “distance” between individuals more comparable.

### Presenting Comments in a Single List

A problem with traditional commenting systems is that they usually present comments in order of popularity, which can lead to comments which are supported by a minority group becoming deprioritized, while the top of a list is filled with comments that are supported by the majority. However, presenting comments in a single list is an appealing UI pattern, especially on small screen sizes. In one embodiment, the inventive system can present comments in a list where minority group opinions are boosted in priority, so they can have a place higher on the list, thereby ensuring that users who only read the first few comments will see a variety of viewpoints.

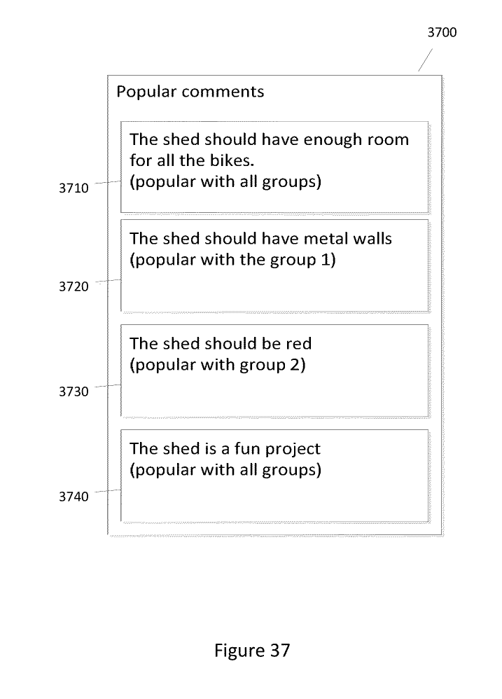

FIG. 37 is a diagram illustrating a user interface where comments have been sorted and shown in a list, with the order of the sorting taking into account the representativeness of comments within each group. In this example, the order of the sort takes into account the representativeness of comments within each group by giving those comments extra priority when sorting. This can help those comments that are important among minority groups to get more visibility. In the figure, the first comment 3710 is an example of a comment which is globally popular. The second 3720 is popular among participants in group 1, which in this example could be the larger of the two groups. The third comment 3730 is an example of a comment that may not have a high total number of votes, but is representative for a group, in this case, the smaller of the two groups, so this comment is given extra priority, and appears in the list. The fourth comment 3740 is popular among all groups, but maybe not as popular as the first comment, and it has been pushed down in the sort order as comments 2 and 3 were prioritized for their representativeness.

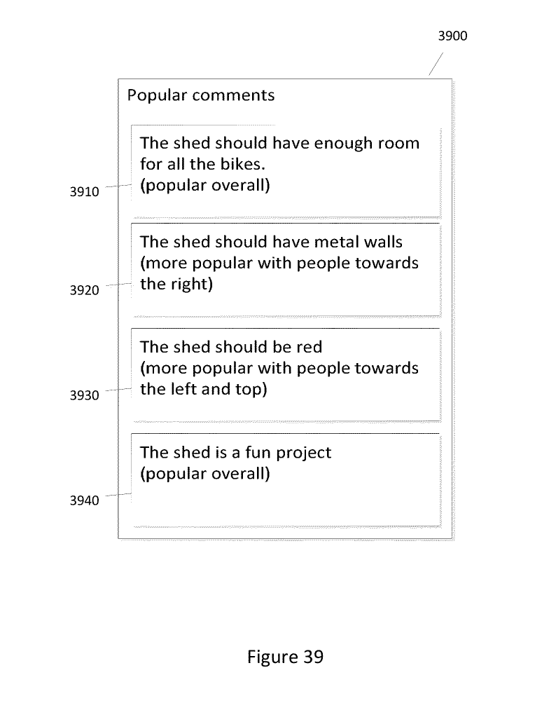

FIG. 39 is a diagram illustrating a user interface where comments have been sorted and shown in a list, with the order of the sorting taking into account the weighting of comments along each principal component. In the figure, the order of the sort takes into account the weights of comments along each principal component, and gives those comments with strong positive or negative weights extra priority when sorting. As with FIG. 37, this can help those comments that are important among minority groups to get more visibility. In the figure, the first comment 3910 is an example of a comment which is globally popular. The second 3920 is popular among participants who were projected towards the right side (note that the visualization may not necessarily be shown). The third comment 3930 is an example of a comment that may not have a high total number of votes, but is representative for enough people that it has received a strong weight on the first PC, so this comment is given extra priority, and appears in the list. The fourth comment 3940 is popular among all groups, but maybe not as popular as the first comment, and it has been pushed down in the sort order as comments 2 and 3 were prioritized for their strong PC weights.

### Showing Comments that Represent Extremes of the Principal Components

As with clusters, the principal components can be used as a “lens” to view the structure of a conversation. Certain comments can be shown as representative of the positive and negative directions of each principal component. This may be informative in understanding the underlying issues that are present in the conversation.

FIG. 38 is a diagram illustrating a user interface where principal components have been used to prioritize the display of certain comments. In this example, four lists 3820, 3830, 3840, 3850 of comments are shown. Each list shows comments which have large values on one of the principal components. Specifically, 3820 shows comments which have large positive values on the first PC, and 3830 has large negative values on the same PC. The viewpoints expressed in these two lists can be thought of as opposite ways of thinking about an aspect of the discussion. Elements/comments 3831 and 3832 are concerned with maintainability issues, at the expense of cosmetic appearance, while 3821 and 3822 are concerned with cosmetic dimensions. Similarly, the second PC is represented by two lists of comments 3840 and 3850. The comments in the bottom list 3840 (3841 and 3842) indicate a conservative attitude about the project, while the comment 3851 in the list at the top indicates a desire to go big with the project. The visualization 3810 shows participants as they are projected along the principal components. Participants on the left 3816 and 3817 tended to vote for comments in the list on the left, and against comments in the list on the right. Participants on the right 3813, 3814, and 3815 tended to vote for comments on the right, and against comments on the left. Participants 3814 and 3815 on the bottom tended to vote for comments in the bottom list, and against comments in the top list. Participants 3817, 3811, and 3813 tended to vote for comments in the top list, and against comments in the bottom list. Participants 3816 and 3812 near the center vertically either have not voted on comments with large weights along the second PC, or voted in a balanced way on comments with large weights along the second PC. For example, they may have voted for 3841, and also voted for 3851. The same can be seen along the first PC, where 3811 and 3812 are centered horizontally. They may have voted for comments from both sides 3820 3830, against comments from both sides, or some mixture that caused their projection to be centered.

### Other Kinds of Votable Entities

As shown in FIG. 32 (which is a diagram illustrating a user interface where a participant is able to change their votes on votable entities/comments), it is possible for votable entities to have complex responses, beyond just Agree/Disagree. In one embodiment, a votable entity can be as complex as an entire traditional survey. Implementation of the UI for this style of votable entity would be fairly straightforward, as there are existing examples of survey creation tools. However, to use these survey-style responses/votes as part of the inventive system, some extra processing is needed. An example of how this can be done is to map each response (i.e., each checkbox option, radio button option, slider value, etc.) to a column in the votes matrix. So a participant's votes vector would contain additional elements. We have previously discussed the Agree/Disagree/Pass as taking values such as 1, −1, 0 on a single element of a vote vector. With these complex votable entities, one can create multiple elements in the votes vector, and use values normalized to a similar [−1,1] range. Following is a brief discussion of how the various survey question types may be mapped to values in the votes vector.

Initially, the implementation needs to consider weights. In a basic Agree/Disagree system, the system has assumed weighting values of 1, −1. Thus, each comment has an equal opportunity to influence the projection. However, if an embodiment allows for votable entities with multiple inputs, greater care is needed in assigning weights.

### Exclusive Multiple Choice

### Radio Buttons

If the comment has an exclusive multiple choice option 3230, then N columns are added to the matrix, one for each of N options. When a participant chooses one of the options, they get a value of 1 in the corresponding column, and −1's in the other N−1 columns.

### Non-Exclusive Multiple Choice

### Checkboxes

If the comment has a non-exclusive multiple choice option 3260, then N columns are added to the matrix, one for each of N options. Options for weighting these include the following:

1. Each of the N columns could have a weight of 1, taking values 1 if checked, −1 if unchecked, or all would have values of 0 if unseen. This is equivalent to having N separate Agree/Disagree comments, except that participants vote on it as an atomic operation;

2. The values in each column could be set to a value whose sum of absolute values totals one. For example, if there are three choices, and the user chooses 2 of them, then the columns would get weights [−⅓, ⅓, ⅓], or if all three were chosen, then the weights would be [⅓, ⅓, ⅓], or [0, 0, 0] if unseen. This option would ensure that the votable entity would have equal weight to other votable entities; or

3. Another option, similar to (1) could allow for the total weights to equal some constant, say 1, but each additional box checked reduces the weight on that item. For example, if only the first box of three is checked, the weights would be [1, 0, 0]. If the first and last were checked, it would be [½, 0, ½], and if all three were checked, it would be [⅓, ⅓, ⅓]. This may be represented differently than checkboxes, to indicate to participants that they are “spending points”.

### Bounded Numerical

If the comment has a numerical input widget that is bounded, such as a slider, then the value can be normalized to map to [−1, 1].

### Unbounded Numerical

If the comment has a free-form numerical input field (e.g., element 3240), then users could enter a number of any value. One approach might be to find the min and max values, and map that domain to the range [−1, 1]. However, that might have a problem where a single user enters a ridiculously large or small number, which compresses the other responses into a small sub-range. Alternatives include things like using a ranking function to distribute responses along the range [−1, 1], or applying an inverse tangent or sigmoid function to map the values to [−1, 1]. These methods require looking at all responses (a column of the matrix) to set the parameters (e.g., of the sigmoid, such that it crosses 0 at the mean of the domain, and approaches −1 and 1 when the domain reaches its minimum response value and maximum response value). The values in the column may need to be recomputed each time a new response of this type is added.

### Multidimensional Numerical

If the comment has N multiple numerical inputs (e.g., elements 3271-3273 or 3250), then N columns are added to the matrix, with each being normalized as described above.

### Mixed-Type

For a mixed-type comment or data input element (e.g., element 3270), suitable options may include:

1. Creating a column for each possible choice of each section, with each column having values between [−1, 1]; or

2. Creating a column for each possible choice, and allowing each group of options to normalize independently. Each group could be thought of as separate comments, and the comment as a whole would be allowed to have more weight than a simpler comment.

As described, FIG. 32 illustrates a user interface 3200 where a participant is able to change their votes on votable entities/comments. The first votable entity is a simple comment, with which the participant has previously disagreed. The second votable entity 3220 is also a comment, with which the participant has agreed. Votable entities may have other inputs than “agree” and “disagree”. Element 3230 illustrates a votable entity with radio buttons which represent exclusive choices. Element 3240 illustrates a votable entity with a one-dimensional numerical input. Element 3250 illustrates a votable entity with a constrained multi-dimensional input widget. Element 3260 illustrates a votable entity where non-exclusive choices have been made. This is similar to having three separate comments, except that it guarantees that participants who vote on it saw all of the options at once. Element 3270 illustrates a votable entity with multiple inputs of different types. Here the participant has selected a paint color using three sliders 3271, 3272, 3273, and made a Boolean choice 3274 about the type of paint using a radio widget.

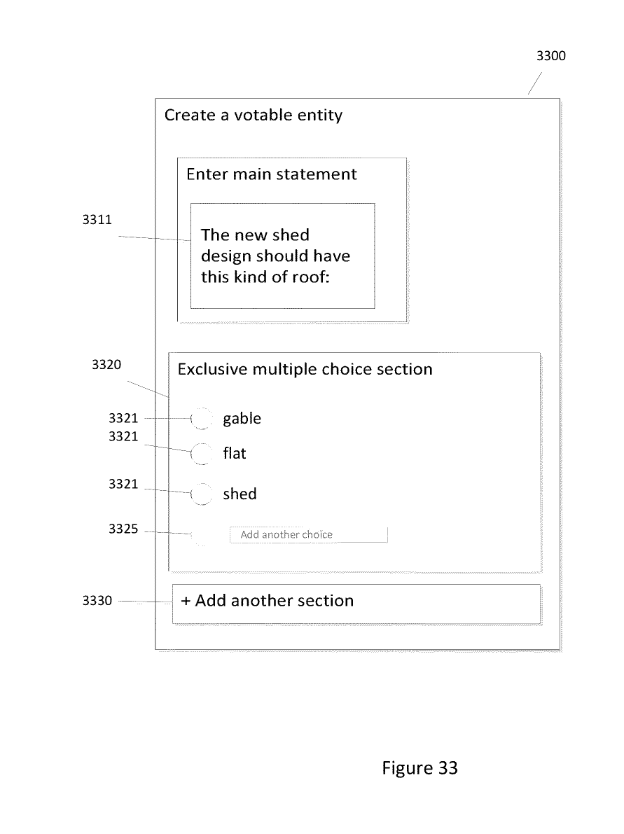

FIG. 33 illustrates a user interface where a participant is creating a votable entity 3300. They have entered text to in a free-form text input field 3311. They have added an exclusive multiple choice section 3320, and populated it with a few options 3321. The widget includes the ability to add additional options 3325, or to add additional sections 3330, which may be of various types, examples of which can be seen in FIG. 32.

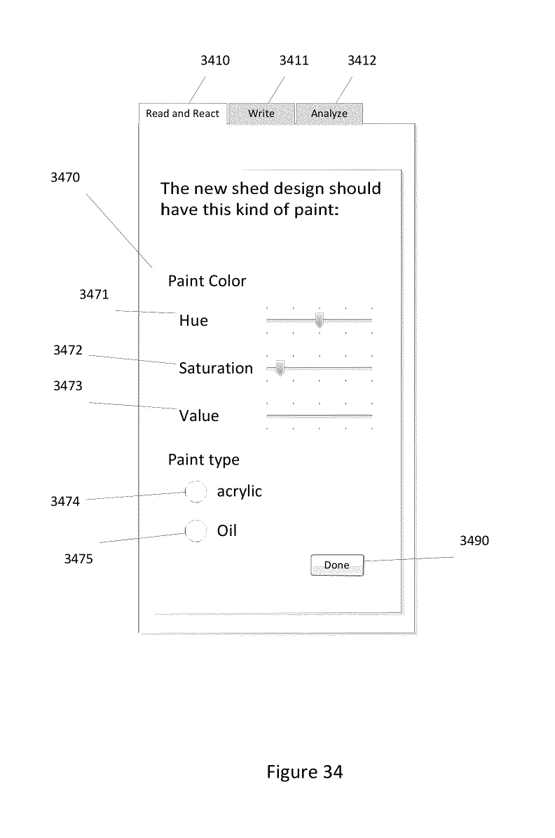

FIG. 34 illustrates a user interface where a participant is in viewing a tab of the user interface 3410, and they are in the process of voting on a votable entity. They have chosen values for hue 3471 and saturation 3472, but have not yet chosen a value for the “Value” 3473 slider, or for the paint type 3474 or 3475. To submit their set of choices, they will click the “Done” button 3490. Also shown are tabs for other interaction modes “Write” 3411 and “Analyze” 3412 where the user may create their own votable entities, or analyze the conversation.

### Embedding/Utilizing the Inventive System within Another Application

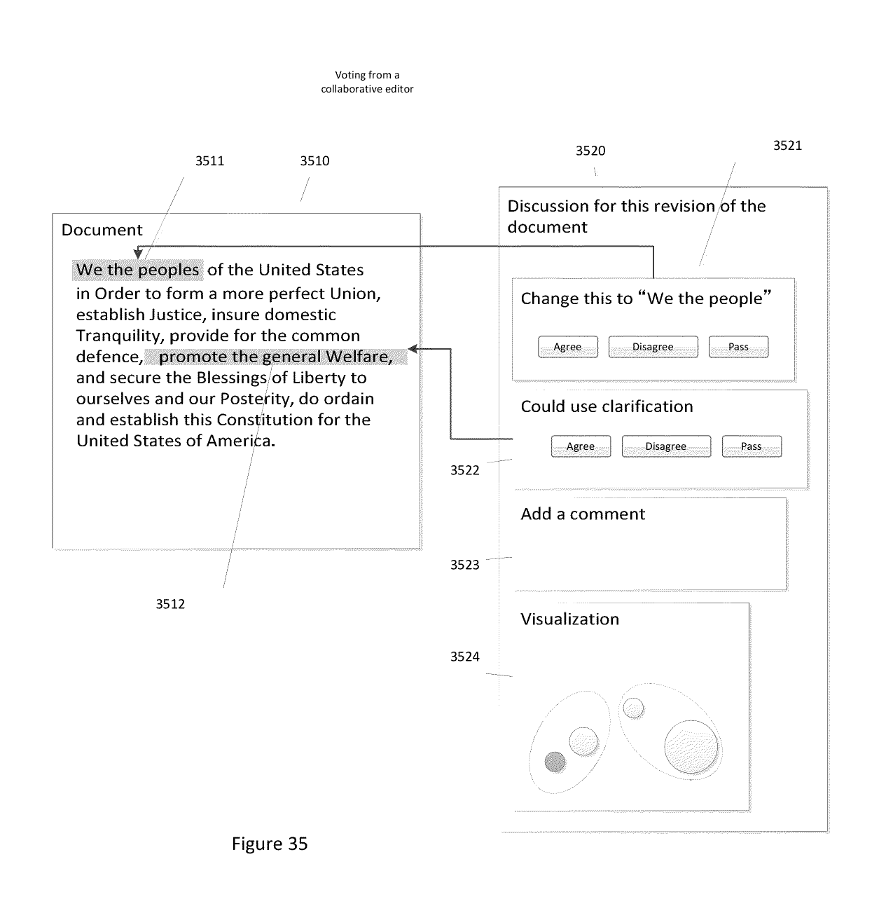

FIG. 35 illustrates a user interface in which the inventive system has been integrated with a collaborative document editing system. In this example, comments may have as a context a reference to the document 3510, and a range 3511 or 3512 within that document to which the comment applies. This example shows multiple comments 3521, 3522 in a side pane 3520 simultaneously, in an order that corresponds to the position of the ranges they refer to in the document. This approach allows the participant to navigate the document at will. Alternatively, one comment could be shown at a time, and the document could be scrolled/cropped to show the content surrounding the context/highlight. Also shown is a form 3523 where users can add their own comment, which would have a corresponding tool for selecting range(s) of content in the document to which the comment refers. Also shown is a visualization 3524, which shows voting patterns for comments associated with a particular iteration of the document—thus an ongoing review/edit process may have multiple conversations.

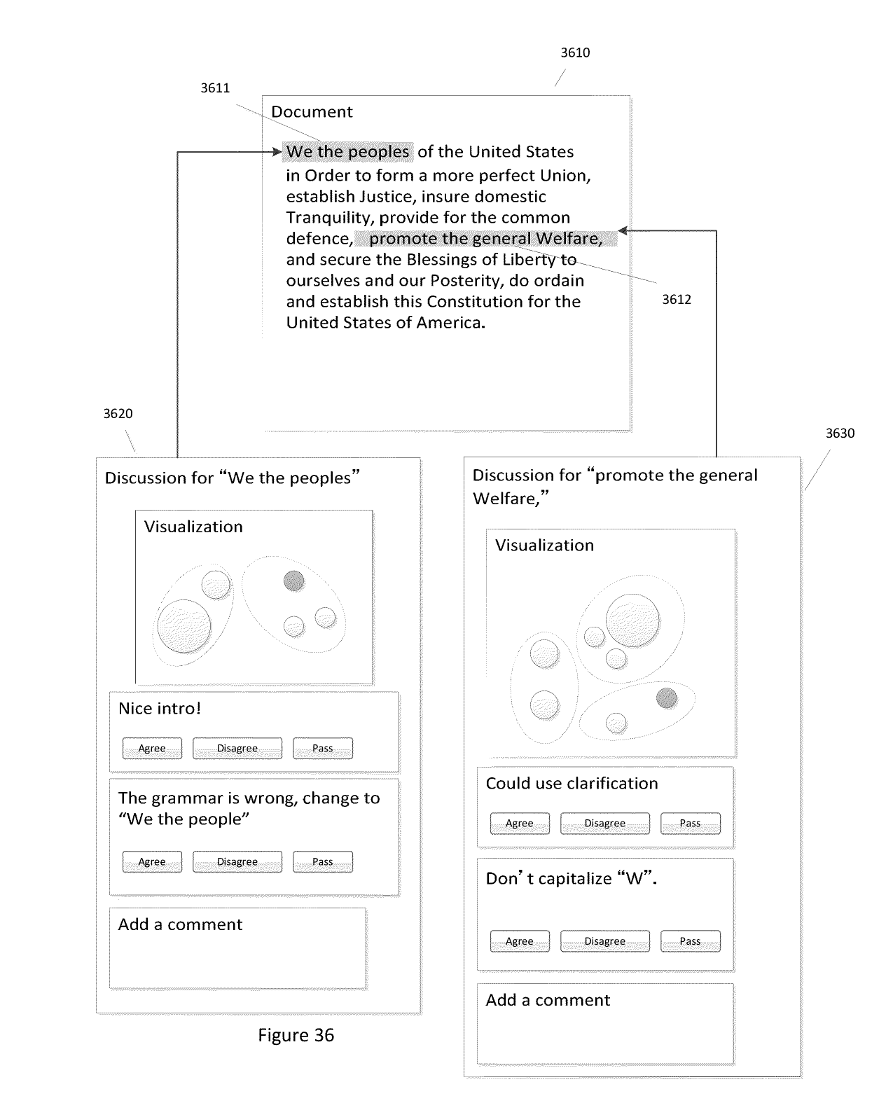

FIG. 36 illustrates a user interface in which the inventive system has been integrated with a collaborative document editing system. This example is similar to FIG. 35, except that instead of having one large conversation about the entire document, there are multiple conversations 3620, 3630. Each can refer to a different range of content 3611, 3512 as a topic of conversation. Shown are two separate discussions, one for each of the highlighted regions. The participants in each conversation may be the same, or not, but the projection and clusters are different, since each operates on a separate set of comments. Note that there would likely be overlap in the sets of participants in each of these conversations, so the comments and votes from each of these conversations could be joined to create a meta-conversation, which might look more like FIG. 35, with extra context displayed along with each comment to indicate which sub-conversation it was associated with. Both styles of conversation could be used simultaneously to offer multiple granularities of analysis.

### Summary/Analysis View of Data

In addition to a conversation based view, users may also be shown a set of statistics regarding the conversation. These may include a list of comments that were the most popular within the largest clusters, comments that had the most disagreement, comments that had the most consensus, etc. Tools to enable a user to submit a query for uncovering additional meaning in the visualization and a list of comments and participants may also be provided, and the results of queries may be shown as widgets on an analysis page. The state of the analysis page, including queries and their results, may be saved, and made sharable with a URL.

Other possible information that may be displayed and/or methods that may be used to improve the utility of the visualization include, but are not limited to:

Display of networks which connect clusters based on central ideas identified as being held in common;

Flipping to illustrating comments in people space;

Inverting of graphics to switch between these views;

Force clustering globe of all comments and users; and

Preserving visual constancy during transitions.

### Anonymous Conversation Mechanism

In one embodiment, conversations may be designated as anonymous during the instantiation of a conversation. Anonymous conversations will function to keep the identities of the participants private. This can be useful because many topics may benefit from a conversation being anonymous. In these cases, if the conversation were not anonymous, participants might choose not to join the conversation, or they might comment/vote in a way that is socially acceptable, but not representative of their actual position. Note that the inventive system is able to show information about users' participation while those users remaining anonymous. For example, the clustering, projection, representative comments, and voting patterns of each participant within the conversation can be shown even if some or all of the participants choose to remain anonymous.

One possible problem with permitting anonymity is that it can create an environment where participants are more likely to make statements that are inappropriate in the context. One possible solution to that problem is a limited form of anonymity where the conversation is anonymous between participants, but the conversation owner (a manager or teacher, for example) has the ability to see who wrote each comment. Another possible solution to this problem is to run in an anonymous-but-moderated mode, where the conversation owner, or someone they've delegated, moderates each comment before they are sent out to other participants. Another possible issue with anonymous users is ensuring that the participants are from the group who were invited, and are not other people, and that individuals are not joining multiple times, pretending to be multiple people. One possible solution to this problem is to require participants to log in, or verify an email address (like the address they were invited with) before and/or during participation.

Note that a conversation can be made up of verified participants and still be anonymous. The inventive system may use a user's credentials (for example, by using an account with an email address at a specific domain name, or with an SMS verification), but within the context of a specific anonymous conversation that user's identity would not be revealed. To enable a user to resume an anonymous conversation on a different browser/device, a mapping between user ID to participant ID would be maintained, with that mapping optionally being encrypted to enhance security. Such a mapping is also desirable to prevent a specific verified user from joining an anonymous conversation multiple times.

### Data Sanity of Diff-Based Cluster Representation

It is possible, in a distributed systems data processing scenario, that two separate cluster-computing processors will compute updates to the clusters based on changes for the same vote. If this were to happen, and those changes were sent as diffs, then the diffs might not be applied correctly (e.g., they might be doubly-applied, or in the case of a computer failing to compute an iteration, there would be a gap). This problem can be prevented if along with the diff itself, there is sent a key that identifies what the diff should apply to. This is similar to version-control software, where each commit (which can be thought of as a diff) has a unique identifier (the hash), and each commit has a reference to its parent hash. In the scenario of the inventive system, the identifier of each diff can be the ID of the comment (which are monotonically increasing), combined with the ID of the conversation, in the case where the comment IDs are local to each conversation. To prevent gaps (where a vote on a given comment is not accounted for), the comment IDs may be sequential and gapless integers.

### Identifier Schemes

It is desirable if participant IDs and comment IDs are gapless sequential sequences of integers. This makes it easier to compute PCA, etc. on them. If present, it should be possible to work around gaps since that logic is needed to handle comments that are of low value, or people that have not voted enough to affect the clustering (e.g., this may be handled by assigning gaps to be vectors having a weight of zero). However, large gaps would add computational overhead, so gapless sequences are preferable. With respect to the ease of producing gapless ID sequences (and unlike for some other large scalable systems), it is relatively easy for the inventive system to assign identifiers since they are related to an individual conversation. This is in contrast to systems such as Twitter, where IDs must be globally unique, which presents a problem when more identifiers are needed than a single computer can assign. Note that in the inventive system, conversations can be partitioned (with IDs assigned by separate databases, for example). In implementing this approach on a traditional RDBMS, a lock can be associated with a conversation, so that while a given participant ID is being assigned, another is not assigned for that same conversation. However, participant IDs for other conversations would have separate locks, so they would not be blocked. Creating unique participant/comment tables for each conversation would be preferable, but traditional RDBMSs typically do not scale well in the number of tables.

### Conversation Health

Conversations may be monitored and optimized to ensure that users' time is being used efficiently; this may involve introducing the concept of a conversation's “health” and making decisions about the administration of a conversation based on that metric. One measure of a conversation's health is to ensure that users are able to be placed and that their dot position stabilizes relatively quickly. To accomplish this, the system administrator can indicate to a user example comments that will cause their dot to initially move in a significant manner. One measure of whether the system is succeeding or failing at this could be to monitor user “passes”, where this action (or more correctly, inaction) could be a measure of wasted user-time. This is because it may indicate that the system is not choosing appropriate comments to show to a user. Such a measure may be weighted by the number of available comments at the time of each view. Thus, if a participant is voting on their third or fourth comment, one would expect to be able to confidently choose a comment they will have an opinion on. However, if the user has already voted on a relatively high percentage of the comments (e.g., 90%), then the system would need to look deeper into the pool of comments to find ones comments that may be interesting to that participant. In addition, metrics such as this could be used to explore tunings of parameters.

### Meta Conversation Layer

Conversations occurring within the communications environment created by the inventive system can be thought of as a single unit. However, there may also be situations in which it would be advantageous to combine these single units to create a “meta layer”, where multiple conversations are connected together or somehow associated with one another. As an example, a professor might ask a question to his students via a conversation which generates follow up questions and increases the number of conversations. This could be visualized as a tree, whereby each new conversation has a parent and can have children. To support this functionality, the inventive system would store a reference to each parent conversation in the database. The system could also detect when a conversation should be split. For example, analyzing the amount of variance being captured by the principle components will aid in evaluating whether or not the visualization is a suitable representation of the values of the participants (i.e., if a large amount of variance is captured in the first two principal components) or is not (i.e., if the first 10 principal components all have 6% of the variance). The system could also be used to represent parallel conversations, and include functionality to make it possible to host multiple conversations with the same topic, each with a different set of participants. This may be useful for seeing which patterns are consistent across randomly sampled groups.

### Other Features or Aspects of System Operation

In one embodiment, selecting a cluster results in “zooming in” to a projection of the participants/sub-clusters of that cluster. This projection may be on the same PCs as the top-level projection, or based on a separate projection for only the participants within that cluster. An alternative approach would be to use an existing survey tool, where the owner chooses a set of questions that he/she thinks will differentiate the participants, and then PCA/clustering can be run on the result of those surveys. With regards to the timing of updates, there may be some optimal delay before updating the red dot after a user votes. There may also be an optimal animation speed. These may be different on a smaller screen where the vote box is closer to the visualization, and a user is more likely to see it if it moves instantly—whereas on a large screen they may need more time to move their eyes over to the visualization section. In some cases, users may actually enjoy some amount of anticipation before the dot moves. In some cases, there may be a benefit to introducing some randomness in the degree of latency, or varying the speed of the animation, etc.

In addition, other system or operational variations might include: (1) different shading for the dots that have recently been active; (2) on a shared screen like a projector, the system could use unique colors/shapes for the dots that have recently been active, and the screen of the participant's device would have an icon with that same shape/color so they can identify themselves; (3) people may not think to use stars for things they disagree with so some form of reminder may be used; (4) panning the visualization (when zoomed) to show recent changes; or (5) permitting a user to change their vote.

### Showing Comments in Order of Representativeness

Comments that are supported in one group (A) but not in another group (B) may represent an opportunity for someone (probably in group A) to reword the comment in a way that may be more appealing/less offensive/more understandable by the people in group B. A reworded comment may be implemented as a new comment entirely, but there is a benefit to maintaining a reference to the original comment. The reworded comment can be sent to the people within the group that already voted on the original (especially those that agreed with the original). When it is sent to them, the user interface might indicate that this “new” comment is a rewording of the original, for the purpose of better communicating the original idea to people in group B. This can act as a “bridge” between the groups, assuming that members in both groups agree with it.

Recursive Conversations—a cluster can be considered to be a sub-conversation. This can be shown in the visualization by transitioning to another projection/sub-clustering that includes only the participants in the cluster that is currently selected. This approach can also be helpful in optimizing comment-routing. Comments originating in a sub-conversation may initially be routed to other members in that cluster. In one example, once enough participants in a cluster agree with the comment, it will be shown to the participants outside the cluster (and have a better chance of being accepted). This functionality can be implemented by reducing the priority within a participant's comment queue for comments from other clusters that have a small number of “agrees”.

### Service Delivery Models

There are several options for how to deliver the services and benefits provided by the inventive system. These options vary in terms of infrastructure, operational elements, and in some cases the applicable pricing models. For example, the inventive system may be implemented by a set of “cloud-based” servers and associated software, and operated as a Software-as-a-Service (SaaS) model. The client software may be browser-based web apps, “native” applications that run on client devices, or a hybrid of the two, where a web-view is embedded in a native client app, increasing the flexibility in deployment. For ease of iterative development it may be advantageous to operate the invention as a centralized system, where the storage of conversation data and the computations performed on the data are performed by centralized servers. This model allows for simple deployment of iterations to the system, without worrying about deployment schedules of customers. Services may also (or instead) be exposed as APIs, which are consumed by customers, who then integrate the logic into other applications. Another option is for a corporation to deploy an instance internally, and then support that deployment through periodic updates.

In one embodiment, data may be encrypted locally before it is sent to the inventive system, since it is not necessary to have the content of comments in order to perform dimensionality reduction and clustering. This approach would not permit textual analysis (so those features would be unavailable), but would permit increased security for the data of enterprise customers. This would maintain data security, while allowing the system to operate as a cloud software model and continue to do real time updates, data storage, and computations remotely.

The inventive system could also be implemented in a peer-to-peer model. In this case, various peers may alternate in performing the “worker” element role (e.g., computing the clustering/PCA/personalized comment ordering), with multiple peers possibly being responsible for computing the same tasks. These peers (or a third peer) would compare their results (or the hashes of those results) to prevent distributing results generated by individuals with “hacked” or otherwise compromised clients. The results could be distributed efficiently using a bit torrent style distribution where peers share updates with other peers. Vote IDs could be used as a sort of “clock” for the peer-to-peer aspects of the system; in this example votes are first registered and ordered on the peers that will next be responsible for performing the data processing. The greatest vote ID considered when producing the processing results is then attached to those results. Clients that receive results with lower IDs than the results they already have are then able to ignore those results. Peers with more computing power (determined by user-agent string, or by running a bit of code and seeing how long it takes) may be asked to do perform a disproportionate amount of work, since, for example, a mobile device would not be ideal for computing clustering, etc.

### A Variation that Focuses on the Projections of Participants and/or Comments as Determined by Dimensionality Reduction

### Possibly without Clustering Steps

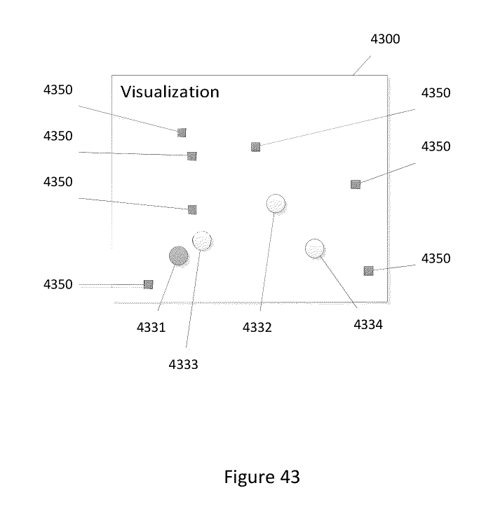

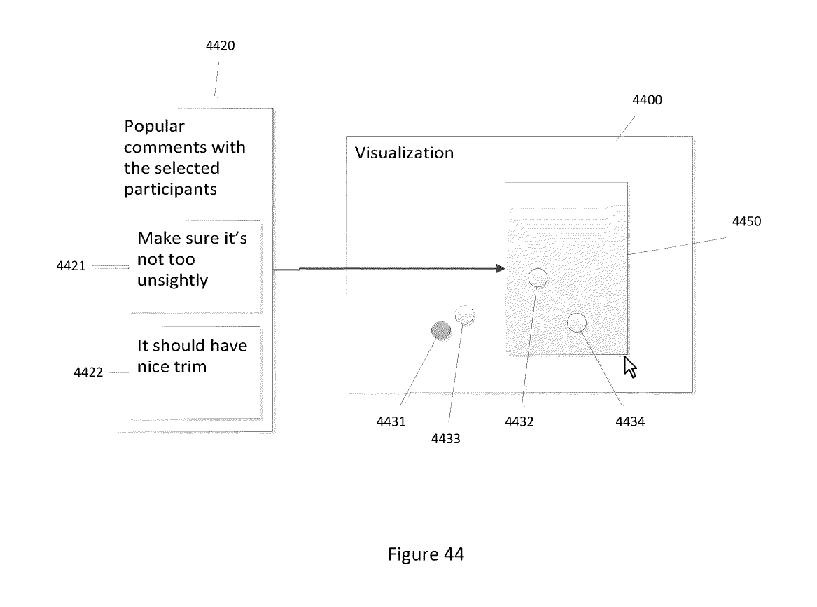

Though this description of the inventive system and methods has focused primarily on a system that segments participants into separate groupings, note that it is also possible to implement an embodiment that relies more directly on dimensionality reduction/PCA. Such a system might not explicitly place participants into groups, but would rely on a participant's or participants' projected positions in the space. Such a system and display could be used to visually compare the positions of participants, observe the number of participants that are projected in certain areas, etc. Subsets of participants and/or comments could be selected based on their projected regions, for example, with a rectangle selection as shown in FIG. 44. FIG. 43 shows a combined projection of participants and comments on which such a selection could be made. FIG. 27 and FIG. 28 show how such a system could update its model and projection, and FIG. 38, FIG. 39, and FIG. 40 show examples of ways that the principal components could be used to present orderings of comments that are informed by the principal components.

Note that such an implementation could be useful in certain situations, such as when it is difficult to produce good segmentation of participants, or in scenarios where it is desirable to see how opinions spread across a gradient. As with a group-based system, it may sometimes be desirable to display the results in a non-graphical manner, for example for viewing on a mobile device or for accessibility reasons. In the principal component style system, such a non-graphical display may consist of lists of comments which are informed by the principal components, as seen in FIG. 39 and FIG. 40. Note that examples such as FIG. 35 and FIG. 36 may similarly be implemented without the groups.

FIG. 43 is a diagram of a user interface illustrating that (similarly to FIG. 42), a visualization can show projections of both participants and comments. However, in FIG. 43, there are no groupings. Comments 4350 are shown as rectangles. Other participants 4332, 4333, and 4334 are shown as light circles, and the current participant 4331 is shown as a dark circle. The projection of comments and participants together is discussed further in the discussion of FIG. 42.

FIG. 44 is a diagram of a user interface illustrating that one or more participants can be selected, and a list of comments shown for which those participants voted in a unique way. The visualization 4400 contains participants 4431, 4432, 4433, 4434, two of which are selected using a selection tool 4450 which is capable of selecting one, or possibly multiple participants. The comments which were popular, or were uniquely voted on by the selected participants are shown in a list 4420, containing comments 4421 and 4422.

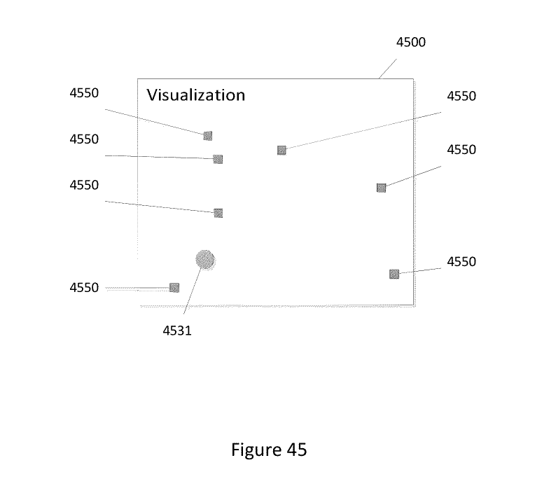

FIG. 45 is a diagram of a user interface illustrating that a visualization can consist primarily of projected comments, with the addition of the current user's dot. While not having the benefit of showing a participant where other participants fall, it would help to clearly show a participant where they fall relative to comments. An alternative of this might be to only project a subset of participants, perhaps participants which are well known, such as a celebrity or political candidate, or who are known to the current participant. In the visualization 4500, the current participant is marked as 4531, while the comments are marked 4550.

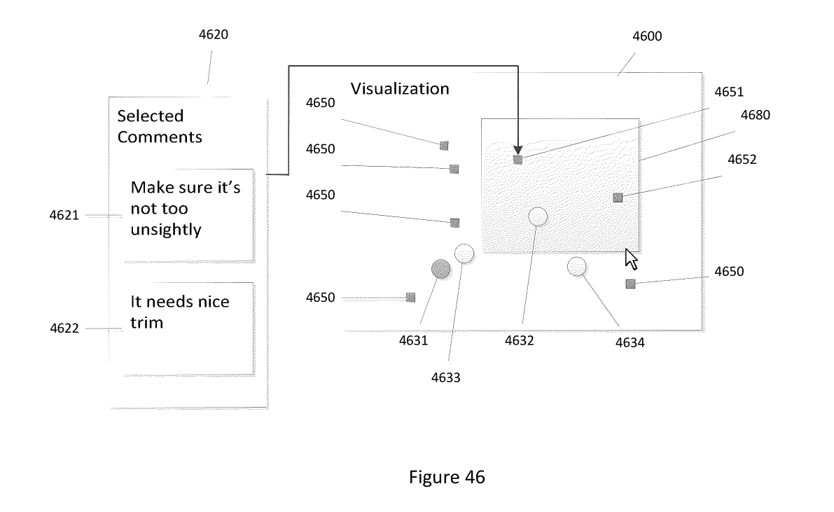

FIG. 46 is a diagram of a user interface illustrating that a visualization can show comments and participants simultaneously, with a comment selection mode that allows for direct selection of comments, without necessarily selecting participants. In the visualization 4600, comments are marked 4650, and the selected comments are marked 4651 and 4652. The selection tool is marked 4680. Participants are marked 4631, 4632, 4633, and 4634. The selected comments are shown as 4621 and 4622, in this case they appear in a list marked 4620.

### Additional Comments and Details Regarding Possible Implementations

When a user selects an element in the visualization, the system makes a query based on the selection, returning a list of participant IDs in the response and/or a cluster ID. The results may be computed on demand, or in a batch process. Note that it is typically easier to pre-compute or cache results for predefined sets of participants, such as clusters.

Note that the projection may additionally (or instead) be to a number of dimensions other than 2 or 3. In this case, the client may choose 2 or 3 of those dimensions to use for purposes of the display.

Many of the embodiments discussed have focused on participants or groups of participants in comment-space. In these embodiments, the visualization is populated with dots which represent participants and groups of participants who voted similarly. However, as mentioned, an alternative embodiment shows comments and groups of comments which were voted on in a similar way. This approach can be referred to as “comments in people-space”. The clustering and projection algorithms are the same, but the elements are comments in people-space instead of people in comment-space.

Clustering and/or projecting comments in people-space can be a useful way to gain insights about the opinions of subsets of the participants. This can be done by clustering/projecting the comments in a smaller space, which only includes a subset of the participants whose metadata (for example, department in a company, job title, age, gender, etc.) match a query. Note that this can also be achieved with “people in comment space” by only projecting and considering for clustering, those participants whose metadata match a query.

In some cases, users may want to see which clusters their comments end up in. This can be visualized in a similar way to the “red dot” that is used to represent the participant in comment-space. Instead of a single red dot, there may be multiple “red squares” (or another color or shape), one for each comment the participant has made. Note that the importance of reducing the latency of displaying the “red squares” is lower, because the squares are moved primarily by the actions of other users, so the latency is less observable. If the participant votes (or changes his vote) for one of his own comments, then the latency for re-computing it could be observed. If reducing latency for the red squares is deemed important, then the latency reduction techniques for the red dot could be applied for each red square. However, note that the projection model will be larger when there are a large number of participants, and every vote cast on the participant's comments needs to be sent to that participant's client.

There are several ways to describe why people or comments are clustered/projected together. These include:

1. “these people are positioned where they are because of a group of comments on which they voted similarly”;

2. “these comments are positioned where they are because of a group of people, who voted on them similarly”;

3. “these people are in a group together because of a the way they voted similarly—these people saw many comments, and in the end had similar results”; or

4. “these comments are in a group together because they convinced people to vote on them in a similar way—these comments made their way through many people, and came out with similar results”.

As described, in some embodiments, the inventive system and methods include a mechanism for participants to vote for or against votable entities, a module that runs on one or more computers which computes clusters and/or projects positions of the participants in a lower-dimensional space suitable for visualization, where participants who voted similarly to each-other are shown close together and participants who voted dissimilarly are shown further apart, and where the clustering and/or projection are updated when at least one new vote has been submitted since the previous projection was computed. Other features or aspects may include:

(1) a votable entity submission mechanism, which is accessible to participants of the system, or to certain human or nonhuman users (computers), before or during the conversation;

(2) notifications and thresholds for different types of notifications;

(3) streaming/non polling implementations of the system;

(4) a mechanism for participants to vote for or against votable entities, a module that runs on one or more computers which computes clusters of the participants where participants who voted similarly to each-other are clustered together, where the clustering is updated when at least one new vote has been submitted since the previous clustering was computed; and

(5) a user interface which in some way (visual and/or audio) shows information about the clusters, such as which votable entities were representative of the clusters, and which participants were influential within each cluster.

### Possible Billing/Revenue Generating Methods

Embodiments of the inventive system and methods may be the subject of one or more types of billing or revenue generating methods. The method chosen may depend on the expected user groups and/or the goals of initiator of the conversation. These billing/revenue generating models include, but are not limited to:

### Total Participants

One relatively simple method of billing is to add up the total number of participants in active conversations (conversations that are still open for new votes/comments/participants) owned by a customer. This number represents a computational load, in CPU time spent updating the calculations after each vote, and in RAM consumed by hosts that are awaiting new votes. This could be offered in a tiered monthly plan, or on a per-participant basis.

### Total Votes

Another billing model might be based on the number of votes (as opposed to total participants) across all the conversations in all the active conversations owned by a customer. However, this may be less easy for a customer to control, and doesn't work as well with a tiered billing plan.

### Pay to Enter

Another possible billing model is to charge participants to join a conversation. There may be a bias problem in that the makeup of participants in a conversation would be biased towards those people who are more likely to pay to join.

### Pay to Enter, Donate to Let More People Join

This may alleviate the bias introduced by the previous billing method, since many of the participants will not have paid to enter (their entry fee being covered by payments made by those who did pay).

### Crowd Funded Conversations

There could be a mechanism where a certain amount of funding must be pledged before a conversation is started. This may have a side-benefit in causing the conversation to be energized once it does begin.

### Enterprise Accounts

Enterprise accounts should take into account that one payer will pay for many accounts, and the resources used by each of those accounts needs to be counted towards the primary account's plan. This could be a form of subscription fee with additional usage based fees or fees for value-added functions.

### Additional Examples of Benefits of the Inventive System and Methods

The inventive communications system described herein offers not only a different infrastructure and features compared to conventional systems, but also a fundamentally different means of operation (and hence benefits) compared to such conventional systems. These differences provide a more optimal and effective communications system in many important use cases in which conventional systems would fail or be largely ineffective. For example, the following describe certain of the differences and accompany benefits of the inventive system that arise from its functions and means of operation:

### Tracking of Changes in Participants' Behavior

The inventive system is different than existing tools for monitoring and understanding communications. Rather than analyzing static data, or an unmodifiable stream of data, the inventive system's statistics are shown to users, which may keep them more engaged, inform them of where they are in the opinion landscape, and how many people have similar opinions. This information may be used by participants to alter their behavior—for example, they may change their votes after seeing new information, write comments that attempt to find common ground, or attempt to split apart a larger group. As a result there is a feedback loop, where the display of information and statistics cause the participants to behave differently, which causes the subsequent data to be different (more informed) than it otherwise would have been.

### Real-Time or Pseudo Real-Time Behavior

This is desirable to permit the feedback loop to be effective. Also, updating the red dot soon (if not immediately) after voting is important for showing the user that their position is determined by their voting behavior.

### Encouraging Spontaneous Conversations

A user doesn't need to do a lot of thinking upfront, and the conversation finishes quickly because all participants can contribute simultaneously. Although a survey can be used somewhat spontaneously when the questions are simple, a conversation using the inventive system can be started in one click, (assuming the participants are aware of the topic). Other methods that are similarly spontaneous to start with—email, Twitter, etc., result in open-ended responses that don't have as useful data analytics.

### Comparison to Other Comment Voting Systems

Other systems don't show group structure, which would allow them to highlight popular opinions among minority groups. Also, they don't show the user where they are in an opinion landscape.

### Changing Votes

Another difference is that the inventive system can allow users to change their votes. In this way, the system operates more like a conversation than a survey. Note that a survey assumes a person's opinions are unchanging. In contrast, the inventive system can accommodate the reading of opinions put forth by others and in response the changing of a participant's view, resulting in a modification of a vote they placed prior to changing their view.

### Minority Opinions

In a survey, you might see that your views are in the minority, but you wouldn't get to see that you're actually part of a minority group with a cohesive set of values/opinions.

### Overlap in Groups

It is possible to select multiple groups, and see what common ground they have, that is see which comments they vote similarly on. Or see which comments they voted differently on.

### Dynamic Comment Prioritization

Because participants only see one comment at a time while voting, it is easy to optimize the ordering of comments they see. As participants react to comments, the system gets more data about the comment, which can be used to affect the priority of showing the comment to a given participant. For example, if a participant has been projected near the center on the y axis of the visualization (because the PC loadings have small absolute values, not because they cancel out), then we may prioritize a comment with a heavily loaded y principal component vector. Similarly, if users pass on a comment, or mark it as off-topic or spam, then the system can reduce the probability of subsequent users seeing the comment (or it may be removed from the conversation entirely, and entered into a moderation queue, which the conversation owner (or delegates) may view).
De-Duplicating Comments that are Saying the Same Thing
It may be challenging to find pairs of comments that are saying the same thing with a high enough probability that the system can show those comments to a participant simultaneously, and ask “are these saying the same thing?” An easier way would be to provide a button on every comment A, which says something like “this says the same thing as another comment”. If a participant clicks that button, a list (L) of comments is shown, prioritizing comments the participant has actually seen. The participant may then select one or more comments from the list. Once this has happened, the system can have enough confidence that that sets of comments are saying the same thing, that it may show them to other users, and ask the “are these saying the same thing” question. Ordering of the list L is probably best done in a reverse chronological order—so either the system can use timestamps of votes/passes the participant has placed for each comment, or the system may track the timestamps that comments were shown to users (in case the comments were shown outside of the voting view, such as when analyzing the group voting patterns). Natural language processing may be used to help emphasize potential duplicate comments. LDA topic modelling can be run on web content, such as Wikipedia, or on a subset of documents related to the topic of the conversation.

### Determining the Set of Training Documents

The conversation owner may be able to paste URLs, upload/paste documents, etc. in cases where the topic is not well covered on Wikipedia. Alternately, the system may have a global model, with links to specific documents that may be relevant. By looking at the text of the conversation, the system may then ask participants “does this document seem relevant to the conversation—is it the same universe of discourse?” If so, the document can be added to a list of documents which are then used to train an LDA model. The LDA model can then be used to determine probabilities that two comments are saying the same thing.

### Disambiguation Tasks

Short comments are often very effective, since they can be read quickly, and avoid the problem where a participant agrees with one phrase, but not another. However, if words are not qualified, then it may be difficult for the natural language system to discover duplicate comments. To assist the system, it may be helpful for the system to ask questions like “In the comment ‘We should paint it blue’, does ‘it’ refer to [‘the bike shed’, ‘the fence’, ‘the main building’]?” In one example, the set of noun-phrases in all comments/topic/description may be used as the list of possible things that “it” refers to. The participant may also enter their own text, or if it's unclear, they may click a button to request the comment author to disambiguate the statement.

### Topics

After disambiguation has taken place, and if a good selection of training documents has been provided, it should be possible to list comments as pertaining to the topics found by the LDA model. It may be useful to look at comments through the topic lenses. For example, in the bike shed discussion, one might want to look at comments pertaining to the type of paint, (acrylic, oil based, matte, gloss), by color, etc.

Embodiments of the inventive system, platform, apparatuses, and methods, enable a person, machine, or process to initiate a discussion or conversation by presenting a topic, statement, or question to a group of participants. One or more of the participants may then submit a comment, judgment, question, or statement in response to the initial topic, statement, or question. Participants may then evaluate and consider the submitted comments, etc. and submit a “vote” or indication of their opinion or evaluation of the comment (or judgment, etc.). In some embodiments, the submitted votes are processed and used to generate a visualization, display, or illustration showing how participants' votes cause the participants to be segmented into groups and sub-groups having a common or similar opinion (where the “commonness” or “similarity” may be based on a metric quantifying a difference in average opinion, for example), with the display also showing how a specific participant relates to or is positioned within the groups or sub-groups (as indicated by the “red dot” described herein). A user interface may permit the specific participant to identify a group or sub-group of interest and in response be presented with information regarding the opinions or values of that group or sub-group (such as a list of the comments received from that sub-group, how members of the sub-group voted with respect to those comments, etc.). In one embodiment, the user interface may enable a user to be provided with a list or ordering of comments submitted by members of a group, highlighting those comments which the members of the group voted on in a way that was different from those outside of the group. In one embodiment, an indicia of a specific user (e.g., the “red dot”) may be displayed, thereby showing the relative position of the user with respect to one or more groups or sub-groups (and if applicable, that the user's response or values cause them to lie outside of one or more (or all) of the groups or sub-groups).

As recognized by the inventors, with relatively large and amorphous sets of participants, and in situations where participants' opinions or thoughts about a topic may not be easily defined or characterized in advance, analyzing participants' more easily comprehensible (and typically limited) voting inputs in response to submitted comments about an initial statement provides a more efficient and effective way to understand a conversation or decision process. From one perspective, embodiments of the invention base an understanding of a conversation on a secondary or indirect response to an initial statement (analysis of the participants' “votes”), rather than relying on evaluation of the direct or primary response (the comments submitted in response to the initial statement). This permits the inventive system and methods to provide both the initiator of the discussion and the participants with a greater understanding of the opinions and values of the set of participants (and how they may change over time due to the introduction of new participants, comments, and votes) in real-time or pseudo real-time, thereby facilitating group decision making, social or political engagement, and group discussions (e.g., for purposes of teaching or learning) more effectively and in a more useful and scalable manner than conventional communications systems.

Note that in some embodiments, one or more of processing of the received votes, generation of the display, or a user's interactions with the display may cause one or more other functions, processes, events, or operations to be initiated or executed. For example, in one embodiment the inventive system and methods may be used to assist in performing one or more of the following:

starting a new conversation with a selected group of participants that hold a specific set of values;

generating a new visualization with only the selected group's participants;

generating a new visualization without the selected group;

generating and/or sending a communication (e.g., an email, invitation, meeting invite, etc.) to the members of the selected group;

generating and/or send an in-app message to the selected group;

saving the members of the selected group to a mailing or other list;

identifying a set of participants having desired characteristics for a study, test, focus group, marketing study, experiment, etc.; or

attaching specific metadata to the selected group, which may be exported to an external metadata system and used to control another function or process.

In accordance with at least one embodiment of the invention, the system, apparatus, methods, processes and/or operations described herein may be wholly or partially implemented in the form of a set of instructions executed by one or more programmed computer processors such as a central processing unit (CPU) or microprocessor. Such processors may be incorporated in an apparatus, server, client, network element, or other computing or data processing device or platform operated by, or in communication with, other components of the system. As an example, FIG. 14 is a diagram illustrating elements or components that may be present in a computer device and/or system 1400 configured to implement a method and/or process in accordance with an embodiment of the invention. The subsystems shown in FIG. 14 are interconnected via a system bus 1402. Additional subsystems include a printer 1404, a keyboard 1406, a fixed disk 1408, and a monitor 1410, which is coupled to a display adapter 1412. Peripherals and input/output (I/O) devices, which couple to an I/O controller 1414, can be connected to the computer system by any number of means known in the art, such as a serial port 1416. For example, the serial port 1416 or an external interface 1418 can be utilized to connect the computer device 1400 to further devices and/or systems not shown in FIG. 14 including a wide area network such as the Internet, a mouse input device, and/or a scanner. The interconnection via the system bus 1402 allows one or more processors 1420 to communicate with each subsystem and to control the execution of instructions that may be stored in a system memory 1422 and/or the fixed disk 1408, as well as the exchange of information between subsystems. The system memory 1422 and/or the fixed disk 1408 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, JavaScript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A method of communicating, comprising:
initiating a conversation involving a plurality of participants, wherein initiating the conversation includes presenting information to the plurality of participants;
receiving a response to the presented information from one of the plurality of participants;
providing the response to the plurality of participants;
receiving an evaluation of the response from others of the plurality of participants than the one that submitted the response;
processing the received evaluations to segment the participants from which an evaluation is received into a set of groups or sub-groups, wherein each group or sub-group represents one or more participants having a similar evaluation of the response; and
generating a display illustrating the set of groups or sub-groups for presentation to the plurality of participants.

2. The method of claim 1, wherein presenting information to the plurality of participants further comprises presenting a topic for discussion, a question, or a statement to the plurality of participants.

3. The method of claim 1, further comprising providing the plurality of participants with an application to install on a device associated with each of the participants, wherein when installed the application generates a display on the device that enables a participant to present a response to the presented information or an evaluation of a response provided by another of the plurality of participants.

4. The method of claim 1, wherein the response to the presented information is a comment regarding the presented information.

5. The method of claim 1, wherein receiving an evaluation of the response from others of the plurality of participants than the one that submitted the response further comprises receiving an indication of one or more participant's vote on or opinion of the response.

6. The method of claim 5, wherein the indication of one or more participant's vote on or opinion of the response further comprises data regarding the one or more participant's selection of one of a plurality of possible evaluations of the response.

7. The method of claim 6, wherein the plurality of possible evaluations to the response depend on one or more characteristics of the presented information or of the participants.

8. The method of claim 1, wherein processing the received evaluations to segment the participants from which an evaluation is received into a set of groups or sub-groups further comprises using a form of dimensionality reduction to determine a group or sub-group to which one or more of the participants belong.

9. The method of claim 1, wherein generating a display illustrating the set of groups or sub-groups further comprises generating a display that shows a plurality of groups of participants, with each group representing a set of participants that share a substantially common evaluation of the response.

10. The method of claim 9, wherein the display further comprises an indication of a user's position relative to the plurality of groups or sub-groups.

11. The method of claim 10, further comprising:
receiving the user's selection of one of the plurality of groups or sub-groups; and
generating for the user a display of the evaluations received from one or more members of the selected group or sub-group.

12. The method of claim 1, further comprising updating the display in response to one or more of:
receiving another response to the presented information from one of the plurality of participants;
receiving an evaluation of the another response from others of the plurality of participants than the one that submitted the another response;
receiving an update to a projection model; and
receiving information regarding a change in a user's preferred number of groups or clusters;
receiving an update to a projection;
receiving an update to a group;
receiving information regarding a set of users who should be included in the display;
receiving information regarding a set of users who should be excluded from the display;
receiving information regarding additional metadata that should be included in the display; or
receiving information regarding a change to analysis parameters or model type.

13. An apparatus for use in facilitating communications between a plurality of participants, comprising:
a processor programmed to execute a set of instructions; and
a data storage element in which the set of instructions are stored, wherein when executed by the processor the set of instructions cause the apparatus to
receive a response to information presented to the plurality of participants from one of the plurality of participants;
provide the response to the plurality of participants;
receive an evaluation of the response from others of the plurality of participants than the one that submitted the response;
process the received evaluations to segment the participants from which an evaluation is received into a set of groups or sub-groups, wherein each group or sub-group represents one or more participants having a similar evaluation of the response; and
generate a display illustrating the set of groups or sub-groups for presentation to the plurality of participants.

14. The apparatus of claim 13, wherein the information presented to the plurality of participants is one of a topic for discussion, a question, or a statement.

15. The apparatus of claim 13, wherein the response to the presented information is a comment regarding the presented information.

16. The apparatus of claim 13, wherein the evaluation of the response from others of the plurality of participants than the one that submitted the response is an indication of one or more participant's vote on or opinion of the response.

17. The apparatus of claim 16, wherein the indication of one or more participant's vote on or opinion of the response is data regarding the one or more participant's selection of one of a plurality of possible evaluations of the response.

18. The apparatus of claim 13, wherein processing the received evaluations to segment the participants from which an evaluation is received into a set of groups or sub-groups further comprises using a form of dimensionality reduction to determine a group or sub-group to which one or more of the participants belong.

19. The apparatus of claim 13, wherein generating a display illustrating the set of groups or sub-groups further comprises generating a display that shows a plurality of groups of participants, with each group representing a set of participants that share a substantially common evaluation of the response.

20. The apparatus of claim 19, wherein the display further comprises an indication of a user's position relative to the plurality of groups or sub-groups.

21. A communications system to facilitate communications between a plurality of participants, comprising:
a client application for installation on a device associated with each of the plurality of participants; and
a data processing platform configured to
receive a response to information presented to the plurality of participants from one of the plurality of participants;
provide the response to the plurality of participants;
receive an evaluation of the response from others of the plurality of participants than the one that submitted the response;
process the received evaluations to segment the participants from which an evaluation is received into a set of groups or sub-groups, wherein each group or sub-group represents one or more participants having a similar evaluation of the response; and
generate a display illustrating the set of groups or sub-groups for presentation to the plurality of participants.

22. The system of claim 21, wherein the client application is configured to cause the device to generate a user interface that operates to enable the user to perform one or more of
submit a comment in response to the information presented to the plurality of participants; and
submit an evaluation of a comment submitted by one of the plurality of participants.

23. The system of claim 21, wherein the information presented to the plurality of participants is one of a topic for discussion, a question, or a statement.

24. The system of claim 21, wherein the evaluation of the response from others of the plurality of participants than the one that submitted the response is an indication of one or more participant's vote on or opinion of the response.

25. The system of claim 21, wherein processing the received evaluations to segment the participants from which an evaluation is received into a set of groups or sub-groups further comprises using a form of dimensionality reduction to determine a group or sub-group to which one or more of the participants belong.
